(19) United States
(12) Patent Application Publication
(10) Pub. No.: US 2022/0236543 A1
(43) Pub. Date: Jul. 28, 2022

(54) VARIABLE MAGNIFICATION OPTICAL SYSTEM AND IMAGING APPARATUS

(71) Applicant: FUJIFILM Corporation, Tokyo (JP)

(72) Inventors: Shinkichi IKEDA, Saitama (JP); Daiki KOMATSU, Saitama (JP); Takashi KUNUGISE, Saitama (JP)

(73) Assignee: FUJIFILM Corporation, Tokyo (JP)

(21) Appl. No.: 17/560,235

(22) Filed: Dec. 22, 2021

(30) Foreign Application Priority Data
Jan. 21, 2021 (JP) 2021-008221
Nov. 9, 2021 (JP) 2021-182841

(51) Int. Cl. G02B 15/14; G02B 3/04

(52) U.S. Cl. CPC G02B 15/1461; G02B 3/04

(57) ABSTRACT

The variable magnification optical system consists of, in order from an object side to an image side, a first lens group that has a positive refractive power, a plurality of lens groups, and a final lens group that has a positive refractive power. During changing magnification, a spacing between the first lens group and the lens group closest to the object side among the plurality of lens groups changes, all spacings between adjacent lens groups in the plurality of lens groups change, and a spacing between the lens group closest to the image side and the final lens group among the plurality of lens groups changes.

### CROSS-REFERENCE TO RELATED APPLICATIONS

The present application claims priority under 35 U.S.C. § 119 to Japanese Patent Application No. 2021-008221, filed on Jan. 21, 2021 and Japanese Patent Application No. 2021-182841, filed on Nov. 9, 2021. Each application above is hereby expressly incorporated by reference, in its entirety, into the present application.

### BACKGROUND

### Technical Field

The technology of the present disclosure relates to a zooming optical system and an imaging apparatus.

### Related Art

In the related art, as a variable magnification optical system applicable to an imaging apparatus such as a broadcasting camera, a movie shooting camera, and a digital camera, for example, the lens systems described in JP2018-205332A, JP2019-139253A, and JP2020-012909A are known.

### SUMMARY

In recent years, there has been a demand for a variable magnification optical system that has a small size and has favorable optical performance

The present disclosure has been made in view of the above circumstances, and an object of the present disclosure is to provide a variable magnification optical system, which is reduced in size and has favorable optical performance, and an imaging apparatus comprising the variable magnification optical system.

The variable magnification optical system according to an aspect of the technique of the present disclosure consists of, in order from an object side to an image side: a first lens group that has a positive refractive power; a plurality of lens groups; and a final lens group that has a positive refractive power. During changing magnification, a spacing between the first lens group and the lens group closest to the object side among the plurality of lens groups changes, all spacings between adjacent lens groups in the plurality of lens groups change, and a spacing between the lens group closest to the image side among the plurality of lens groups and the final lens group changes.

Assuming that a focal length of the first lens group in a state in which an infinite distance object is in focus is f1, a focal length of the variable magnification optical system at a telephoto end in the state in which the infinite distance object is in focus is ft, and an open F number of the variable magnification optical system at the telephoto end in the state in which the infinite distance object is in focus is FNt, it is preferable that the variable magnification optical system of the above-mentioned aspect satisfies Conditional Expression (1) represented by

$$1 < f 1 / ( ft / FNt ) < 3. \qquad ( 1 )$$

Assuming that a maximum image height is Ims, and a focal length of the first lens group in a state in which an infinite distance object is in focus is f1, it is preferable that the variable magnification optical system of the above-mentioned aspect satisfies Conditional Expression (2) represented by

$$0.1 < Ims / f 1 < 0.5 . \qquad ( 2 )$$

It is preferable that a lens group that moves by changing a spacing from an adjacent lens group during changing magnification is a movable lens group, and a movable lens group having a maximum absolute value of a ratio of a lateral magnification of a movable lens group at a telephoto end to a lateral magnification of the movable lens group at a wide angle end among the movable lens groups included in the variable magnification optical system in a state in which an infinite distance object is in focus is a fz group. Assuming that a focal length of the fz group is ffz, and a maximum image height is Ims, it is preferable that the variable magnification optical system of the above-mentioned aspect satisfies Conditional Expression (3) represented by

$$0.05 < \vert Ims / ffz \vert < 0.6 . \qquad ( 3 )$$

It is preferable that a lens group that moves by changing a spacing from an adjacent lens group during changing magnification is a movable lens group, and a movable lens group having a maximum absolute value of a ratio of a lateral magnification of a movable lens group at a telephoto end to a lateral magnification of the movable lens group at a wide angle end among the movable lens groups included in the variable magnification optical system in a state in which an infinite distance object is in focus is a fz group. Assuming that a lateral magnification of the fz group at the telephoto end in the state in which the infinite distance object is in focus is βfzt, it is preferable that the variable magnification optical system of the above-mentioned aspect satisfies Conditional Expression (4) represented by

$$- 0.3 < 1 / β fzt < 0.3 . \qquad ( 4 )$$

It is preferable that a lens group that moves by changing a spacing from an adjacent lens group during changing magnification is a movable lens group, and a movable lens group having a maximum absolute value of a ratio of a lateral magnification of a movable lens group at a telephoto end to a lateral magnification of the movable lens group at a wide angle end among the movable lens groups included in the variable magnification optical system in a state in which an infinite distance object is in focus is a fz group. Assuming that a focal length of the fz group is ffz, and a difference in an optical axis direction between a position of the fz group at the wide angle end and a position of the fz group at the telephoto end is Dpfz, it is preferable that the variable magnification optical system of the above-mentioned aspect satisfies Conditional Expression (5) represented by

$$0.3 < \vert Dpfz / ffz \vert < 3. \qquad ( 5 )$$

It is preferable that the plurality of lens groups include, in order from a position closest to the object side to the image side, a middle group, which includes one or more lens groups and has a negative refractive power as a whole, and a negative movable lens group, which has a negative refractive power and moves during changing magnification, and the negative movable lens group is positioned closest to the image side in the lens groups having negative refractive powers in the plurality of lens groups.

Assuming that a focal length of the middle group at a wide angle end in a state in which an infinite distance object is in focus is fMw, and a focal length of the negative movable lens group is fN, it is preferable that the variable magnification optical system of the above-mentioned aspect satisfies Conditional Expression (6) represented by

$$0.2 < fMw / fN < 0.7 . \qquad ( 6 )$$

In a configuration in which the negative movable lens group includes one or more negative lenses and one or more positive lenses, assuming that a maximum absolute value of a difference between an Abbe number of the negative lens included in the negative movable lens group based on a d line and an Abbe number of the positive lens included in the negative movable lens group based on the d line is μNdif, it is preferable that the variable magnification optical system of the above-mentioned aspect satisfies Conditional Expression (7) represented by

$$40 < ν Ndif < 95. \qquad ( 7 )$$

In a configuration in which the middle group includes one or more positive lenses, assuming that an Abbe number of the positive lens, of which an Abbe number based on a d line is maximum, among the positive lenses included in the middle group based on the d line is νM and a partial dispersion ratio thereof between a g line and an F line is θM, it is preferable that the variable magnification optical system of the above-mentioned aspect satisfies Conditional Expression (8) represented by

$$- 0.02 < θ M + 0.00 \; 18 \times ν M - 0. 64833 < 0 .07 . \qquad ( 8 )$$

Assuming that a curvature radius of an image side surface of a negative lens closest to the object side in the middle group is RMnr, and a curvature radius of an object side surface of a lens disposed adjacent to the image side of a negative lens closest to the object side in the middle group is RMf, it is preferable that the variable magnification optical system of the above-mentioned aspect satisfies Conditional Expression (9) represented by

$$- 1.5 < ( RMnr + RMf ) / ( RMnr - RMf ) < 0.2 . \qquad ( 9 )$$

Assuming that a difference in an optical axis direction between a position of a lens surface closest to the image side in the middle group at a wide angle end and a position of a lens surface closest to the image side in the middle group at a telephoto end in a state in which an infinite distance object is in focus is DpM, a focal length of the variable magnification optical system at a wide angle end in the state in which the infinite distance object is in focus is fw, a focal length of the variable magnification optical system at a telephoto end in the state in which the infinite distance object is in focus is ft, and a maximum image height is Ims, it is preferable that the variable magnification optical system of the above-mentioned aspect satisfies Conditional Expression (10) represented by

$$0.2 < DpM / \{ ( f t / fw ) \times Ims \} < 0.9 . \qquad ( 10 )$$

Assuming that an effective diameter of a lens surface closest to the object side in the middle group in a state in which an infinite distance object is in focus is EDMf, and an effective diameter of a lens surface closest to the image side in the middle group in the state in which the infinite distance object is in focus is EDMr, it is preferable that the variable magnification optical system of the above-mentioned aspect satisfies Conditional Expression (11) represented by

$$0.5 < \text{EDMf} \text{/} \text{EDMr} < 3.25 . \qquad ( 11 )$$

Assuming that a height of a principal ray from an optical axis at a maximum image height on a lens surface closest to the object side in the middle group at the wide angle end in the state in which the infinite distance object is in focus is HMfb, a height of the on-axis marginal ray from the optical axis on the lens surface closest to the object side in the middle group at the wide angle end in the state in which the infinite distance object is in focus is HMfa, a height of a principal ray from the optical axis at a maximum image height on a lens surface closest to the image side in the middle group at the wide angle end in the state in which the infinite distance object is in focus is HMrb, and a height of an on-axis marginal ray from the optical axis on the lens surface closest to the image side in the middle group at the wide angle end in the state in which the infinite distance object is in focus is HMra, it is preferable that the variable magnification optical system of the above-mentioned aspect satisfies Conditional Expression (12) represented by

$$1 < \vert ( \text{HMfb/HMfa} \text{)/(} \text{HMrb/HMra} ) \vert < 3. \qquad ( 12 )$$

The plurality of lens groups may be configured to consist of an middle group and a negative movable lens group.

The middle group may be configured to consist of a front lens group having a positive refractive power and a rear lens group having a negative refractive power in order from the object side to the image side, and a spacing between the front lens group and the rear lens group changes during changing magnification.

Groups, which are included in the plurality of lens groups and move by changing a spacing from an adjacent lens group during changing magnification, may be configured to consist of, in order from the object side to the image side, the middle group, the negative movable lens group, and a positive movable lens group having a positive refractive power.

Assuming that a maximum image height is Ims, and a focal length of the final lens group is fE, it is preferable that the variable magnification optical system of the above-mentioned aspect satisfies Conditional Expression (13) represented by

$$0 .1 < \text{Ims/fE} < 0.6 . \qquad ( 13 )$$

Assuming that an Abbe number of the positive lens, of which an Abbe number based on a d line is maximum, among the positive lenses included in the final lens group based on the d line is νE and a partial dispersion ratio thereof between a g line and an F line is θE, it is preferable that the variable magnification optical system of the above-mentioned aspect satisfies Conditional Expression (14) represented by

$$0.02 < θ E + 0.0018 \times v E - 0.64833 < 0.08 . \qquad ( 14 )$$

It is preferable that the variable magnification optical system of the above-mentioned aspect includes a focus group that performs focusing by moving along an optical axis. Assuming that a specific gravity of each lens in the focus group is Sgf and a refractive index thereof at a d line is Nf, an average value of Sgf/Nf of all lenses in the focus group is ave(Sgf/Nf), and a maximum value of refractive indexes of all the lenses in the focus group at the d line is Nfmax, it is preferable that the variable magnification optical system satisfies Conditional Expressions (15) and (16) represented by

$$\begin{matrix}2.05 < ave ( \text{Sgf/Nf} ) < 2.55 , and & ( 15 ) \\ 1.7 < Nf max < 2.2 . & ( 16 )\end{matrix}$$

It is preferable that in a case where a lens group that moves by changing a spacing from an adjacent lens group during changing magnification is a movable lens group, the number of the movable lens groups included in the variable magnification optical system is three or more, and the movable lens group closest to the object side among the movable lens groups included in the variable magnification optical system has a positive refractive power.

It is preferable that the movable lens group closest to the object side among the movable lens groups included in the variable magnification optical system consists of one positive lens having a convex surface facing toward the object side. In such a case, assuming that a curvature radius of an object side surface of the positive lens having the convex surface facing toward the object side is Rpf, and a curvature radius of an image side surface of the positive lens having the convex surface facing toward the object side is Rpr, it is preferable that the variable magnification optical system of the above-mentioned aspect satisfies Conditional Expression (17) represented by

$$- 6 < ( Rpf - Rpr \text{)/(} Rpf + Rpr ) < 1. \qquad ( 17 )$$

The first lens group may be configured to consist of, in order from the object side to the image side, a first A subgroup having a negative refractive power, a first B subgroup having a positive refractive power, and a first C subgroup having a positive refractive power, and focusing is performed by moving the first B subgroup along an optical axis.

Assuming that a maximum image height is Ims, and a focal length of the first C subgroup is f1C, it is preferable that the variable magnification optical system of the above-mentioned aspect satisfies Conditional Expression (18) represented by

$$0.05 < \text{Ims/f} \text{1} \text{C} < 0.3 . \qquad ( 18 )$$

Assuming that a focal length of the first lens group is f1, and a focal length of the first B subgroup is f1B, it is preferable that the variable magnification optical system of the above-mentioned aspect satisfies Conditional Expression (19) represented by

$$0 .3 < \text{f} \text{1} \text{/f} \text{1} \text{B} < 0.9 . \qquad ( 19 )$$

In a configuration in which the first B subgroup includes one or more positive lenses and one or more negative lenses, assuming that an Abbe number of the positive lens, of which an Abbe number based on a d line is maximum, among the positive lenses included in the first B subgroup based on the d line is ν1Bp, and a partial dispersion ratio thereof between a g line and an F line is θ1Bp, and a minimum value of Abbe numbers of all the negative lenses included in the first B subgroup based on the d line is ν1Bn, it is preferable that the variable magnification optical system of the above-mentioned aspect satisfies Conditional Expressions (20) and (21) represented by

$$\begin{matrix}0.01 < θ1 Bp + 0. 0018 \times v 1 Bp - 0. 64833 < 0.07 , and & ( 20 ) \\ 15 < v 1 Bn < 40. & ( 21 )\end{matrix}$$

It is preferable that the first A subgroup includes two or more negative lenses of which Abbe numbers based on a d line are 50 or more. Assuming that a minimum value of Abbe numbers of all the positive lenses included in the first A subgroup based on the d line is ν1Ap, it is preferable that the variable magnification optical system of the above-mentioned aspect satisfies Conditional Expression (22) represented by

$$15 < v 1 Ap < 40. \qquad ( 22 )$$

It is preferable that the first lens group remains stationary with respect to an image plane during changing magnification.

It is preferable that the final lens group remains stationary with respect to an image plane during changing magnification, and a stop is disposed closest to the object side in the final lens group. In such a case, it is preferable that a lens component disposed adjacent to the image side of the stop has a biconvex shape. It should be noted that one lens component is one single lens or one group of cemented lenses. Assuming that a curvature radius of a surface closest to the object side of the lens component disposed adjacent to the image side of the stop is REf, and a curvature radius of a surface closest to the image side of the lens component disposed adjacent to the image side of the stop is REr, it is preferable that the variable magnification optical system of the above-mentioned aspect satisfies Conditional Expression (23) represented by

$$- 0.7 < ( REf + REr \text{)/(} REf - REr ) < 0.7 . \qquad ( 23 )$$

Assuming that a temperature coefficient of a relative refractive index of a lens in the final lens group at a d line in a range of 20° C. to 40° C. is dN/dT and a unit of dN/dT is ° C.⁻¹, it is preferable that the final lens group includes one or more lenses respectively having an Abbe number based on the d line of 65 or more and satisfying Conditional Expression (24), which is represented by

$$0 < \text{dN/dT} < 8 \times 1 {0}^{- 6} . \qquad ( 24 )$$

An imaging apparatus according to another aspect of the technique of the present disclosure includes a variable magnification optical system according to the above-mentioned aspect of the present disclosure.

In the present specification, it should be noted that the terms “consisting of ˜” and “consists of ˜” mean that the lens may include not only the above-mentioned constituent elements but also lenses substantially having no refractive powers, optical elements, which are not lenses, such as a stop, a filter, and a cover glass, and mechanism parts such as a lens flange, a lens barrel, an imaging element, and a camera shaking correction mechanism.

The term “˜ group that has a positive refractive power” in the present specification means that the group has a positive refractive power as a whole. Similarly, the term “˜ group having a negative refractive power” means that the group has a negative refractive power as a whole. The term “a lens having a positive refractive power” and the term “a positive lens” are synonymous. The term “a lens having a negative refractive power” and the term “negative lens” are synonymous. The terms “˜ lens group” and “˜ subgroup” are not limited to a configuration in which the lens group consists of a plurality of lenses, but the lens group may consist of only one lens.

The term “a single lens” means one lens that is not cemented. Here, a compound aspheric lens (a lens in which a spherical lens and an aspheric film formed on the spherical lens are integrally formed and function as one aspheric lens as a whole) is not regarded as cemented lenses, but the compound aspheric lens is regarded as one lens. Unless otherwise specified, the sign of refractive power, the surface shape, and the curvature radius of a lens including an aspherical surface are considered in terms of the paraxial region. The sign of the curvature radius of the surface convex toward the object side is positive and the sign of the curvature radius of the surface convex toward the image side is negative.

The “focal length” used in a conditional expression is a paraxial focal length. The values used in conditional expressions are values in the case of using the d line as a reference in a state in which the infinite distance object is in focus.

The partial dispersion ratio θgF between the g line and the F line of a certain lens is defined by θgF=(Ng−NF)/(NF−NC), where Ng, NF, and NC are the refractive indexes of the lens at the g line, the F line, and the C line. The “d line”, “C line”, “F line”, and “g line” described in the present specification are emission lines. In the present specification, it is assumed that the d line wavelength is 587.56 nm (nanometers), the C line wavelength is 656.27 nm (nanometers), the F line wavelength is 486.13 nm (nanometers), and the g line wavelength is 435.84 nm (nanometers).

According to the technique of the present disclosure, it is possible to provide a variable magnification optical system, which is reduced in size and has favorable optical performance, and an imaging apparatus comprising the variable magnification optical system.

### BRIEF DESCRIPTION OF THE DRAWINGS

FIG. 1 is a cross-sectional view of a configuration of a variable magnification optical system according to an embodiment corresponding to the variable magnification optical system of Example 1, and is a diagram showing movement loci.

FIG. 2 is a cross-sectional view of the configuration of the variable magnification optical system shown in FIG. 1, and is a diagram showing luminous flux.

FIG. 3 is a diagram for explaining an effective diameter.

FIG. 4 is a diagram for explaining a symbol of Conditional Expression (12).

FIG. 5 is a diagram of aberrations of the variable magnification optical system of Example 1.

FIG. 6 is a cross-sectional view of the configuration of the variable magnification optical system of Example 2, and is a diagram showing movement loci.

FIG. 7 is a diagram of aberrations of the variable magnification optical system of Example 2.

FIG. 8 is a cross-sectional view of the configuration of the variable magnification optical system of Example 3, and is a diagram showing movement loci.

FIG. 9 is a diagram of aberrations of the variable magnification optical system of Example 3.

FIG. 10 is a cross-sectional view of the configuration of the variable magnification optical system of Example 4, and is a diagram showing movement loci.

FIG. 11 is a diagram of aberrations of the variable magnification optical system of Example 4.

FIG. 12 is a cross-sectional view of the configuration of the variable magnification optical system of Example 5, and is a diagram showing movement loci.

FIG. 13 is a diagram of aberrations of the variable magnification optical system of Example 5.

FIG. 14 is a cross-sectional view of the configuration of the variable magnification optical system of Example 6, and is a diagram showing movement loci.

FIG. 15 is a diagram of aberrations of the variable magnification optical system of Example 6.

FIG. 16 is a cross-sectional view of the configuration of the variable magnification optical system of Example 7, and is a diagram showing movement loci.

FIG. 17 is a diagram of aberrations of the variable magnification optical system of Example 7.

FIG. 18 is a cross-sectional view of the configuration of the variable magnification optical system of Example 8, and is a diagram showing movement loci.

FIG. 19 is a diagram of aberrations of the variable magnification optical system of Example 8.

FIG. 20 is a cross-sectional view of the configuration of the variable magnification optical system of Example 9, and is a diagram showing movement loci.

FIG. 21 is a diagram of aberrations of the variable magnification optical system of Example 9.

FIG. 22 is a cross-sectional view of the configuration of the variable magnification optical system of Example 10, and is a diagram showing movement loci.

FIG. 23 is a diagram of aberrations of the variable magnification optical system of Example 10.

FIG. 24 is a cross-sectional view of the configuration of the variable magnification optical system of Example 11, and is a diagram showing movement loci.

FIG. 25 is a diagram of aberrations of the variable magnification optical system of Example 11.

FIG. 26 is a cross-sectional view of the configuration of the variable magnification optical system of Example 12, and is a diagram showing movement loci.

FIG. 27 is a diagram of aberrations of the variable magnification optical system of Example 12.

FIG. 28 is a cross-sectional view of the configuration of the variable magnification optical system of Example 13, and is a diagram showing movement loci.

FIG. 29 is a diagram of aberrations of the variable magnification optical system of Example 13.

FIG. 30 is a cross-sectional view of the configuration of the variable magnification optical system of Example 14, and is a diagram showing movement loci.

FIG. 31 is a diagram of aberrations of the variable magnification optical system of Example 14.

FIG. 32 is a cross-sectional view of the configuration of the variable magnification optical system of Example 15, and is a diagram showing movement loci.

FIG. 33 is a diagram of aberrations of the variable magnification optical system of Example 15.

FIG. 34 is a diagram showing a schematic configuration of an imaging apparatus according to an embodiment.

### DESCRIPTION OF EMBODIMENTS

Hereinafter, embodiments according to the technique of the present disclosure will be described with reference to the accompanying drawings.

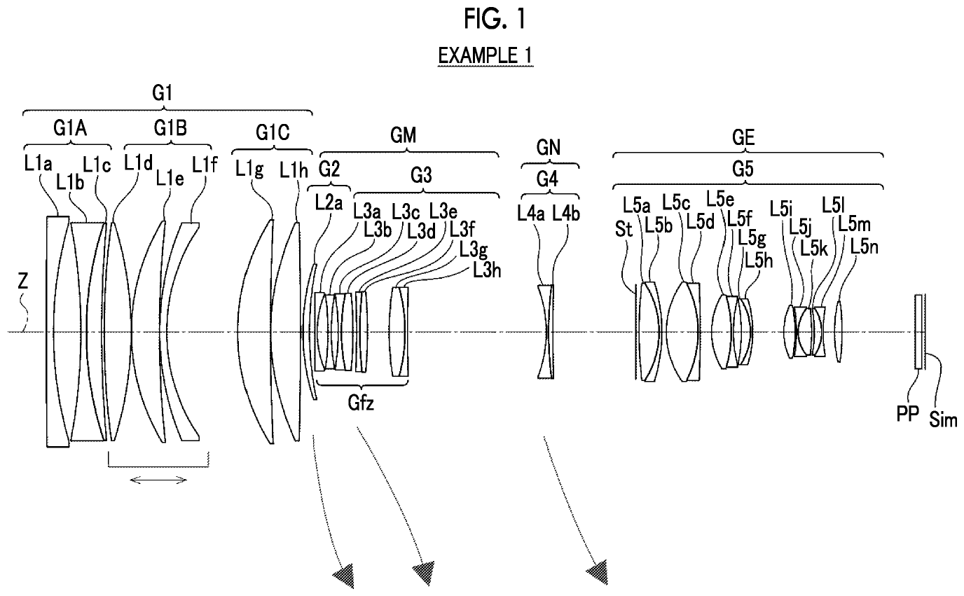

FIG. 1 shows a cross-sectional view of the configuration at the wide angle end of the variable magnification optical system according to the embodiment of the present disclosure and shows movement loci. The example shown in FIG. 1 corresponds to the variable magnification optical system of Example 1 to be described later. FIG. 1 shows a state in which the infinite distance object is in focus, the left side thereof is an object side, and the right side thereof is an image side.

FIG. 1 shows an example in which an optical member PP having a parallel plate shape is disposed between a variable magnification optical system and an image plane Sim under assumption that the variable magnification optical system is applied to the imaging apparatus. The optical member PP is a member assumed to include various filters, a cover glass, and the like. The various filters include, for example, a low pass filter, an infrared cut filter, and a filter that cuts a specific wavelength region. The optical member PP is a member that has no refractive power. It is also possible to configure the imaging apparatus by removing the optical member PP.

The variable magnification optical system according to the present embodiment consists of, in order from the object side to the image side, a first lens group G1, a plurality of lens groups, and a final lens group GE. It should be noted that the term “lens group” in the present specification refers to a part including the at least one lens, which is a constituent part of the variable magnification optical system and is divided by an air spacing that changes during changing magnification. During changing magnification, the lens groups move or remain stationary, and the mutual spacing between the lenses in one lens group does not change.

The first lens group G1 is a lens group having a positive refractive power. By forming the lens group closest to the object side as the first lens group G1 having a positive refractive power, it is possible to achieve reduction in total length of the lens system. Thus, there is an advantage in achieving reduction in size. The final lens group GE is a lens group having a positive refractive power. By setting the final lens group GE closest to the image side as a lens group having a positive refractive power, it is possible to suppress an increase in angle at which the principal ray of the off-axis luminous flux is incident on the image plane Sim. As a result, there is an advantage in suppressing shading.

During changing magnification, a spacing between the first lens group G1 and the lens group closest to the object side among the plurality of lens groups changes, all spacings between adjacent lens groups in the plurality of lens groups change, and a spacing between the lens group closest to the image side among the plurality of lens groups and the final lens group GE changes.

For example, the variable magnification optical system in FIG. 1 consists of, in order from the object side to the image side, a first lens group G1 having a positive refractive power, a second lens group G2 having a positive refractive power, a third lens group G3 having a negative refractive power, a fourth lens group G4 having a negative refractive power, and a fifth lens group G5 having a positive refractive power. The plurality of lens groups correspond to the second lens group G2, the third lens group G3, and the fourth lens group G4. The final lens group GE corresponds to the fifth lens group G5.

In the example of FIG. 1, the first lens group G1 consists of eight lenses L1a to L1h in order from the object side to the image side. The second lens group G2 consists of one lens L2a. The third lens group G3 consists of eight lenses L3a to L3h in order from the object side to the image side. The fourth lens group G4 consists of two lenses L4a and L4b in order from the object side to the image side. The fifth lens group G5 consists of an aperture stop St and fourteen lenses L5a to L5n in order from the object side to the image side. It should be noted that the aperture stop St shown in FIG. 1 does not indicate a shape thereof, but indicates a position thereof in the direction of the optical axis.

In the example of FIG. 1, the first lens group G1 and the fifth lens group G5 remain stationary with respect to the image plane Sim during changing magnification. Since the lens group closest to the object side and the lens group closest to the image side remain stationary during changing magnification, the distance from the lens surface closest to the object side to the lens surface closest to the image side does not change during changing magnification. According to this configuration, fluctuation in centroid of the lens system during changing magnification can be reduced. Therefore, the convenience during imaging can be enhanced.

Further, in the example of FIG. 1, during changing magnification, the second lens group G2, the third lens group G3, and the fourth lens group G4 move along the optical axis Z by changing the spacings between the adjacent lens groups. In FIG. 1, arrows below respective lens groups indicate approximate movement loci of the second lens group G2, the third lens group G3, and the fourth lens group G4 during changing magnification from the wide angle end to the telephoto end.

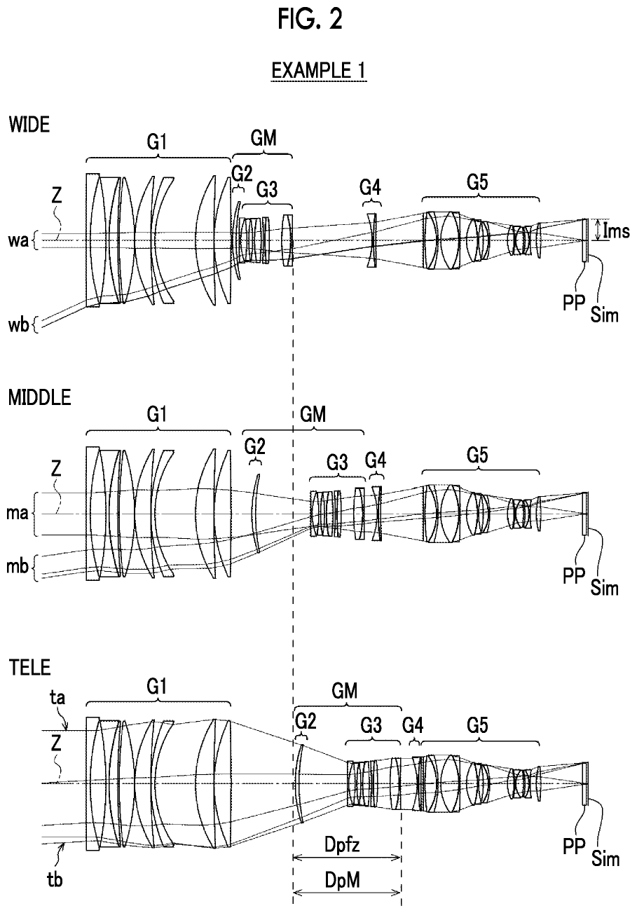

FIG. 2 shows a cross-sectional view of the configuration of the variable magnification optical system and luminous flux in each zooming state in FIG. 1. In FIG. 2, the upper part labeled by “WIDE” shows the wide angle end state, the middle part labeled by “MIDDLE” shows the middle focal length state, and the lower part labeled by “TELE” shows the telephoto end state. FIG. 2 shows luminous flux including on-axis luminous flux wa and luminous flux wb at the maximum image height Ims at the wide angle end state, on-axis luminous flux ma and luminous flux mb at the maximum image height Ims at the middle focal length state, and on-axis luminous flux to and luminous flux tb at the maximum image height Ims at the telephoto end state. FIG. 2 shows a state in which the infinite distance object is in focus, the left side thereof is an object side, and the right side thereof is an image side. In FIG. 2, some reference numerals are not repeated in order to avoid complication of the drawings.

In the variable magnification optical system according to the present embodiment, Assuming that a focal length of the first lens group G1 in the state in which the infinite distance object is in focus is f1, a focal length of the variable magnification optical system at a telephoto end in the state in which the infinite distance object is in focus is ft, and an open F number of the variable magnification optical system at the telephoto end in the state in which the infinite distance object is in focus is FNt, it is preferable to satisfy Conditional Expression (1). By not allowing the corresponding value of Conditional Expression (1) to be equal to or less than the lower limit, it is possible to suppress an increase in emission angle of the on-axis marginal ray from the first lens group G1 at the telephoto end. As a result, during changing magnification from the wide angle side to the telephoto side, the second lens group G2 can be easily moved to the image side. Thus, there is an advantage in achieving an increase in magnification. Further, by not allowing the corresponding value of Conditional Expression (1) to be equal to or less than the lower limit, there is an advantage in preventing F drop. The F drop is a phenomenon in which the F number becomes remarkably large on the telephoto side from a certain focal length during changing magnification from the wide angle end to the telephoto end. In some conventional variable magnification optical systems, particularly, high magnification variable magnification optical systems, F drop is caused from the viewpoint of size and weight. However, in some cases, a user may request that the F number is substantially constant even during changing magnification from the wide angle end to the telephoto end. By not allowing the corresponding value of Conditional Expression (1) to be equal to or less than the lower limit, it is easy to meet such a request. By not allowing the corresponding value of Conditional Expression (1) to be equal to or greater than the upper limit, it is easy to prevent the emission angle of the on-axis marginal ray from the first lens group G1 at the telephoto end from becoming excessively small. As a result, it is possible to suppress an increase in height of the on-axis marginal ray passing through the second lens group G2 from the optical axis Z. Thus, there is an advantage in achieving reduction in diameter of the second lens group G2. In order to obtain more favorable characteristics, it is more preferable that the variable magnification optical system satisfies Conditional Expression (1-1), and it is yet more preferable that the variable magnification optical system satisfies Conditional Expression (1-2).

$$\begin{matrix}1 < \text{f} \text{1} \text{/(ft/FNt)} < 3 & ( 1 ) \\ 1.1 < \text{f} \text{1} \text{/(ft/FNt)} < 2.75 & ( \text{1-1} ) \\ 1.3 < \text{f} \text{1} \text{/(ft/FNt)} < 2.5 & ( \text{1-2)}\end{matrix}$$

Assuming that a maximum image height is Ims, and a focal length of the first lens group G1 in the state in which the infinite distance object is in focus is f1, it is preferable that the variable magnification optical system according to the present embodiment satisfies Conditional Expression (2). By not allowing the corresponding value of Conditional Expression (2) to be equal to or less than the lower limit, the refractive power of the first lens group G1 can be ensured. Therefore, the spherical aberration can be suppressed from being insufficiently corrected, particularly on the telephoto side. Further, it is possible to suppress an increase in diameter of the second lens group G2. By not allowing the corresponding value of Conditional Expression (2) to be equal to or greater than the upper limit, the refractive power of the first lens group G1 is prevented from becoming excessively strong. Therefore, it is possible to suppress overcorrection of spherical aberration. In order to obtain more favorable characteristics, it is more preferable that the variable magnification optical system satisfies Conditional Expression (2-1), and it is yet more preferable that the variable magnification optical system satisfies Conditional Expression (2-2).

$$\begin{matrix}0.1 < Ims / f 1 < 0.5 & ( 2 ) \\ 0.11 < Ims / f 1 < 0.35 & ( 2 \text{-} 1 ) \\ 0.12 < Ims / f 1 < 0.2 & ( 2 \text{-} 2 )\end{matrix}$$

Further, it is preferable that the variable magnification optical system according to the present embodiment satisfies at least one of Conditional Expressions (3) to (5) with respect to the fz group defined below. In the present specification, a lens group that moves by changing the spacing from an adjacent lens group during changing magnification is referred to as a “movable lens group”.

Among the movable lens groups included in the variable magnification optical system, a movable lens group, of which the absolute value of the ratio of the lateral magnification of the movable lens group at the telephoto end to the lateral magnification of the movable lens group at the wide angle end is the maximum in a state where the infinite distance object is in focus, is defined as the fz group. That is, for each movable lens group included in the variable magnification optical system, assuming that a lateral magnification of the movable lens group at the wide angle end in a state where the infinite distance object is in focus is βw and a lateral magnification of the movable lens group at the telephoto end in a state where the infinite distance object is in focus is βt, the movable lens group having the maximum|βt/βw| is defined as the fz group.

In the example of FIG. 1, the movable lens group is the second lens group G2, the third lens group G3, and the fourth lens group G4. In the example of FIG. 1, of the three lens groups, the third lens group G3 is the fz group.

Assuming that a focal length of the fz group is ffz and a maximum image height is Ims, it is preferable that the variable magnification optical system according to the present embodiment satisfies Conditional Expression (3). Among the movable lens groups included in the variable magnification optical system, the fz group defined by the above definition is a lens group having a main zooming effect. By not allowing the corresponding value of Conditional Expression (3) to be equal to or less than the lower limit, it is possible to ensure that the refractive power of the fz group is not weakened. Thereby, the amount of movement of the fz group at the time of zooming can be suppressed. As a result, there is an advantage in shortening the total length of the lens system, or there is an advantage in achieving an increase in magnification while maintaining the predetermined total length of the lens system. By not allowing the corresponding value of Conditional Expression (3) to be equal to or greater than the upper limit, the refractive power of the fz group is prevented from becoming excessively strong. Therefore, it is easy to suppress fluctuation in spherical aberration and fluctuation in field curvature due to zooming. In order to obtain more favorable characteristics, it is more preferable that the variable magnification optical system satisfies Conditional Expression (3-1), and it is yet more preferable that the variable magnification optical system satisfies Conditional Expression (3-2).

$$\begin{matrix}0.05 < \vert Ims / ffz \vert < 0.6 & ( 3 ) \\ 0.1 < \vert Ims / ffz \vert < 0.5 & ( 3 \text{-} 1 ) \\ 0.12 < \vert Ims / ffz \vert < 0.41 & ( 3 \text{-} 2 )\end{matrix}$$

Assuming that a lateral magnification of the fz group at the telephoto end in the state in which the infinite distance object is in focus is βfzt, it is preferable that the fz group satisfies Conditional Expression (4). In a case where the lateral magnification of the fz group is within the range of Conditional Expression (4), it is easy to increase the magnification while shortening the total length of the lens system. In order to obtain more favorable characteristics, it is more preferable that the fz group satisfies Conditional Expression (4-1), and it is yet more preferable that the fz group satisfies Conditional Expression (4-2).

$$\begin{matrix}- 0 .3 < \text{1/β} \text{fzt} < 0.3 & ( 4 ) \\ - 0.25 < \text{1/β} \text{fzt} < 0.1 & ( \text{4-1)} \\ - 0.15 < \text{1/β} \text{fzt} < 0.05 & ( \text{4-2)}\end{matrix}$$

Assuming that a focal length of the fz group is ffz and a difference in the optical axis direction between a position of the fz group at the wide angle end and a position of the fz group at the telephoto end is Dpfz, it is preferable that the fz group satisfies Conditional Expression (5). By not allowing the corresponding value of Conditional Expression (5) to be equal to or less than the lower limit, the amount of movement of the fz group can be ensured. Therefore, it is easy to increase the magnification. By not allowing the corresponding value of Conditional Expression (5) to be equal to or greater than the upper limit, the amount of movement of the fz group during changing magnification can be suppressed. As a result, there is an advantage in shortening the total length of the lens system. In order to obtain more favorable characteristics, it is more preferable that the fz group satisfies Conditional Expression (5-1), and it is yet more preferable that the fz group satisfies Conditional Expression (5-2).

$$\begin{matrix}0.3 < \vert \text{Dpfz/ffz} \vert < 3 & ( 5 ) \\ 0.45 < \vert \text{Dpfz/ffz} \vert < 2.5 & ( \text{5-1)} \\ 0.6 < \vert \text{Dpfz/ffz} \vert < 2 & \text{(5-2)}\end{matrix}$$

For example, FIG. 2 shows Dpfz in a case where the third lens group G3 is the fz group. In FIG. 2, Dpfz and DpM to be described later are the same, but this is an example. In the variable magnification optical system of the present disclosure, Dpfz and DpM may be different.

In the variable magnification optical system according to the present embodiment, the plurality of lens groups disposed between the first lens group G1 and the final lens group GE may be configured to include the middle group GM and the negative movable lens group GN in order from the position closest to the object side to the image side. The middle group GM is a group including one or more lens groups and having a negative refractive power as a whole. The negative movable lens group GN is a lens group having a negative refractive power positioned closest to the image side among the lens groups having a negative refractive power in the plurality of lens groups, and is a lens group that moves during changing magnification. In such a case, fluctuation in spherical aberration and fluctuation in chromatic aberration caused by the middle group GM during changing magnification can be reduced by the negative movable lens group GN. Therefore, there is an advantage in achieving both a small F number and an increase in magnification. In the above-mentioned phrase “a plurality of lens groups include an middle group GM and a negative movable lens group GN in order from the position closest to the object side to the image side”, the middle group GM and the negative movable lens group GN may be continuously disposed, and may be discontinuously disposed.

In a case where the variable magnification optical system includes the middle group GM, the middle group GM may be configured to consist of a front lens group having a positive refractive power and a rear lens group having a negative refractive power in order from the object side to the image side, and a spacing between the front lens group and the rear lens group changes during changing magnification. In such a case, it is easy to satisfactorily suppress fluctuations in various aberrations due to zooming.

In the example of FIG. 1, the middle group GM consists of the second lens group G2 and the third lens group G3. In the example of FIG. 1, the front lens group corresponds to the second lens group G2, the rear lens group corresponds to the third lens group G3, and the negative movable lens group GN corresponds to the fourth lens group G4.

As in the example of FIG. 1, the plurality of lens groups disposed between the first lens group G1 and the final lens group GE may be configured to consist of the middle group GM and the negative movable lens group GN. By limiting the group which is present between the first lens group G1 and the final lens group GE to only the middle group GM and the negative movable lens group GN, it is easy to reduce the size of the optical system.

With respect to the middle group GM and the negative movable lens group GN, it is preferable that the variable magnification optical system according to the present embodiment satisfies at least one of Conditional Expressions (6) to (12).

Assuming that a focal length of the middle group GM at a wide angle end in a state in which the infinite distance object is in focus is fMw, and a focal length of the negative movable lens group GN is fN, it is preferable that the variable magnification optical system according to the present embodiment satisfies Conditional Expression (6). By not allowing the corresponding value of Conditional Expression (6) to be equal to or less than the lower limit, there is an advantage in suppressing fluctuations in various aberrations due to zooming. By not allowing the corresponding value of Conditional Expression (6) to be equal to or greater than the upper limit, there is an advantage in shortening the total length of the lens system, or there is an advantage in increasing the magnification while maintaining the predetermined total length of the lens system. In order to obtain more favorable characteristics, it is more preferable that the variable magnification optical system satisfies Conditional Expression (6-1), and it is yet more preferable that the variable magnification optical system satisfies Conditional Expression (6-2).

$$\begin{matrix}0.2 < fMw / fN < 0.7 & ( 6 ) \\ 0.25 < fMw / fN < 0.65 & ( 6 \text{-} 1 ) \\ 0.4 < fMw / fN < 0.6 & ( 6 \text{-} 2 )\end{matrix}$$

In a configuration in which the negative movable lens group GN includes one or more negative lenses and one or more positive lenses. Assuming that a maximum absolute value of a difference between an Abbe number of the negative lens included in the negative movable lens group GN based on the d line and an Abbe number of the positive lens included in the negative movable lens group GN based on the d line is μNdif, it is preferable that the variable magnification optical system according to the present embodiment satisfies Conditional Expression (7). By not allowing the corresponding value of Conditional Expression (7) to be equal to or less than the lower limit, it is easy to suppress fluctuation in chromatic aberration due to zooming. By not allowing the corresponding value of Conditional Expression (7) to be equal to or greater than the upper limit, a material having a high refractive index can be selected. Therefore, it is easy to satisfactorily suppress fluctuations in various aberrations due to zooming while achieving reduction in size and high magnification. In order to obtain more favorable characteristics, it is more preferable that the variable magnification optical system satisfies Conditional Expression (7-1), and it is yet more preferable that the variable magnification optical system satisfies Conditional Expression (7-2).

$$\begin{matrix}40 < ν Ndif < 95 & ( 7 ) \\ 45 < ν Ndif < 85 & ( 7 \text{-} 1 ) \\ 50 < ν Ndif < 75 & ( 7 \text{-} 2 )\end{matrix}$$

In a configuration in which the middle group GM includes one or more positive lenses, assuming that an Abbe number of the positive lens having a largest Abbe number based on the d line among the positive lenses included in the middle group GM is νM and a partial dispersion ratio thereof between the g line and the F line is θM, it is preferable that the variable magnification optical system according to the present embodiment satisfies Conditional Expression (8). By satisfying Conditional Expression (8), it is easy to satisfactorily suppress fluctuation in secondary chromatic aberration due to the zooming. In order to obtain more favorable characteristics, it is more preferable that the variable magnification optical system satisfies Conditional Expression (8-1), and it is yet more preferable that the variable magnification optical system satisfies Conditional Expression (8-2).

$$\begin{matrix}- 0.02 < θ M + 0.0018 \times v M - 0.64833 < 0.07 & ( 8 ) \\ - 0.015 < θ M + 0.0018 \times v M - 0.64833 < 0.065 & ( 8 \text{-} 1 ) \\ 0.02 < θ M + 0.0018 \times v M - 0.64833 < 0.06 & ( 8 \text{-} 2 )\end{matrix}$$

Since the middle group GM has a negative refractive power as a whole, the middle group GM includes one or more negative lenses. Among the negative lenses included in the middle group GM, assuming that a curvature radius of an image side surface of a negative lens closest to the object side in the middle group GM is RMnr, and a curvature radius of an object side surface of a lens disposed adjacent to the image side of a negative lens closest to the object side in the middle group GM is RMf, it is preferable that the variable magnification optical system according to the present embodiment satisfies Conditional Expression (9). By not allowing the corresponding value of Conditional Expression (9) to be equal to or less than the lower limit, the refractive power of the negative lens closest to the object side in the middle group GM is prevented from becoming excessively strong. Therefore, it is easy to suppress fluctuations in various aberrations due to zooming. By not allowing the corresponding value of Conditional Expression (9) to be equal to or greater than the upper limit, the amount of movement of the middle group GM during changing magnification can be suppressed while maintaining a predetermined zoom magnification (that is, the magnification of the zooming). As a result, there is an advantage in achieving both reduction in size and an increase in magnification. In order to obtain more favorable characteristics, it is more preferable that the variable magnification optical system satisfies Conditional Expression (9-1), and it is yet more preferable that the variable magnification optical system satisfies Conditional Expression (9-2).

$$\begin{matrix}- 1.5 < ( RMnr + RMf ) / ( RMnr - RMf ) < 0.2 & ( 9 ) \\ - 1 < ( RMnr + RMf ) / ( RMnr - RMf ) < 0.1 & ( 9 \text{-} 1 ) \\ - 0.5 < ( RMnr + RMf ) / ( RMnr - RMf ) < 0. 05 & ( 9 \text{-} 2 )\end{matrix}$$

Assuming that a difference in the optical axis direction between a position of a lens surface closest to the image side in the middle group GM at a wide angle end and a position of a lens surface closest to the image side in the middle group GM at a telephoto end in the state in which the infinite distance object is in focus is DpM, a focal length of the variable magnification optical system at a wide angle end in the state in which the infinite distance object is in focus is fw, a focal length of the variable magnification optical system at a telephoto end in the state in which the infinite distance object is in focus is ft, and a maximum image height is Ims, it is preferable that the variable magnification optical system according to the present embodiment satisfies Conditional Expression (10). By not allowing the corresponding value of Conditional Expression (10) to be equal to or less than the lower limit, it is easy to satisfactorily suppress fluctuations in aberrations due to zooming. By not allowing the corresponding value of Conditional Expression (10) to be equal to or greater than the upper limit, there is an advantage in achieving both reduction in size and an increase in magnification. In order to obtain more favorable characteristics, it is more preferable that the variable magnification optical system satisfies Conditional Expression (10-1), and it is yet more preferable that the variable magnification optical system satisfies Conditional Expression (10-2).

$$\begin{matrix}0.2 < DpM / \{ ( f t / fw ) \times Ims \} < 0.9 & ( 10 ) \\ 0.3 < DpM / \{ ( f t / fw ) \times Ims \} < 0.85 & ( 10 \text{-} 1 ) \\ 0.45 < DpM / \{ ( f t / fw ) \times Ims \} < 0.8 & ( 10 \text{-} 2 )\end{matrix}$$

Assuming that an effective diameter of a lens surface closest to the object side in the middle group GM in the state in which the infinite distance object is in focus is EDMf, and an effective diameter of a lens surface closest to the image side in the middle group GM in the state in which the infinite distance object is in focus is EDMr, it is preferable that the variable magnification optical system according to the present embodiment satisfies Conditional Expression (11). By not allowing the corresponding value of Conditional Expression (11) to be equal to or less than the lower limit, the negative refractive power acting on the off-axis luminous flux incident on the middle group GM is prevented from becoming excessively weak. Thus, there is an advantage in achieving reduction in size. By not allowing the corresponding value of Conditional Expression (11) to be equal to or greater than the upper limit, it is possible to suppress the amount of change in height of the ray from the optical axis Z in a case where the off-axis ray passes through the middle group GM. As a result, it is possible to suppress an increase in incidence angle of the off-axis luminous flux on the image plane Sim of the principal ray. Therefore, it is easy to ensure the amount of peripheral light. In order to obtain more favorable characteristics, it is more preferable that the variable magnification optical system satisfies Conditional Expression (11-1), and it is yet more preferable that the variable magnification optical system satisfies Conditional Expression (11-2).

$$0.5 < E DMf / EDMr < 3 \text{.25} \qquad ( 11 )$$

$$0.6 < E DMf / EDMr < 3 \qquad ( 11 - 1 )$$

$$0.7 < E DMf / EDMr < 2 \text{.75} \qquad ( 11 - 2 )$$

In the technique of the present disclosure, twice the distance to the optical axis Z from the intersection between the lens surface and the ray passing through the outermost side among rays incident onto the lens surface from the object side and emitted to the image side is the “effective diameter” of the lens surface. The “outside” here is the radial outside centered on the optical axis Z, that is, the side separated from the optical axis Z. In addition, the “ray passing through the outermost side” is determined in consideration of the entire area of zooming.

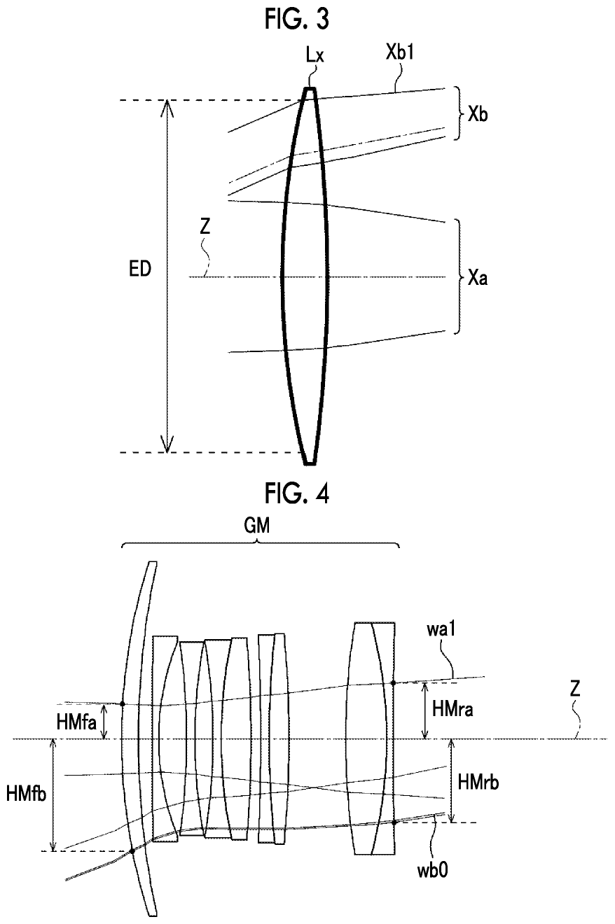

As an explanatory diagram, FIG. 3 shows an example of an effective diameter ED. In FIG. 3, the left side is the object side and the right side is the image side. FIG. 3 shows an on-axis luminous flux Xa and an off-axis luminous flux Xb passing through a lens Lx. In the example of FIG. 3, the ray Xb1, which is the upper ray of the off-axis luminous flux Xb, is the ray passing through the outermost side. Therefore, in the example of FIG. 3, twice the distance to the optical axis Z from the intersection between the ray Xb1 and the object side surface of the lens Lx is the effective diameter ED of the object side surface of the lens Lx. In FIG. 3, the upper ray of the off-axis luminous flux Xb is the ray passing through the outermost side, but which ray is the ray passing through the outermost side depends on the optical system.

It is preferable that the variable magnification optical system according to the present embodiment satisfies Conditional Expression (12) for the on-axis marginal ray wa1 and the principal ray wb0 having the maximum image height Ims at the wide angle end in a state in which the infinite distance object is in focus. The symbols used in Conditional Expression (12) are shown in FIG. 4 as an example. FIG. 4 is a partially enlarged view of the middle group GM at the wide angle end of the variable magnification optical system of FIG. 1. HMfb is a height from the optical axis Z of the principal ray wb0 having the maximum image height Ims on the lens surface closest to the object side in the middle group GM at the wide angle end in the state in which the infinite distance object is in focus. HMfa is a height from the optical axis Z of the on-axis marginal ray wa1 on the lens surface closest to the object side in the middle group GM at the wide angle end in the state in which the infinite distance object is in focus. HMrb is a height from the optical axis Z of the principal ray wb0 of the maximum image height Ims on the lens surface closest to the image side in the middle group GM at the wide angle end in the state in which the infinite distance object is in focus. HMra is a height from the optical axis Z of the on-axis marginal ray wa1 on the lens surface closest to the image side in the middle group GM at the wide angle end in the state in which the infinite distance object is in focus. By not allowing the corresponding value of Conditional Expression (12) to be equal to or less than the lower limit, the negative refractive power acting on the off-axis luminous flux incident on the middle group GM is prevented from becoming excessively weak. Thus, there is an advantage in achieving reduction in size. By not allowing the corresponding value of Conditional Expression (12) to be equal to or greater than the upper limit, it is possible to suppress the amount of change in ray height in a case where the off-axis ray passes through the middle group GM. As a result, it is possible to suppress an increase in incidence angle of the off-axis luminous flux on the image plane Sim of the principal ray. Therefore, it is easy to ensure the amount of peripheral light. In order to obtain more favorable characteristics, it is more preferable that the variable magnification optical system satisfies Conditional Expression (12-1), and it is yet more preferable that the variable magnification optical system satisfies Conditional Expression (12-2).

$$\begin{matrix}1 < \vert ( HMfb / ( HMfb / ( HMrb / HMra ) \vert < 3 & ( 12 ) \\ 1.25 < \vert ( HMfb / HMfa ) / ( HMrb / HMra ) \vert < 2.75 & ( 12 \text{-} 1 ) \\ 1.5 < \vert ( HMfb / ( HMfa ) / ( HMrb / HMra ) \vert < 2.5 & ( 12 \text{-} 2 )\end{matrix}$$

Further, it is preferable that the variable magnification optical system according to the embodiment of the present disclosure has the configuration described below.

Assuming that a maximum image height is Ims, and a focal length of the final lens group GE is fE, it is preferable that the variable magnification optical system according to the present embodiment satisfies Conditional Expression (13). By not allowing the corresponding value of Conditional Expression (13) to be equal to or less than the lower limit, the positive refractive power of the final lens group GE is prevented from becoming excessively weak. Thus, there is an advantage in achieving reduction in size of the lens system. By not allowing the corresponding value of Conditional Expression (13) to be equal to or greater than the upper limit, the positive refractive power of the final lens group GE is prevented from becoming excessively strong. Therefore, it is easy to suppress fluctuations in various aberrations due to zooming. In order to obtain more favorable characteristics, it is more preferable that the variable magnification optical system satisfies Conditional Expression (13-1), and it is yet more preferable that the variable magnification optical system satisfies Conditional Expression (13-2).

$$0.1 < Ims / fE < 0.6 \qquad ( 13 )$$

$$0.2 < Ims / fE < 0.5 \qquad ( 13 - 1 )$$

$$0.25 < Ims / fE < 0.4 \qquad ( 13 - 2 )$$

Assuming that an Abbe number of the positive lens having a largest Abbe number based on the d line among the positive lenses included in the final lens group GE is νE and a partial dispersion ratio thereof between the g line and the F line is θE, it is preferable that the variable magnification optical system according to the present embodiment satisfies Conditional Expression (14). By satisfying Conditional Expression (14), there is an advantage in satisfactorily correcting secondary chromatic aberration in the entire region of zooming. In order to obtain more favorable characteristics, it is more preferable that the variable magnification optical system satisfies Conditional Expression (14-1), and it is yet more preferable that the variable magnification optical system satisfies Conditional Expression (14-2).

$$\begin{matrix}0.02 < θ E + 0.0018 \times v E - 0.64833 < 0.08 & ( 14 ) \\ 0.025 < θ E + 0.0018 \times v E - 0.64833 < 0.07 & ( 14 \text{-} 1 ) \\ 0.03 < θ E + 0.0018 \times v E - 0.64833 < 0.06 & ( 14 \text{-} 2 )\end{matrix}$$

The variable magnification optical system may be configured to include a group that performs focusing by moving along the optical axis Z (hereinafter, referred to as a focus group). That is, during the focusing, only the focus group moves along the optical axis Z. In a configuration in which the variable magnification optical system includes a focus group, assuming that a specific gravity of each lens in the focus group is Sgf and a refractive index thereof at the d line is Nf, an average value of Sgf/Nf of all lenses in the focus group is ave(Sgf/Nf), and a maximum value of refractive indexes of all the lenses in the focus group at the d line is Nfmax, it is preferable that the variable magnification optical system according to the present embodiment satisfies Conditional Expressions (15) and (16). By not allowing the corresponding value of Conditional Expression (15) to be equal to or less than the lower limit, the refractive power of the focus group is prevented from becoming excessively strong. Therefore, it is easy to suppress the fluctuation in aberration due to focusing. By not allowing the corresponding value of Conditional Expression (15) to be equal to or greater than the upper limit, there is an advantage in reducing the weight of the focus group. By satisfying Conditional Expression (15) and not allowing the corresponding value of Conditional Expression (16) to be equal to or less than the lower limit, it is easy to reduce the weight of the focus group while the focus group has sufficient focusing ability. By satisfying Conditional Expression (15) and not allowing the corresponding value of Conditional Expression (16) to be equal to or greater than the upper limit, the refractive power of the focus group is prevented from becoming excessively strong. Therefore, it is easy to suppress the fluctuation in aberration due to focusing. Regarding the effect of the conditional expression (15), in order to obtain more favorable characteristics, it is more preferable that the variable magnification optical system satisfies Conditional Expression (15-1), and it is yet more preferable that the variable magnification optical system satisfies Conditional Expression (15-2). Regarding the effect of the conditional expression (16), in order to obtain more favorable characteristics, it is more preferable that the variable magnification optical system satisfies Conditional Expression (16-1), and it is yet more preferable that the variable magnification optical system satisfies Conditional Expression (16-2).

$$\begin{matrix}2.05 < ave ( S g f / Nf ) < 2.55 & ( 15 ) \\ 2.1 < ave ( S g f / N l ) < 2.45 & ( 15 \text{-} 1 ) \\ 2.15 < ave ( S g f / N l ) < 2.35 & ( 15 \text{-} 2 ) \\ 1.7 < N f max < 2.2 & ( 16 ) \\ 1.75 < N f max < 2.1 & ( 16 \text{-} 1 ) \\ 1.8 < N f max < 2.05 & ( 16 \text{-} 2 )\end{matrix}$$

The number of movable lens groups included in the variable magnification optical system may be three or more. Since there are provided three or more movable lens groups, there is an advantage in correcting spherical aberration and field curvature in each zooming state, and it is easy to increase the magnification.

Among the movable lens groups included in the variable magnification optical system, the movable lens group closest to the object side may be configured to have a positive refractive power. In such a case, there is an advantage in achieving reduction in size of the first lens group G1. Further, since there is an advantage in achieving reduction in size of the first lens group G1, there is an advantage in achieving reduction in effective diameter of the first lens group G1 in a case of trying to realize an optical system having a large aperture ratio.

The movable lens group closest to the object side may be configured to consist of one positive lens having a convex surface facing toward the object side. In such a case, there is an advantage in achieving reduction in size and weight.

In a configuration in which the movable lens group closest to the object side consists of one positive lens having a convex surface facing toward the object side, assuming that a curvature radius of an object side surface of the positive lens having the convex surface facing toward the object side is Rpf, and a curvature radius of an image side surface of the positive lens having the convex surface facing toward the object side is Rpr, it is preferable that the variable magnification optical system according to the present embodiment satisfies Conditional Expression (17). By not allowing the corresponding value of Conditional Expression (17) to be equal to or less than the lower limit, the refractive power of this positive lens is prevented from becoming excessively strong. Therefore, it is easy to suppress fluctuations in various aberrations due to zooming. By not allowing the corresponding value of Conditional Expression (17) to be equal to or greater than the upper limit, the refractive power of this positive lens is prevented from becoming excessively weak. Therefore, the effect of aberration correction can be ensured. In order to obtain more favorable characteristics, it is more preferable that the variable magnification optical system satisfies Conditional Expression (17-1), and it is yet more preferable that the variable magnification optical system satisfies Conditional Expression (17-2).

$$\begin{matrix}- 6 < ( R p f - R p r ) / ( R p f + R p r ) < 1 & ( 17 ) \\ - 3 < ( R p f - R p r ) / ( R p f + R p r ) < 0.75 & ( 17 \text{-} 1 ) \\ - 1.5 < ( R p f - R p r ) / ( R p f + R p r ) < 0.5 & ( 17 \text{-} 2 )\end{matrix}$$

The lens closest to the image side in the first lens group G1 has a convex object side surface, and may be configured such that the absolute value of the curvature radius of the image side surface is greater than the absolute value of the curvature radius of the object side surface. In such a case, it is easy to suppress fluctuation in astigmatism due to the zooming.

During changing magnification from the wide angle end to the telephoto end, it is preferable that the spacing between the first lens group G1 and the lens group closest to the object side in the plurality of lens groups increases. In such a case, it is easy to satisfactorily suppress fluctuations in various aberrations during changing magnification from the wide angle end to the telephoto end.

the first lens group G1 may be configured to consist of, in order from the object side to the image side, a first A subgroup G1A having a negative refractive power, a first B subgroup G1B having a positive refractive power, and a first C subgroup G1C having a positive refractive power. Then, the first B subgroup G1B may be configured to performing focusing by moving along the optical axis Z. That is, the first B subgroup G1B may be configured to be the focus group. In such a case, during focusing, the first B subgroup G1B moves along the optical axis Z, and the other groups remain stationary with respect to the image plane Sim. By adopting such a configuration, it is easy to suppress a change in angle of view due to focusing and fluctuations in various aberrations due to focusing due to a change in subject distance.

In the example of FIG. 1, the first A subgroup G1A consists of three lenses L1a to L1c in order from the object side to the image side. The first B subgroup G1B consists of three lenses L1d to L1f in order from the object side to the image side. The first C subgroup G1C consists of two lenses L1g and L1h in order from the object side to the image side. The horizontal double-headed arrow below the first B subgroup G1B in FIG. 1 indicates that the first B subgroup G1B is the focus group.

In a case where the first lens group G1 consists of the first A subgroup G1A, the first B subgroup G1B, and the first C subgroup G1C, it is preferable that the variable magnification optical system according to the present embodiment satisfies at least one of Conditional Expressions (18) to (22).

Assuming that a maximum image height is Ims, and a focal length of the first C subgroup G1C is f1C, it is preferable that the variable magnification optical system according to the present embodiment satisfies Conditional Expression (18). By not allowing the corresponding value of Conditional Expression (18) to be equal to or less than the lower limit, the refractive power of the first C subgroup G1C can be ensured. Therefore, particularly, it is possible to suppress insufficient correction of spherical aberration on the telephoto side. Further, it is possible to suppress an increase in size of the movable lens group closer to the image side than the first lens group G1. By not allowing the corresponding value of Conditional Expression (18) to be equal to or greater than the upper limit, the refractive power of the first C subgroup G1C is prevented from becoming excessively strong. Therefore, particularly, it is possible to suppress overcorrection of spherical aberration. In order to obtain more favorable characteristics, it is more preferable that the variable magnification optical system satisfies Conditional Expression (18-1), and it is yet more preferable that the variable magnification optical system satisfies Conditional Expression (18-2).

$$\begin{matrix}0.05 < I m s / f 1 C < 0.3 & ( 18 ) \\ 0.1 < Ims / f 1 C < 0.25 & ( 18 \text{-} 1 ) \\ 0.13 < I m s / f 1 C < 0.2 & ( 18 \text{-} 2 )\end{matrix}$$

It is preferable that all the lenses included in the first C subgroup G1C have a positive refractive power. In such a case, the number of lenses can be minimized Therefore, the weight increase can be suppressed.

Assuming that a focal length of the first lens group G1 is f1, and a focal length of the first B subgroup G1B is f1B, it is preferable that the variable magnification optical system according to the present embodiment satisfies Conditional Expression (19). By not allowing the corresponding value of Conditional Expression (19) to be equal to or less than the lower limit, the refractive power of the first B subgroup G1B is prevented from becoming excessively weak. Therefore, the amount of movement of the first B subgroup G1B during focusing can be suppressed. As a result, there is an advantage in achieving reduction in size. By not allowing the corresponding value of Conditional Expression (19) to be equal to or greater than the upper limit, the refractive power of the first B subgroup G1B is prevented from becoming excessively strong. Therefore, particularly, it is possible to suppress overcorrection of spherical aberration on the telephoto side. In order to obtain more favorable characteristics, it is more preferable that the variable magnification optical system satisfies Conditional Expression (19-1), and it is yet more preferable that the variable magnification optical system satisfies Conditional Expression (19-2).

$$\begin{matrix}0.3 < f 1 / f 1 B < 0.9 & ( 19 ) \\ 0.4 < f 1 / f 1 B < 0.8 & ( 19 \text{-} 1 ) \\ 0.5 < f 1 / f 1 B < 0.7 & ( 19 \text{-} 2 )\end{matrix}$$

The first B subgroup G1B has a positive refractive power, and thus includes one or more positive lenses. Assuming that an Abbe number of the positive lens, of which an Abbe number based on the d line is maximum, among the positive lenses included in the first B subgroup G1B based on the d line is ν1Bp, and a partial dispersion ratio thereof between a g line and an F line is θ1Bp, it is preferable that the variable magnification optical system according to the present embodiment satisfies Conditional Expression (20). By satisfying Conditional Expression (20), it is easy to satisfactorily suppress fluctuation in secondary chromatic aberration due to focusing. In order to obtain more favorable characteristics, it is more preferable that the variable magnification optical system satisfies Conditional Expression (20-1), and it is yet more preferable that the variable magnification optical system satisfies Conditional Expression (20-2).

$$\begin{matrix}0.01 < θ1 Bp + 0. 0018 \times v 1 B p - 0.6 \; 4833 < 0.07 & ( 20 ) \\ 0.02 < θ1 Bp + 0.0 \; 018 \times v 1 Bp - 0. 64833 < 0.065 & ( 20 \text{-} 1 ) \\ 0.05 < θ1 Bp + 0.0 \; 018 \times v 1 Bp - 0. 64833 < 0.06 & ( 20 \text{-} 2 )\end{matrix}$$

In a configuration in which the first B subgroup G1B includes one or more negative lenses, assuming that a minimum value of the Abbe numbers of all the negative lenses included in the first B subgroup G1B based on the d line is ν1Bn, it is preferable that the variable magnification optical system according to the present embodiment satisfies Conditional Expression (21). By satisfying Conditional Expression (21), it is easy to satisfactorily suppress fluctuations in axial chromatic aberration due to focusing. In order to obtain more favorable characteristics, it is more preferable that the variable magnification optical system satisfies Conditional Expression (21-1), and it is yet more preferable that the variable magnification optical system satisfies Conditional Expression (21-2).

$$15 < v 1 Bn < 40 \qquad ( 21 )$$

$$20 < v 1 Bn < 35 \qquad ( 21 - 1 )$$

$$23 < v 1 Bn < 30 \qquad ( 21 - 2 )$$

In a configuration in which the first B subgroup G1B includes one or more positive lenses and one or more negative lenses, it is more preferable that the variable magnification optical system according to the present embodiment satisfies Conditional Expressions (20) and (21). Further, it is yet more preferable to satisfy not only Conditional Expressions (20) and (21) but also at least one of Conditional Expressions (20-1), (20-2), (21-1), or (21-2).

It is preferable that the first B subgroup G1B includes a meniscus-shaped negative lens having a convex surface facing toward the object side closest to the image side. In such a case, it is easy to suppress fluctuation in astigmatism due to focusing.

It is preferable that the first A subgroup G1A includes two or more negative lenses of which Abbe numbers based on the d line are 50 or more. Further, assuming that a minimum value of Abbe numbers of all the positive lenses included in the first A subgroup G1A based on the d line is ν1Ap, it is preferable that the variable magnification optical system according to the embodiment of the present disclosure satisfies Conditional Expression (22). By not allowing the corresponding value of Conditional Expression (22) to be equal to or less than the lower limit, it is possible to suppress overcorrection of axial chromatic aberration. By not allowing the corresponding value of Conditional Expression (22) to be equal to or greater than the upper limit, it is easy to correct axial chromatic aberration. In a case where the first A subgroup G1A includes two or more negative lenses of which Abbe numbers based on the d line are 50 or more and satisfies Conditional Expression (22), it is easy to satisfactorily correct axial chromatic aberration. In order to obtain more favorable characteristics, it is more preferable that the variable magnification optical system satisfies Conditional Expression (22-1), and it is yet more preferable that the variable magnification optical system satisfies Conditional Expression (22-2).

$$15 < v 1 Ap < 40 \qquad ( 22 )$$

$$20 < v 1 Ap < 35 \qquad ( 22 - 1 )$$

$$23 < v 1 Ap < 30 \qquad ( 22 - 2 )$$

The first lens group G1 may be configured to be remaining stationary with respect to the image plane Sim during changing magnification. In such a case, it is easy to configure the lens system such that the total length of the lens system does not change even in a case where zooming is performed. According to this configuration, it is easy to reduce fluctuation in centroid of the lens system during changing magnification. Thus, there is an advantage in improving the convenience during imaging.

The final lens group GE may be remaining stationary with respect to the image plane Sim during changing magnification, and the aperture stop St may be disposed closest to the object side in the final lens group GE. In such a case, it is easy to suppress fluctuation in F number due to the zooming. In addition, there is an advantage in suppressing fluctuation in field curvature and fluctuation in spherical aberration due to zooming.

In a case where the aperture stop St is disposed closest to the object side in the final lens group GE, it is preferable that the lens component disposed adjacent to the image side of the aperture stop St has a biconvex shape. In such a case, there is an advantage in satisfactorily correcting the spherical aberration. In addition, in the present specification, one lens component means one single lens or one group of cemented lenses. In the example of FIG. 1, the lens component disposed adjacent to the image side of the aperture stop St is a cemented lens consisting of the lens L5a and the lens L5b.

In a case where the aperture stop St is disposed closest to the object side in the final lens group GE, assuming that a curvature radius of a surface of the lens component, which is closest to the object side and is disposed adjacent to the image side of the aperture stop St, is REf, and a curvature radius of a surface of the lens component, which is closest to the image side and is disposed adjacent to the image side of the aperture stop St, is REr, it is preferable that the variable magnification optical system according to the present embodiment satisfies Conditional Expression (23). By not allowing the corresponding value of Conditional Expression (23) to be equal to or less than the lower limit, there is an advantage in achieving reduction in size. By not allowing the corresponding value of Conditional Expression (23) to be equal to or greater than the upper limit, there is an advantage in satisfactorily correcting the spherical aberration in the entire region of the zooming. In order to obtain more favorable characteristics, it is more preferable that the variable magnification optical system satisfies Conditional Expression (23-1), and it is yet more preferable that the variable magnification optical system satisfies Conditional Expression (23-2).

$$- 0.7 < ( R E f + R Er ) / ( REf - R E r ) < 0.7 \qquad ( 23 )$$

$$- 0.5 \; 5 < ( R E f + R Er ) / ( REf - R E r ) < 0.55 \qquad ( 23 - 1 )$$

$$- 0.45 < ( R E f + R Er ) / ( REf - R E r ) < 0 \text{.45} \qquad ( 23 - 2 )$$

It is preferable that the final lens group GE includes one or more lenses of which Abbe numbers based on the d line are 65 or more and which satisfies Conditional Expression (24). In Conditional Expression (24), it is assumed that a temperature coefficient of a relative refractive index of a lens in the final lens group GE at the d line in a range of 20° C. to 40° C. is dN/dT and a unit of dN/dT is ° C.⁻¹. The final lens group GE having a positive refractive power tends to use a material having low dispersion and abnormal dispersibility as a material for a positive lens in order to correct chromatic aberration. However, many such materials each have a negative temperature coefficient. By not allowing the corresponding value of Conditional Expression (24) to be equal to or less than the lower limit, a positive lens using a material having a positive temperature coefficient can be disposed in the final lens group GE, which is caused by a temperature change. Therefore, it is easy to satisfactorily correct fluctuation in image formation position. By not allowing the corresponding value of Conditional Expression (24) to be equal to or greater than the upper limit, it is possible to prevent the correction amount for suppressing fluctuation in image formation position from becoming excessive. In order to obtain more favorable characteristics, it is more preferable that the variable magnification optical system satisfies Conditional Expression (24-1), and it is yet more preferable that the variable magnification optical system satisfies Conditional Expression (24-2).

$$\begin{matrix}0 < d N / d T < 8 \times 1 {0}^{- 6} & ( 24 ) \\ 1.5 \times 1 {0}^{- 6} < d N / d T < 7 \times 1 {0}^{- 6} & ( 24 \text{-} 1 ) \\ 3 \times 1 {0}^{- 6} < d N / d T < 6 \times 1 {0}^{- 6} & ( 24 \text{-} 2 )\end{matrix}$$

The example shown in FIG. 1 is an example, and various modifications can be made without departing from the scope of the technology of the present disclosure. For example, the number of the plurality of lens groups disposed between the first lens group G1 and the final lens group GE, the number of lens groups included in the middle group GM, the number of movable lens groups included in the middle group GM, and the number of lenses included in each lens group may be different from the numbers shown in FIG. 1.

Specifically, for example, groups, which are included in the plurality of lens groups disposed between the first lens group G1 and the final lens group GE and move by changing the spacing between adjacent lens groups during changing magnification, may be configured to consist of, in order from the object side to the image side, an middle group GM, a negative movable lens group GN, and a positive movable lens group having a positive refractive power. The middle group GM is a group including one or more lens groups and having a negative refractive power as a whole. The negative movable lens group GN is a lens group having a negative refractive power positioned closest to the image side among the lens groups having a negative refractive power in the plurality of lens groups, and is a lens group that moves during changing magnification. In such a case, it is easy to satisfactorily suppress fluctuations in various aberrations due to zooming.

Further, the middle group GM may be configured to consist of, in order from the object side to the image side, a front lens group having a positive refractive power, a central lens group having a negative refractive power, and a rear lens group having a negative refractive power. The middle group GM may be configured such that, during changing magnification, the spacing between the front lens group and the central lens group may change, and the spacing between the central lens group and the rear lens group may change. In such a case, it is easy to satisfactorily suppress fluctuations in various aberrations due to zooming.

Alternatively, the middle group GM may be configured to consist of only one lens group having a negative refractive power.

More specifically, each lens group can have, for example, the following configuration.

The first A subgroup G1A can be configured to consist of three lenses. The first A subgroup G1A may be configured to consist of two negative lenses and one positive lens in order from the object side to the image side. Alternatively, the first A subgroup G1A may be configured to consist of one negative lens, one positive lens, and one negative lens in order from the object side to the image side.

Alternatively, the first A subgroup G1A can be configured to consist of four lenses. In such a case, the first A subgroup G1A may be configured to consist of three negative lenses and one positive lens in order from the object side to the image side.

The first B subgroup G1B can be configured to consist of three lenses. In such a case, the first B subgroup G1B may be configured to consist of two positive lenses and one negative lens in order from the object side to the image side.

The first B subgroup G1B can be configured to consist of four lenses. In such a case, the first B subgroup G1B may be configured to consist of three positive lenses and one negative lens in order from the object side to the image side.

The first C subgroup G1C can be configured to consist of two or three lenses. In such a case, the first C subgroup G1C may be configured to consist of two or three positive lenses.

In a case where the middle group GM consists of the front lens group and the rear lens group described above, the middle group GM can be configured as follows. The front lens group can be configured to consist of one positive lens. Alternatively, the front lens group can be configured to consist of one negative lens and one positive lens. In such a case, the front lens group may be configured to consist of one group of cemented lenses. The rear lens group can be configured to consist of eight lenses. In such a case, the rear lens group may be configured to consist of five negative lenses and three positive lenses. Alternatively, the rear lens group can be configured to consist of seven lenses. In such a case, the rear lens group may be configured to consist of four negative lenses and three positive lenses, or may be configured to consist of five negative lenses and two positive lenses. Alternatively, the rear lens group can be configured to consist of six lenses. In such a case, the rear lens group may be configured to consist of three negative lenses and three positive lenses, or may be configured to consist of four negative lenses and two positive lenses.

In a case where the middle group GM consists of the front lens group, the central lens group, and the rear lens group, the middle group GM can be configured as follows. The front lens group can be configured to consist of one positive lens. The central lens group can be configured to consist of four lenses. In this case, the central lens group may be configured to consist of three negative lenses and one positive lens. The rear lens group can be configured to consist of three lenses. In this case, the rear lens group may be configured to consist of one negative lens and two positive lenses.

In a case where the middle group GM consists of only one lens group, the middle group GM can be configured as follows. The middle group GM can be configured to consist of six lenses. In such a case, the middle group GM may be configured to consist of four negative lenses and two positive lenses. Alternatively, the middle group GM can be configured to consist of seven lenses. In such a case, the middle group GM may be configured to consist of four negative lenses and three positive lenses.

The negative movable lens group GN can be configured to consist of two lenses. In such a case, the negative movable lens group GN may be configured to consist of one negative lens and one positive lens. The negative movable lens group GN may be configured to consist of one group of cemented lenses or may be configured to consist of two single lenses.

The positive movable lens group can be configured to consist of three lenses. In this case, the positive movable lens group may be configured to consist of two positive lenses and one negative lens.

The variable magnification optical system of the present disclosure may be a zoom lens or a varifocal lens.

The above-mentioned preferred configurations and available configurations including the configurations relating to Conditional Expressions may be any combination, and it is preferable to appropriately selectively adopt the configurations in accordance with required specification. It should be noted that the ranges of the possible conditional expressions are not limited to the conditional expressions described in the form of the expression, and the lower limit and the upper limit are selected from each of the preferable, more preferable, and yet more preferable conditional expressions. The ranges of the conditional expressions include ranges obtained through optional combinations.

Next, examples of the variable magnification optical system of the present disclosure will be described. The reference numerals attached to the lenses in the cross-sectional views of each example are used independently for each example in order to avoid complication of description and drawings due to an increase in the number of digits of the reference numerals. Therefore, even in a case where common reference numerals are attached in the drawings of different examples, components do not necessarily have a common configuration.

### Example 1

The configuration and movement loci of the variable magnification optical system according to Example 1 are shown in FIG. 1, and the illustration method and configuration thereof are as described above, and thus, repeated description will be omitted.

Regarding the variable magnification optical system of Example 1, Tables 1A and 1B show basic lens data, Table 2 shows specification and variable surface spacings, and Table 3 shows aspherical coefficients. Here, the basic lens data is divided into two tables, Table 1A and Table 1B, in order to avoid lengthening of one table. Tables 1A, 1B, and 2 show data in a state in which the infinite distance object is in focus.

Tables 1A and 1B are described as follows. The column of Sn shows surface numbers in a case where the surface closest to the object side is the first surface and the number is increased one by one toward the image side. The column of R shows a curvature radius of each surface. The column of D shows a surface spacing between each surface and the surface adjacent to the image side on the optical axis. The column of Nd shows a refractive index of each constituent element at the d line. The column of νd shows an Abbe number of each constituent element based on the d line. The column of θgF shows a partial dispersion ratio of each constituent element between the g line and the F line. The column of ED shows an effective diameter at the diameter of each surface. The column of Sg shows a specific gravity of each constituent element. The specific gravity shows only the first lens group G1.

In Tables 1A and 1B, the sign of the curvature radius of the surface having a convex surface facing toward the object side is positive and the sign of the curvature radius of the surface having a convex surface facing toward the image side is negative. In Table 1B, in a place of a surface number of a surface corresponding to the aperture stop St, the surface number and a term of (St) are noted. Table 1B also shows the optical member PP. A value at the bottom place of the column of D in Table 1B indicates a spacing between the image plane Sim and the surface closest to the image side in the table. In Table 1A, the symbol DD[ ] is used for each variable surface spacing during changing magnification, and the object side surface number of the spacing is given in [ ] and is noted in the column of D.

Table 2 shows the zoom magnification Zr, the focal length f, the back focal length Bf at the air conversion distance, the open F number FNo., the maximum total angle of view 2ω, the maximum image height Ims, and the variable surface spacing during changing magnification, based on the d line. In a case where the variable magnification optical system is a zoom lens, the zoom magnification is synonymous with the zoom ratio. (°) in the place of 2ω indicates that the unit thereof is a degree. In Table 2, the columns of WIDE, MIDDLE, and TELE show values in the wide angle end state, the middle focal length state, and the telephoto end state, respectively.

In basic lens data, the reference sign * is attached to surface numbers of aspherical surfaces, and numerical values of the paraxial curvature radius are written into the column of the curvature radius of the aspherical surface. In Table 3, the row of Sn shows surface numbers of the aspherical surfaces, and the rows of KA and Am show numerical values of the aspherical coefficients for each aspherical surface. It should be noted that m of Am is an integer of 3 or more, and differs depending on the surface. For example, on the first surface, m=3, 4, 5, . . . , 20. The “E±n” (n: an integer) in numerical values of the aspherical coefficients of Table 3 indicates “×10^{±n}”. KA and Am are the aspherical coefficients in the aspheric equation represented by the following expression.

$$Z d = C \times {h}^{2} / \{ 1 + {( 1 - KA \times {C}^{2} \times {h}^{2} )}^{1 / 2} \} + Σ A m \times {h}^{m}$$

Here,

Zd is an aspherical surface depth (a length of a perpendicular from a point on an aspherical surface at height h to a plane that is perpendicular to the optical axis Z in contact with the vertex of the aspherical surface),

h is a height (a distance from the optical axis Z to the lens surface),

C is an inverse of the paraxial curvature radius,

KA and Am are aspherical coefficients, and

Σ in the aspheric equation means the sum with respect to m.

In data of each table, a degree is used as a unit of an angle, and mm (millimeter) is used as a unit of a length, but appropriate different units may be used since the optical system can be used even in a case where the system is enlarged or reduced in proportion. Further, each of the following tables shows numerical values rounded off to predetermined decimal places.

TABLE 1A
Example 1

| Sn | R | D | Nd | νd | θgF | ED | Sg |
|---|---|---|---|---|---|---|---|
| *1 | 19966.75539 | 4.400 | 1.73316 | 54.68 | 0.54436 | 146.17 | 4.13 |
| 2 | 256.96189 | 16.939 | | | | 139.16 | |
| 3 | −385.40577 | 3.419 | 1.78403 | 49.60 | 0.55166 | 138.65 | 4.38 |
| 4 | 225.21207 | 9.401 | 1.84666 | 23.83 | 0.61603 | 138.14 | 5.51 |
| 5 | 773.30724 | 1.637 | | | | 138.07 | |
| 6 | 544.99170 | 16.600 | 1.50614 | 81.58 | 0.53913 | 138.27 | 3.56 |
| 7 | −235.89997 | 0.199 | | | | 138.20 | |
| 8 | 138.37249 | 17.351 | 1.43875 | 94.66 | 0.53402 | 140.50 | 3.59 |
| 9 | 664.41960 | 0.201 | | | | 140.00 | |
| 10 | 181.53334 | 4.300 | 1.85478 | 24.80 | 0.61232 | 138.38 | 3.49 |
| 11 | 120.21551 | 43.844 | | | | 133.43 | |
| 12 | 137.33199 | 20.000 | 1.43875 | 94.66 | 0.53402 | 141.93 | 3.59 |
| 13 | 1457.05292 | 0.120 | | | | 141.50 | |
| *14 | 152.38909 | 18.500 | 1.49700 | 81.54 | 0.53748 | 138.45 | 3.62 |
| 15 | −2660.64421 | DD[15] | | | | 137.44 | |
| *16 | 144.32402 | 3.974 | 1.43875 | 94.66 | 0.53402 | 85.78 | |
| 17 | 204.56938 | DD[17] | | | | 84.09 | |
| 18 | 4016.52155 | 1.500 | 1.91171 | 36.83 | 0.57843 | 49.74 | |
| 19 | 63.89848 | 6.659 | | | | 46.87 | |
| 20 | −169.93294 | 1.984 | 1.59282 | 68.62 | 0.54414 | 46.74 | |
| 21 | 130.63810 | 4.324 | | | | 46.52 | |
| 22 | −143.84388 | 1.981 | 1.68344 | 57.33 | 0.54263 | 46.57 | |
| 23 | 119.65744 | 7.095 | 1.70112 | 33.73 | 0.59318 | 47.99 | |
| 24 | −289.75477 | 2.340 | | | | 48.79 | |
| 25 | −539.00664 | 2.020 | 1.58894 | 61.02 | 0.54280 | 49.49 | |
| 26 | 245.56024 | 4.707 | 1.62898 | 35.10 | 0.58644 | 50.24 | |
| 27 | −269.21774 | 13.401 | | | | 50.74 | |
| 28 | 179.96575 | 9.820 | 1.68893 | 51.22 | 0.55235 | 55.89 | |
| 29 | −109.66190 | 1.510 | 1.53476 | 77.27 | 0.54055 | 56.09 | |
| 30 | 1153.79118 | DD[30] | | | | 56.10 | |
| 31 | −79.79343 | 1.300 | 1.49700 | 81.64 | 0.53714 | 56.45 | |
| 32 | 227.23675 | 0.213 | | | | 58.67 | |
| 33 | 250.06516 | 2.500 | 1.84666 | 23.83 | 0.61603 | 58.69 | |
| 34 | 1037.07126 | DD[34] | | | | 58.90 | |

TABLE 1B
Example 1

| Sn | R | D | Nd | νd | θgF | ED |
|---|---|---|---|---|---|---|
| 35(St) | ∞ | 1.969 | | | | 59.73 |
| 36 | 258.55091 | 12.437 | 1.59504 | 61.34 | 0.54252 | 61.16 |
| 37 | −58.20553 | 1.649 | 1.78748 | 47.99 | 0.55522 | 61.43 |
| 38 | −111.36299 | 2.799 | | | | 62.93 |
| 39 | 54.99693 | 19.647 | 1.53775 | 74.70 | 0.53936 | 62.88 |
| 40 | −70.31665 | 1.388 | 1.54072 | 47.23 | 0.56511 | 61.63 |
| 41 | −706.85120 | 7.045 | | | | 58.00 |
| 42 | 46.02808 | 11.733 | 1.43875 | 94.66 | 0.53402 | 46.82 |
| 43 | −83.26502 | 1.300 | 1.95375 | 32.32 | 0.59015 | 44.76 |
| 44 | 82.42912 | 4.998 | | | | 41.61 |
| 45 | −102.20122 | 5.623 | 1.84666 | 23.83 | 0.61603 | 41.53 |
| 46 | −37.86090 | 1.410 | 1.76612 | 47.61 | 0.55688 | 41.52 |
| 47 | −71.81824 | 19.232 | | | | 41.20 |
| 48 | 40.85242 | 6.953 | 1.43875 | 94.66 | 0.53402 | 33.14 |
| 49 | −81.00907 | 0.879 | | | | 32.26 |
| 50 | −88.48926 | 1.000 | 1.95375 | 32.32 | 0.59015 | 31.17 |
| 51 | 22.77130 | 8.404 | 1.60517 | 37.48 | 0.58160 | 29.17 |
| 52 | −119.20658 | 1.675 | | | | 29.24 |
| 53 | −77.87165 | 4.552 | 1.52637 | 50.06 | 0.55898 | 29.12 |
| 54 | −27.08668 | 0.900 | 1.84850 | 43.79 | 0.56197 | 29.23 |
| 55 | 95.16631 | 6.969 | | | | 30.96 |
| 56 | 82.92367 | 4.773 | 1.80518 | 25.46 | 0.61572 | 37.78 |
| 57 | −144.06667 | 45.091 | | | | 38.07 |
| 58 | ∞ | 4.150 | 1.51633 | 64.14 | | |
| 59 | ∞ | 2.014 | | | | |

TABLE 2
Example 1

| | WIDE | MIDDLE | TELE |
|---|---|---|---|
| Zr | 1.0 | 3.0 | 7.7 |
| f | 50.018 | 152.397 | 385.642 |
| Bf | 49.842 | 49.842 | 49.842 |
| FNo. | 3.30 | 3.30 | 3.30 |
| 2ω(°) | 50.2 | 16.8 | 6.8 |
| Ims | 23.4 | 23.4 | 23.4 |
| DD[15] | 1.470 | 22.522 | 69.501 |
| DD[17] | 3.399 | 59.638 | 51.984 |
| DD[30] | 85.932 | 14.049 | 18.085 |
| DD[34] | 51.349 | 45.940 | 2.580 |

TABLE 3
Example 1

| Sn | 1 | 14 | 16 |
|---|---|---|---|
| KA | 1.0000000E+00 | 1.0000000E+00 | 1.0000000E+00 |
| A3 | −5.3857896E−09 | 0.0000000E+00 | 1.7256063E−07 |
| A4 | 1.1315386E−08 | −5.4182092E−08 | 1.2726346E−08 |
| A5 | 1.8930570E−11 | 2.9141317E−10 | 7.5368315E−11 |
| A6 | 1.7729498E−13 | −1.1920877E−11 | 1.6209835E−11 |
| A7 | −1.3582473E−14 | 1.1786770E−13 | −1.2891196E−13 |
| A8 | −9.5033792E−17 | 3.8936267E−16 | −1.1200960E−14 |
| A9 | 9.3573784E−19 | −1.1326430E−17 | 6.0527364E−17 |
| A10 | 1.1949393E−20 | −9.5068469E−20 | 2.9868130E−18 |
| A11 | −5.7431595E−23 | 2.6816889E−22 | 4.8256342E−20 |
| A12 | 2.4895462E−24 | 1.0744516E−23 | 4.2089104E−22 |
| A13 | 1.0131116E−27 | 1.1132978E−25 | −2.4606332E−24 |
| A14 | −4.8777903E−28 | 4.6458610E−28 | −8.9024330E−25 |
| A15 | 7.0220562E−30 | −5.4333594E−30 | −1.8662042E−26 |
| A16 | −3.7920649E−33 | −1.4005746E−31 | 6.4480795E−29 |
| A17 | 1.3449455E−34 | −1.5785270E−33 | 7.0738863E−30 |
| A18 | −1.5602557E−35 | −1.8852320E−35 | 1.1599279E−31 |
| A19 | −4.1366483E−37 | 1.3050375E−38 | 2.7652334E−33 |
| A20 | 5.9333966E−39 | 4.7589070E−39 | −9.2994676E−35 |

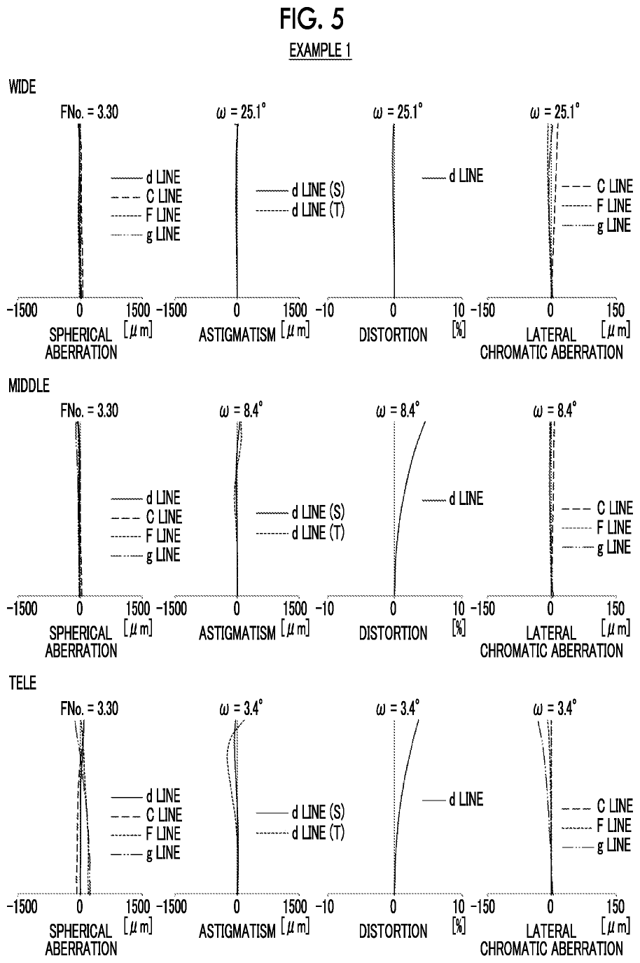

FIG. 5 shows a diagram of aberrations of the variable magnification optical system of Example 1 in a state in which the infinite distance object is in focus. FIG. 5 shows, in order from the left, spherical aberration, astigmatism, distortion, and lateral chromatic aberration. In FIG. 5, the upper part labeled by “WIDE” shows aberrations in the wide angle end state, the middle part labeled by “MIDDLE” shows aberrations in the middle focal length state, and the lower part labeled by “TELE” shows aberrations in the telephoto end state. In spherical aberration diagram, aberrations at the d line, the C line, the F line, and the g line are indicated by the solid line, the long broken line, the short broken line, and the two-dot chain line, respectively. In the astigmatism diagram, aberration in the sagittal direction at the d line is indicated by the solid line, and aberration in the tangential direction at the d line is indicated by the short broken line. In the distortion diagram, aberration at the d line is indicated by the solid line. In lateral chromatic aberration diagram, aberrations at the C line, the F line, and the g line are respectively indicated by the long broken line, the short broken line, and the two-dot chain line. In the spherical aberration diagram, the value of the open F number is shown after FNo.=. In other aberration diagrams, the value of the maximum half angle of view is shown after ω=.

Symbols, meanings, description methods, and illustration methods of the respective data pieces according to Example 1 are the same as those in the following examples unless otherwise specified. Therefore, in the following description, repeated description will be omitted.

### Example 2

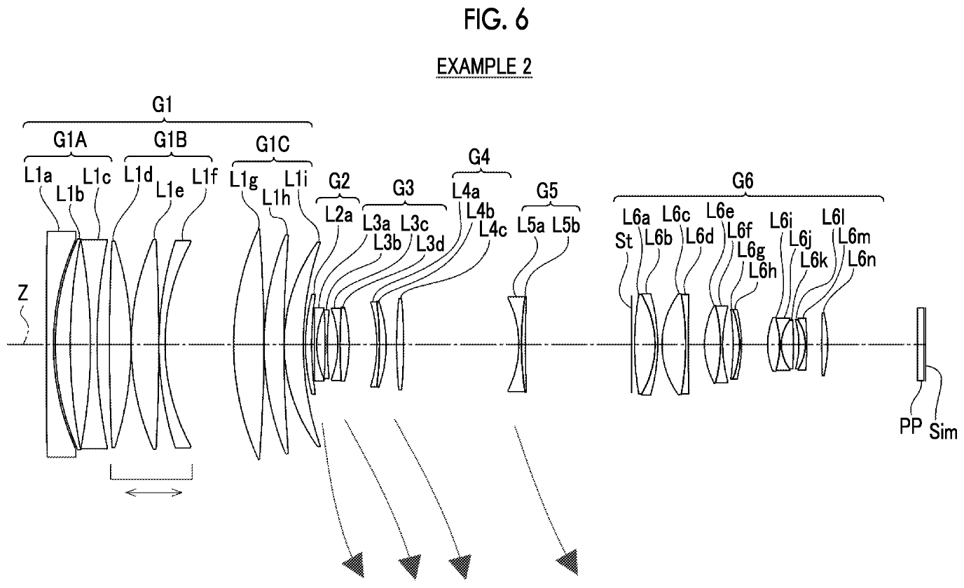

FIG. 6 shows a configuration and movement loci of the variable magnification optical system of Example 2. The variable magnification optical system of Example 2 consists of, in order from the object side to the image side, a first lens group G1 having a positive refractive power, a second lens group G2 having a positive refractive power, a third lens group G3 having a negative refractive power, a fourth lens group G4 having a positive refractive power, a fifth lens group G5 having a negative refractive power, and a sixth lens group G6 having a positive refractive power.

During changing magnification, the first lens group G1 and the sixth lens group G6 remain stationary with respect to the image plane Sim, and the second lens group G2, the third lens group G3, the fourth lens group G4, and the fifth lens group G5 move along the optical axis Z by changing the spacings from the adjacent lens groups. The middle group GM consists of the second lens group G2, the third lens group G3, and the fourth lens group G4. The negative movable lens group GN consists of a fifth lens group G5.

The first lens group G1 consists of a first A subgroup G1A, a first B subgroup G1B, and a first C subgroup G1C in order from the object side to the image side. The focus group is the first B subgroup G1B. The first A subgroup G1A consists of three lenses L1a to L1c in order from the object side to the image side. The first B subgroup G1B consists of three lenses L1d to L1f in order from the object side to the image side. The first C subgroup G1C consists of three lenses L1g to L1i in order from the object side to the image side.

The second lens group G2 consists of one lens L2a. The third lens group G3 consists of four lenses L3a to L3d in order from the object side to the image side. The fourth lens group G4 consists of three lenses L4a to L4c in order from the object side to the image side. The fifth lens group G5 consists of two lenses L5a and L5b in order from the object side to the image side. The sixth lens group G6 consists of an aperture stop St and fourteen lenses L6a to L6n in order from the object side to the image side.

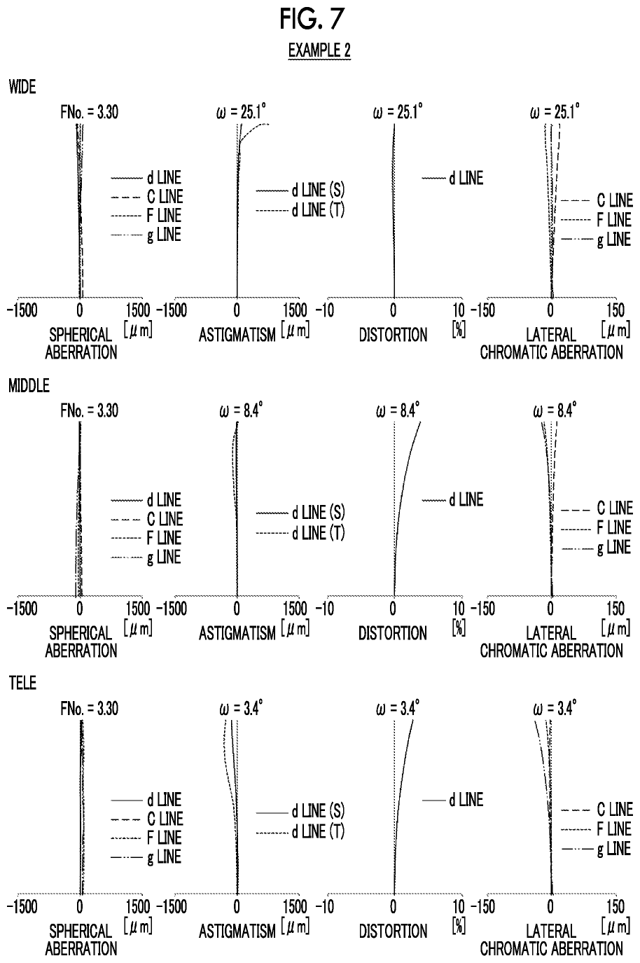

Regarding the variable magnification optical system of Example 2, Tables 4A and 4B show the basic lens data, Table 5 shows the specifications and the variable surface spacings, Table 6 shows the aspherical coefficients, and FIG. 7 shows a diagram of aberrations in a state in which the infinite distance object is in focus.

TABLE 4A
Example 2

| Sn | R | D | Nd | νd | θgF | ED | Sg |
|---|---|---|---|---|---|---|---|
| *1 | 19988.03274 | 4.500 | 1.72916 | 54.68 | 0.54451 | 147.62 | 4.18 |
| 2 | 172.27220 | 1.216 | | | | 147.00 | |
| 3 | 173.57490 | 9.399 | 1.84666 | 23.84 | 0.62012 | 137.42 | 3.50 |
| 4 | 358.26008 | 12.949 | | | | 137.26 | |
| 5 | −378.60416 | 4.100 | 1.77250 | 49.62 | 0.55188 | 136.41 | 4.26 |
| 6 | 345.78380 | 7.946 | | | | 136.29 | |
| 7 | 1435.89354 | 13.739 | 1.49700 | 81.64 | 0.53714 | 134.14 | 3.65 |
| 8 | −222.05319 | 0.120 | | | | 134.36 | |
| 9 | 173.39471 | 17.558 | 1.43875 | 94.66 | 0.53402 | 134.40 | 3.59 |
| 10 | −1349.98175 | 0.120 | | | | 136.38 | |
| 11 | 224.59749 | 3.800 | 1.84666 | 23.84 | 0.62012 | 136.02 | 3.50 |
| 12 | 142.86358 | 43.675 | | | | 135.34 | |
| 13 | 187.01575 | 19.199 | 1.43875 | 94.66 | 0.53402 | 132.31 | 3.59 |
| 14 | −963.84820 | 0.120 | | | | 144.81 | |
| 15 | 192.35345 | 12.660 | 1.49700 | 81.64 | 0.53714 | 144.71 | 3.65 |
| 16 | 905.89200 | 0.120 | | | | 142.32 | |
| 17 | 115.33356 | 12.095 | 1.49700 | 81.64 | 0.53714 | 141.69 | 3.65 |
| 18 | 208.41559 | DD[18] | | | | 133.22 | |
| *19 | 133.14797 | 4.000 | 1.49700 | 81.64 | 0.53714 | 131.99 | |
| 20 | 234.14102 | DD[20] | | | | 64.76 | |
| 21 | 2780.66501 | 1.500 | 1.90043 | 37.37 | 0.57668 | 63.20 | |
| 22 | 56.78262 | 5.314 | | | | 47.41 | |
| 23 | −429.01422 | 1.500 | 1.77250 | 49.62 | 0.55188 | 44.35 | |
| 24 | 255.33442 | 6.572 | | | | 44.31 | |
| 25 | −63.14256 | 1.444 | 1.84850 | 43.79 | 0.56197 | 44.25 | |
| 26 | 431.97027 | 5.719 | 1.80518 | 25.43 | 0.61027 | 46.81 | |
| 27 | −98.69530 | DD[27] | | | | 46.82 | |
| 28 | −96.54800 | 1.651 | 1.62846 | 59.17 | 0.55583 | 47.69 | |
| 29 | −220.02181 | 4.269 | 1.61266 | 44.46 | 0.56403 | 54.99 | |
| 30 | −83.50066 | 6.635 | | | | 54.99 | |
| 31 | 300.66861 | 4.500 | 1.74400 | 44.90 | 0.56308 | 55.52 | |
| 32 | −335.97977 | DD[32] | | | | 58.94 | |
| 33 | −67.54701 | 1.671 | 1.43875 | 94.66 | 0.53402 | 59.04 | |
| 34 | 220.65719 | 2.562 | 1.80518 | 25.43 | 0.61027 | 61.69 | |
| 35 | 1054.77979 | DD[35] | | | | 61.69 | |

TABLE 4B
Example 2

| Sn | R | D | Nd | νd | θgF | ED |
|---|---|---|---|---|---|---|
| 36(St) | ∞ | 1.990 | | | | 61.83 |
| 37 | 195.66024 | 13.008 | 1.55397 | 71.76 | 0.53931 | 62.65 |
| 38 | −64.96103 | 1.650 | 1.81600 | 46.59 | 0.55661 | 64.41 |
| 39 | −121.38468 | 2.800 | | | | 64.41 |
| 40 | 57.19756 | 14.999 | 1.53775 | 74.70 | 0.53936 | 65.77 |
| 41 | −190.00256 | 1.670 | 1.54072 | 47.23 | 0.56511 | 64.53 |
| 42 | 1604.41721 | 10.337 | | | | 64.52 |
| 43 | 54.77964 | 10.145 | 1.49700 | 81.64 | 0.53714 | 62.29 |
| 44 | −97.71354 | 1.300 | 1.90043 | 37.37 | 0.57668 | 49.83 |
| 45 | 85.41346 | 6.682 | | | | 49.82 |
| 46 | −172.36448 | 4.081 | 1.80518 | 25.43 | 0.61027 | 46.06 |
| 47 | −61.22649 | 1.231 | 1.53775 | 74.70 | 0.53936 | 45.06 |
| 48 | −95.77163 | 16.656 | | | | 45.06 |
| 49 | 49.27767 | 7.738 | 1.43875 | 94.66 | 0.53402 | 44.25 |
| 50 | −58.57296 | 1.000 | 1.90043 | 37.37 | 0.57668 | 33.64 |
| 51 | 26.58530 | 7.648 | 1.58144 | 40.98 | 0.57640 | 31.65 |
| 52 | −259.96209 | 3.527 | | | | 31.65 |
| 53 | −58.50509 | 4.010 | 1.58313 | 59.37 | 0.54345 | 31.69 |
| 54 | −30.24183 | 0.900 | 1.88300 | 40.69 | 0.56730 | 31.89 |
| 55 | −270.81550 | 9.601 | | | | 31.89 |
| 56 | 632.93983 | 3.737 | 1.80518 | 25.43 | 0.61027 | 33.55 |
| 57 | −92.33303 | 57.093 | | | | 39.10 |
| 58 | ∞ | 4.150 | 1.51633 | 64.14 | | |
| 59 | ∞ | 1.000 | | | | |

TABLE 5
Example 2

| | WIDE | MIDDLE | TELE |
|---|---|---|---|
| Zr | 1.0 | 3.0 | 7.7 |
| f | 50.014 | 152.384 | 385.608 |
| Bf | 60.830 | 60.830 | 60.830 |
| FNo. | 3.30 | 3.30 | 3.30 |
| 2ω(°) | 50.2 | 16.8 | 6.8 |
| Ims | 23.4 | 23.4 | 23.4 |
| DD[18] | 1.401 | 61.013 | 112.889 |
| DD[20] | 1.671 | 18.471 | 1.771 |
| DD[27] | 17.660 | 18.342 | 17.931 |
| DD[32] | 72.888 | 9.241 | 25.734 |
| DD[35] | 67.324 | 53.877 | 2.620 |

TABLE 6
Example 2

| Sn | 1 | 19 |
|---|---|---|
| KA | 1.0000000E+00 | 1.0000000E+00 |
| A3 | −5.3857896E−09 | 1.7256063E−07 |
| A4 | 1.6400269E−08 | 1.0893109E−07 |
| A5 | 2.3508237E−10 | 1.0971148E−09 |
| A6 | −1.5235911E−11 | 5.6637554E−11 |
| A7 | 4.9670252E−13 | −2.2920563E−12 |
| A8 | −7.6409319E−15 | −1.9202370E−14 |
| A9 | 3.1570719E−17 | 4.7260463E−16 |
| A10 | 3.4461939E−19 | 6.6562681E−18 |
| A11 | −7.7681344E−22 | 2.1540998E−18 |
| A12 | −1.1578351E−23 | 2.7181607E−20 |
| A13 | −2.8382718E−25 | −9.5470802E−22 |
| A14 | 4.5952417E−28 | −7.4604126E−23 |
| A15 | −2.5573237E−29 | −1.0282561E−24 |
| A16 | 2.4594128E−31 | −1.5620019E−26 |
| A17 | 1.8989264E−33 | 2.8630617E−27 |
| A18 | 1.0526064E−34 | 1.9178263E−29 |
| A19 | −3.8125305E−37 | 2.2155451E−32 |
| A20 | −8.7483555E−39 | −3.1766565E−32 |

### Example 3

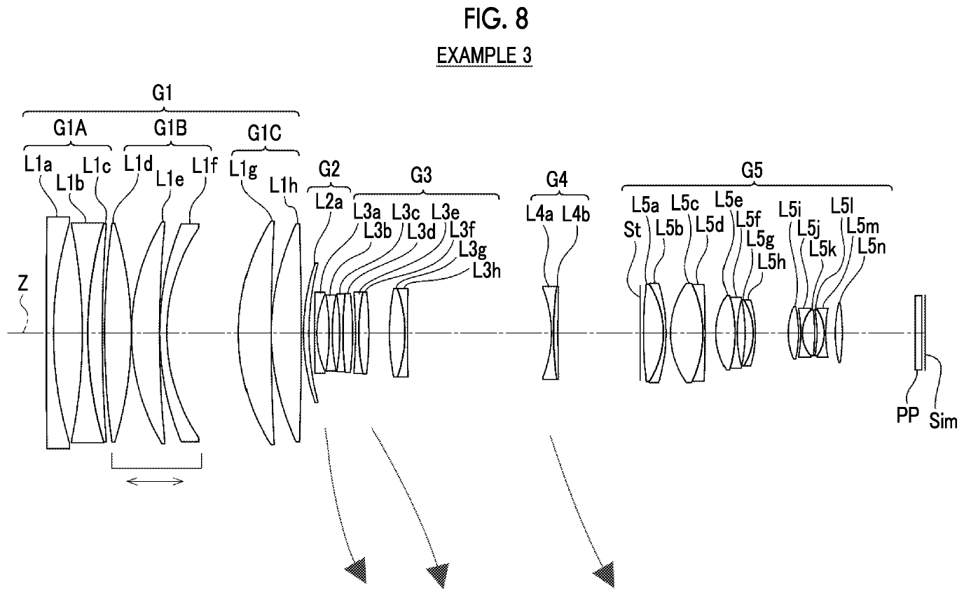

FIG. 8 shows a configuration and movement loci of the variable magnification optical system of Example 3. The variable magnification optical system in Example 3 consists of, in order from the object side to the image side, a first lens group G1 having a positive refractive power, a second lens group G2 having a positive refractive power, a third lens group G3 having a negative refractive power, a fourth lens group G4 having a negative refractive power, and a fifth lens group G5 having a positive refractive power.

During changing magnification, the first lens group G1 and the fifth lens group G5 remain stationary with respect to the image plane Sim, and the second lens group G2, the third lens group G3, and the fourth lens group G4 move along the optical axis Z by changing the spacing from the adjacent lens groups. The middle group GM consists of a second lens group G2 and a third lens group G3. The negative movable lens group GN consists of a fourth lens group G4.

The first lens group G1 consists of a first A subgroup G1A, a first B subgroup G1B, and a first C subgroup G1C in order from the object side to the image side. The focus group is the first B subgroup G1B. The first A subgroup G1A consists of three lenses L1a to L1c in order from the object side to the image side. The first B subgroup G1B consists of three lenses L1d to L1f in order from the object side to the image side. The first C subgroup G1C consists of two lenses L1g and L1h in order from the object side to the image side.

The second lens group G2 consists of one lens L2a. The third lens group G3 consists of eight lenses L3a to L3h in order from the object side to the image side. The fourth lens group G4 consists of two lenses L4a and L4b in order from the object side to the image side. The fifth lens group G5 consists of an aperture stop St and fourteen lenses L5a to L5n in order from the object side to the image side.

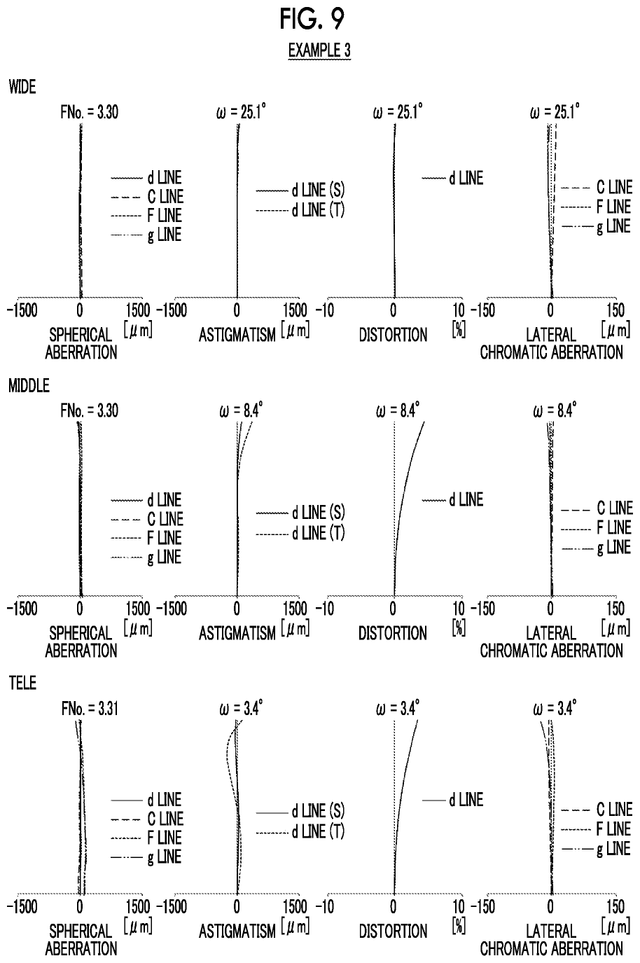

Regarding the variable magnification optical system of Example 3, Tables 7A and 7B show the basic lens data, Table 8 shows the specifications and the variable surface spacings, Table 9 shows the aspherical coefficients, and FIG. 9 shows a diagram of aberrations in a state in which the infinite distance object is in focus.

TABLE 7A
Example 3

| Sn | R | D | Nd | vd | θgF | ED | Sg |
|---|---|---|---|---|---|---|---|
| *1 | 19271.78853 | 4.400 | 1.72916 | 54.09 | 0.54490 | 147.35 | 3.98 |
| 2 | 252.10525 | 17.839 | | | | 147.00 | |
| 3 | −353.06322 | 3.419 | 1.76804 | 51.69 | 0.54848 | 139.84 | 4.28 |
| 4 | 249.21816 | 8.920 | 1.84666 | 23.83 | 0.61603 | 138.34 | 5.51 |
| 5 | 960.99204 | 1.480 | | | | 138.34 | |
| 6 | 540.48281 | 16.420 | 1.50945 | 81.08 | 0.53930 | 138.29 | 3.56 |
| 7 | −241.75010 | 0.199 | | | | 138.51 | |
| 8 | 140.62658 | 17.342 | 1.43875 | 94.66 | 0.53402 | 138.43 | 3.59 |
| 9 | 731.45411 | 0.200 | | | | 140.53 | |
| 10 | 186.94200 | 4.299 | 1.85478 | 24.80 | 0.61232 | 140.00 | 3.49 |
| 11 | 122.10150 | 44.236 | | | | 138.34 | |
| 12 | 136.76463 | 20.001 | 1.43875 | 94.66 | 0.53402 | 133.47 | 3.59 |
| 13 | 1379.24472 | 0.119 | | | | 141.94 | |
| *14 | 151.90029 | 18.500 | 1.49700 | 81.54 | 0.53748 | 142.00 | 3.62 |
| 15 | −2373.89846 | DD[15] | | | | 138.41 | |
| *16 | 141.15697 | 3.326 | 1.43875 | 94.66 | 0.53402 | 137.43 | |
| 17 | 173.08616 | DD[17] | | | | 88.15 | |
| 18 | 882.03281 | 1.500 | 1.90043 | 37.37 | 0.57668 | 86.59 | |
| 19 | 61.62679 | 7.548 | | | | 51.07 | |
| 20 | −144.69746 | 1.964 | 1.59282 | 68.62 | 0.54414 | 48.00 | |
| 21 | 127.82290 | 4.607 | | | | 47.85 | |
| 22 | −159.27544 | 1.957 | 1.63153 | 59.92 | 0.54308 | 47.75 | |
| 23 | 233.97006 | 5.977 | 1.73800 | 32.26 | 0.58953 | 49.09 | |
| 24 | −223.32010 | 1.830 | | | | 49.09 | |
| 25 | −310.24481 | 2.000 | 1.52841 | 76.45 | 0.53954 | 49.80 | |
| 26 | 129.73970 | 6.253 | 1.55345 | 45.09 | 0.56984 | 51.33 | |
| 27 | −249.65422 | 12.737 | | | | 51.33 | |
| 28 | 149.96629 | 9.528 | 1.60342 | 54.02 | 0.55040 | 51.75 | |
| 29 | −87.74754 | 1.510 | 1.52841 | 76.45 | 0.53954 | 55.81 | |
| 30 | 1059.63429 | DD[30] | | | | 55.81 | |
| 31 | −78.11539 | 1.300 | 1.49700 | 81.64 | 0.53714 | 55.82 | |
| 32 | 222.92065 | 0.218 | | | | 56.30 | |
| 33 | 253.65662 | 2.499 | 1.84666 | 23.83 | 0.61603 | 58.61 | |
| 34 | 1707.86188 | DD[34] | | | | 58.60 | |

TABLE 7B
Example 3

| Sn | R | D | Nd | νd | θgF | ED |
|---|---|---|---|---|---|---|
| 35(St) | ∞ | 1.970 | | | | 58.79 |
| 36 | 254.22704 | 12.360 | 1.59410 | 60.47 | 0.55516 | 59.79 |
| 37 | −58.35769 | 1.650 | 1.80577 | 43.86 | 0.56366 | 61.46 |
| 38 | −108.61656 | 2.800 | | | | 61.46 |
| 39 | 55.37270 | 20.001 | 1.53775 | 74.70 | 0.53936 | 62.96 |
| 40 | −73.49141 | 1.377 | 1.54072 | 47.23 | 0.56511 | 61.10 |
| 41 | −628.54906 | 6.567 | | | | 61.09 |
| 42 | 46.39609 | 11.611 | 1.43875 | 94.66 | 0.53402 | 57.70 |
| 43 | −84.14447 | 1.300 | 1.95375 | 32.32 | 0.59015 | 44.78 |
| 44 | 84.64250 | 4.978 | | | | 44.77 |
| 45 | −99.79374 | 5.001 | 1.84666 | 23.83 | 0.61603 | 41.64 |
| 46 | −39.83899 | 1.410 | 1.75118 | 52.88 | 0.54695 | 41.55 |
| 47 | −72.59238 | 20.191 | | | | 41.55 |
| 48 | 42.22067 | 6.335 | 1.43875 | 94.66 | 0.53402 | 41.20 |
| 49 | −82.33364 | 1.388 | | | | 32.83 |
| 50 | −86.04543 | 1.000 | 1.95375 | 32.32 | 0.59015 | 32.15 |
| 51 | 22.26164 | 7.667 | 1.59321 | 38.68 | 0.58204 | 28.73 |
| 52 | −121.83579 | 1.442 | | | | 28.73 |
| 53 | −80.07575 | 4.511 | 1.55117 | 45.40 | 0.56927 | 28.83 |
| 54 | −26.36830 | 0.900 | 1.84850 | 43.79 | 0.56197 | 28.95 |
| 55 | 94.56389 | 5.914 | | | | 28.95 |
| 56 | 78.49034 | 4.398 | 1.80518 | 25.46 | 0.61572 | 30.82 |
| 57 | −138.63520 | 44.999 | | | | 37.13 |
| 58 | ∞ | 4.150 | 1.51633 | 64.14 | | |
| 59 | ∞ | 2.001 | | | | |

TABLE 8
Example 3

| | WIDE | MIDDLE | TELE |
|---|---|---|---|
| Zr | 1.0 | 3.0 | 7.7 |
| f | 50.001 | 152.343 | 385.504 |
| Bf | 49.737 | 49.737 | 49.737 |
| FNo. | 3.30 | 3.30 | 3.31 |
| 2ω(°) | 50.2 | 16.8 | 6.8 |
| Ims | 23.4 | 23.4 | 23.4 |
| DD[15] | 1.466 | 26.102 | 64.416 |
| DD[17] | 3.466 | 58.858 | 57.105 |
| DD[30] | 89.216 | 13.333 | 21.241 |
| DD[34] | 50.973 | 46.829 | 2.359 |

TABLE 9
Example 3

| Sn | 1 | 14 | 16 |
|---|---|---|---|
| KA | 1.0000000E+00 | 1.0000000E+00 | 1.0000000E+00 |
| A3 | −5.3857896E−09 | 0.0000000E+00 | 1.7256063E−07 |
| A4 | 8.6613357E−09 | −5.6436664E−08 | 1.1522478E−08 |
| A5 | 4.8145204E−11 | 3.1182995E−10 | 6.5602143E−11 |
| A6 | −6.2326937E−15 | −1.2523650E−11 | 1.6451849E−11 |
| A7 | −1.0869750E−14 | 1.1451718E−13 | −1.2838540E−13 |
| A8 | −1.6426134E−16 | 5.1308507E−16 | −1.1170168E−14 |
| A9 | 1.4781502E−18 | −1.2034245E−17 | 6.2369017E−17 |
| A10 | 2.2111089E−20 | −9.1379324E−20 | 2.9484419E−18 |
| A11 | −9.3150872E−23 | 1.8999198E−22 | 5.1239276E−20 |
| A12 | 1.9426906E−25 | 1.0561860E−23 | 4.4926424E−22 |
| A13 | 2.3760241E−26 | 1.1613112E−25 | −2.5001949E−24 |
| A14 | −1.0533093E−27 | 4.7242666E−28 | −9.6227948E−25 |
| A15 | 6.8200149E−30 | −4.2683902E−30 | −1.7801159E−26 |
| A16 | 3.7900040E−32 | −1.3658557E−31 | 5.2905524E−29 |
| A17 | 1.5826565E−35 | −1.5120340E−33 | 6.6013263E−30 |
| A18 | 8.0390213E−37 | −2.0075291E−35 | 1.1849862E−31 |
| A19 | −1.9500130E−37 | −8.5478889E−39 | 2.7764059E−33 |
| A20 | 1.5764736E−39 | 4.6940535E−39 | −8.7655507E−35 |

### Example 4

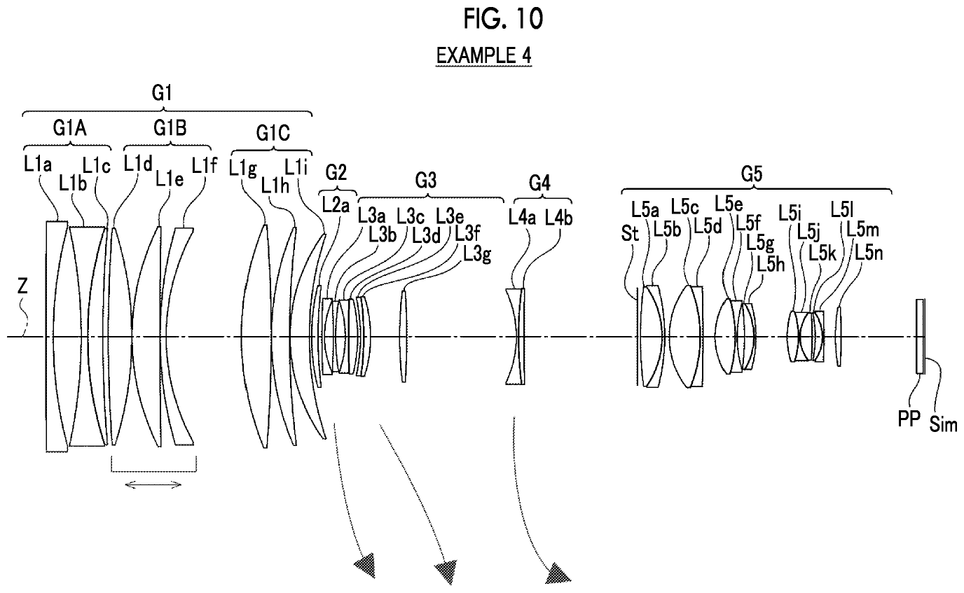

The configuration and movement loci of the variable magnification optical system of Example 4 are shown in FIG. 10. The variable magnification optical system in Example 4 consists of, in order from the object side to the image side, a first lens group G1 having a positive refractive power, a second lens group G2 having a positive refractive power, a third lens group G3 having a negative refractive power, a fourth lens group G4 having a negative refractive power, and a fifth lens group G5 having a positive refractive power.

During changing magnification, the first lens group G1 and the fifth lens group G5 remain stationary with respect to the image plane Sim, and the second lens group G2, the third lens group G3, and the fourth lens group G4 move along the optical axis Z by changing the spacing from the adjacent lens groups. The middle group GM consists of a second lens group G2 and a third lens group G3. The negative movable lens group GN consists of a fourth lens group G4.

The first lens group G1 consists of a first A subgroup G1A, a first B subgroup G1B, and a first C subgroup G1C in order from the object side to the image side. The focus group is the first B subgroup G1B. The first A subgroup G1A consists of three lenses L1a to L1c in order from the object side to the image side. The first B subgroup G1B consists of three lenses L1d to L1f in order from the object side to the image side. The first C subgroup G1C consists of three lenses L1g to L1i in order from the object side to the image side.

The second lens group G2 consists of one lens L2a. The third lens group G3 consists of seven lenses L3a to L3g in order from the object side to the image side. The fourth lens group G4 consists of two lenses L4a and L4b in order from the object side to the image side. The fifth lens group G5 consists of an aperture stop St and fourteen lenses L5a to L5n in order from the object side to the image side.

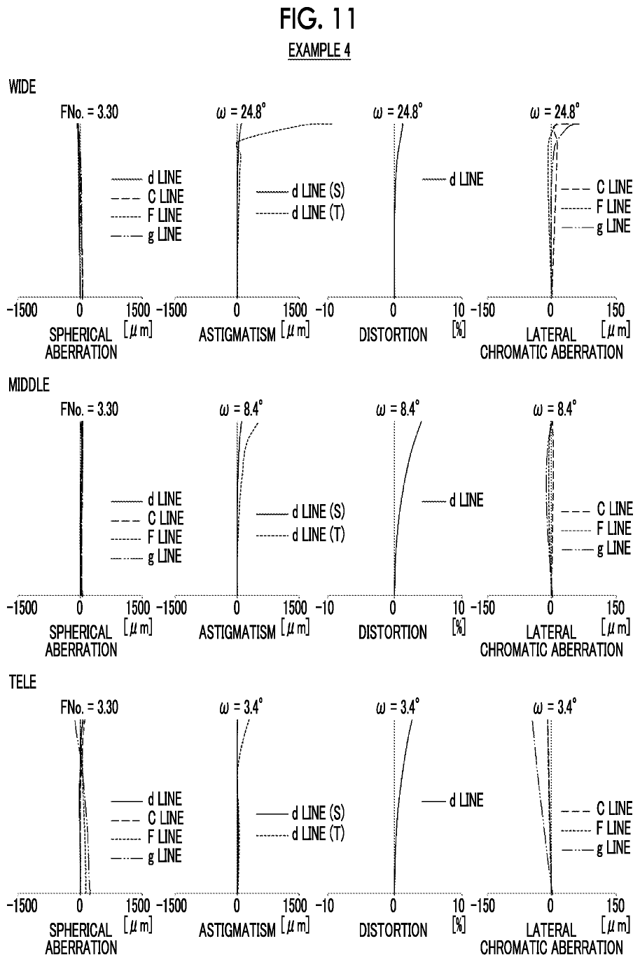

Regarding the variable magnification optical system of Example 4, Tables 10A and 10B show the basic lens data, Table 11 shows the specifications and the variable surface spacings, Table 12 shows the aspherical coefficients, and FIG. 11 shows a diagram of aberrations in a state in which the infinite distance object is in focus.

TABLE 10A
Example 4

| Sn | R | D | Nd | vd | θgF | ED | Sg |
|---|---|---|---|---|---|---|---|
| *1 | 20015.99317 | 4.500 | 1.72916 | 54.68 | 0.54451 | 147.26 | 4.18 |
| 2 | 278.88173 | 17.371 | | | | 147.00 | |
| 3 | −336.90848 | 4.120 | 1.77250 | 49.62 | 0.55188 | 140.34 | 4.26 |
| 4 | 231.89924 | 9.383 | 1.84666 | 23.78 | 0.61923 | 138.14 | 3.50 |
| 5 | 831.17307 | 3.394 | | | | 138.14 | |
| 6 | 976.94620 | 14.693 | 1.59282 | 68.62 | 0.54414 | 138.07 | 4.13 |
| 7 | −233.57946 | 0.119 | | | | 138.28 | |
| 8 | 160.27416 | 17.350 | 1.43875 | 94.66 | 0.53402 | 138.27 | 3.59 |
| 9 | 3512.68676 | 0.119 | | | | 140.43 | |
| 10 | 255.67430 | 3.800 | 1.84666 | 23.78 | 0.61923 | 140.00 | 3.50 |
| 11 | 143.06427 | 46.801 | | | | 138.54 | |
| 12 | 191.98920 | 18.281 | 1.43875 | 94.66 | 0.53402 | 134.73 | 3.59 |
| 13 | −915.96649 | 0.120 | | | | 142.21 | |
| 14 | 183.22841 | 11.298 | 1.55032 | 75.50 | 0.54001 | 142.00 | 4.09 |
| 15 | 573.33724 | 0.300 | | | | 139.32 | |
| 16 | 113.82582 | 11.947 | 1.49700 | 81.64 | 0.53714 | 138.64 | 3.65 |
| 17 | 207.66957 | DD[17] | | | | 130.75 | |
| *18 | 138.05623 | 4.037 | 1.43875 | 94.66 | 0.53402 | 129.50 | |
| 19 | 265.27876 | DD[19] | | | | 64.62 | |
| 20 | 837.50172 | 1.500 | 1.90043 | 37.37 | 0.57668 | 63.07 | |
| 21 | 56.89286 | 5.456 | | | | 48.20 | |
| 22 | −426.91477 | 1.499 | 1.69560 | 59.05 | 0.54348 | 44.95 | |
| 23 | 132.20113 | 6.002 | | | | 44.88 | |
| 24 | −69.92114 | 1.996 | 1.88300 | 40.69 | 0.56730 | 44.34 | |
| 25 | 511.90677 | 5.675 | 1.67270 | 32.21 | 0.59190 | 46.43 | |
| 26 | −102.13627 | 1.816 | | | | 46.44 | |
| 27 | −115.08883 | 2.015 | 1.61720 | 53.97 | 0.55033 | 47.48 | |
| 28 | −186.58078 | 4.249 | 1.62004 | 36.37 | 0.58282 | 49.59 | |
| 29 | −84.73004 | 18.131 | | | | 49.60 | |
| 30 | 258.26706 | 4.475 | 1.78880 | 28.43 | 0.60092 | 50.47 | |
| 31 | −373.84758 | DD[31] | | | | 57.71 | |
| 32 | −68.46537 | 1.320 | 1.43875 | 94.66 | 0.53402 | 57.83 | |
| 33 | 240.13920 | 3.472 | 1.80518 | 25.43 | 0.61027 | 60.55 | |
| 34 | 1893.01324 | DD[34] | | | | 60.55 | |

TABLE 10B
Example 4

| Sn | R | D | Nd | νd | θgF | ED |
|---|---|---|---|---|---|---|
| 35(St) | ∞ | 1.991 | | | | 60.86 |
| 36 | 246.08533 | 13.478 | 1.59349 | 67.00 | 0.53667 | 61.68 |
| 37 | −56.96983 | 1.650 | 1.77250 | 49.62 | 0.55188 | 63.22 |
| 38 | −128.74560 | 2.800 | | | | 63.22 |
| 39 | 53.73521 | 19.343 | 1.53775 | 74.70 | 0.53936 | 64.82 |
| 40 | −87.79724 | 1.670 | 1.54072 | 47.20 | 0.56784 | 63.64 |
| 41 | −1213.08505 | 7.569 | | | | 63.63 |
| 42 | 45.48315 | 12.135 | 1.43875 | 94.66 | 0.53402 | 60.04 |
| 43 | −90.50969 | 1.300 | 1.95375 | 32.32 | 0.59015 | 45.48 |
| 44 | 74.58134 | 4.515 | | | | 45.47 |
| 45 | −165.65036 | 5.878 | 1.84666 | 23.83 | 0.61603 | 41.96 |
| 46 | −41.51517 | 1.230 | 1.78800 | 47.35 | 0.55597 | 41.75 |
| 47 | −80.86869 | 19.483 | | | | 41.75 |
| 48 | 54.64839 | 7.001 | 1.43875 | 94.66 | 0.53402 | 41.20 |
| 49 | −53.11591 | 1.000 | 1.95375 | 32.32 | 0.59015 | 30.73 |
| 50 | 24.20585 | 7.621 | 1.64769 | 33.85 | 0.58860 | 29.44 |
| 51 | −175.50585 | 1.887 | | | | 29.44 |
| 52 | −73.53897 | 4.444 | 1.51742 | 52.43 | 0.55649 | 29.63 |
| 53 | −27.31579 | 0.900 | 1.84850 | 43.79 | 0.56197 | 29.94 |
| 54 | −380.11638 | 7.190 | | | | 29.94 |
| 55 | 106.32314 | 3.601 | 1.80518 | 25.43 | 0.61027 | 31.77 |
| 56 | −279.79194 | 46.853 | | | | 37.44 |
| 57 | ∞ | 4.150 | 1.51633 | 64.14 | | |
| 58 | ∞ | 0.989 | | | | |

TABLE 11
Example 4

| | WIDE | MIDDLE | TELE |
|---|---|---|---|
| Zr | 1.0 | 3.0 | 7.7 |
| f | 49.999 | 152.340 | 385.496 |
| Bf | 50.579 | 50.579 | 50.579 |
| FNo. | 3.30 | 3.30 | 3.30 |
| 2ω(°) | 49.6 | 16.8 | 6.8 |
| Ims | 23.4 | 23.4 | 23.4 |
| DD[17] | 1.483 | 59.306 | 106.099 |
| DD[19] | 2.470 | 17.070 | 2.470 |
| DD[31] | 68.278 | 8.267 | 31.715 |
| DD[34] | 70.421 | 58.010 | 2.368 |

TABLE 12
Example 4

| Sn | 1 | 18 |
|---|---|---|
| KA | 1.0000000E+00 | 1.0000000E+00 |
| A3 | −5.3857896E−09 | 1.7256063E−07 |
| A4 | 3.7872778E−09 | 1.1885030E−07 |
| A5 | 2.4462612E−10 | −1.8059320E−09 |
| A6 | −1.5306688E−11 | 1.0267909E−10 |
| A7 | 5.1635354E−13 | −7.6080811E−13 |
| A8 | −8.6121829E−15 | −4.4255539E−14 |
| A9 | 4.0743938E−17 | −6.9957786E−16 |
| A10 | 4.5417288E−19 | −1.7013319E−17 |
| A11 | −1.8056473E−21 | 3.4005008E−18 |
| A12 | −1.7318465E−23 | 3.6443030E−21 |
| A13 | −3.1472514E−25 | 9.0084163E−22 |
| A14 | −1.7400242E−27 | −5.8505170E−23 |
| A15 | −2.0027491E−29 | −1.6825507E−24 |
| A16 | 7.7081656E−31 | 4.2946000E−26 |
| A17 | 3.6956738E−33 | −1.1275985E−27 |
| A18 | 7.5521081E−35 | −5.2190876E−29 |
| A19 | −3.4871525E−37 | 4.1305544E−30 |
| A20 | −1.2520730E−38 | −5.0103229E−32 |

### Example 5

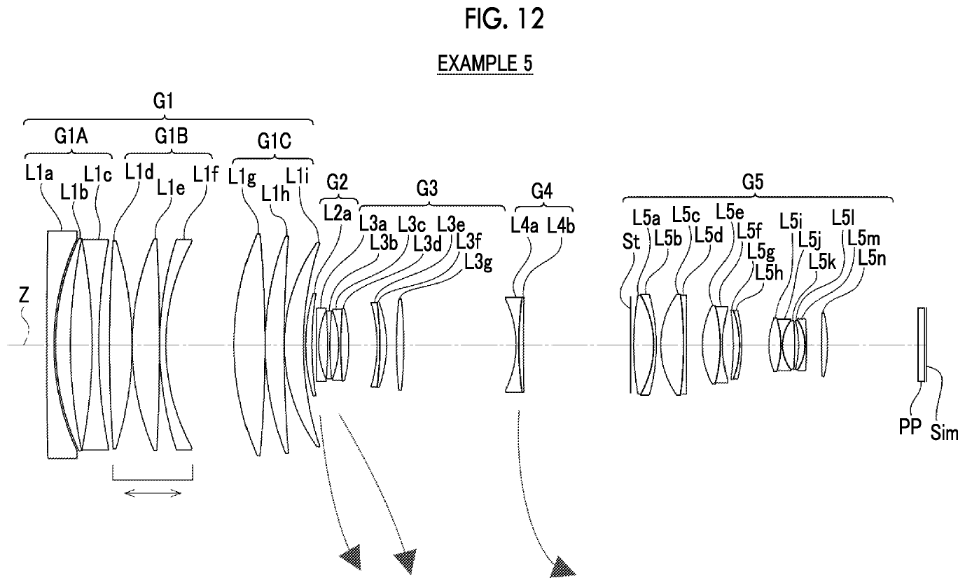

FIG. 12 shows a configuration and movement loci of the variable magnification optical system of Example 5. The variable magnification optical system in Example 5 consists of, in order from the object side to the image side, a first lens group G1 having a positive refractive power, a second lens group G2 having a positive refractive power, a third lens group G3 having a negative refractive power, a fourth lens group G4 having a negative refractive power, and a fifth lens group G5 having a positive refractive power.

During changing magnification, the first lens group G1 and the fifth lens group G5 remain stationary with respect to the image plane Sim, and the second lens group G2, the third lens group G3, and the fourth lens group G4 move along the optical axis Z by changing the spacing from the adjacent lens groups. The middle group GM consists of a second lens group G2 and a third lens group G3. The negative movable lens group GN consists of a fourth lens group G4.

The first lens group G1 consists of a first A subgroup G1A, a first B subgroup G1B, and a first C subgroup G1C in order from the object side to the image side. The focus group is the first B subgroup G1B. The first A subgroup G1A consists of three lenses L1a to L1c in order from the object side to the image side. The first B subgroup G1B consists of three lenses L1d to L1f in order from the object side to the image side. The first C subgroup G1C consists of three lenses L1g to L1i in order from the object side to the image side.

The second lens group G2 consists of one lens L2a. The third lens group G3 consists of seven lenses L3a to L3g in order from the object side to the image side. The fourth lens group G4 consists of two lenses L4a and L4b in order from the object side to the image side. The fifth lens group G5 consists of an aperture stop St and fourteen lenses L5a to L5n in order from the object side to the image side.

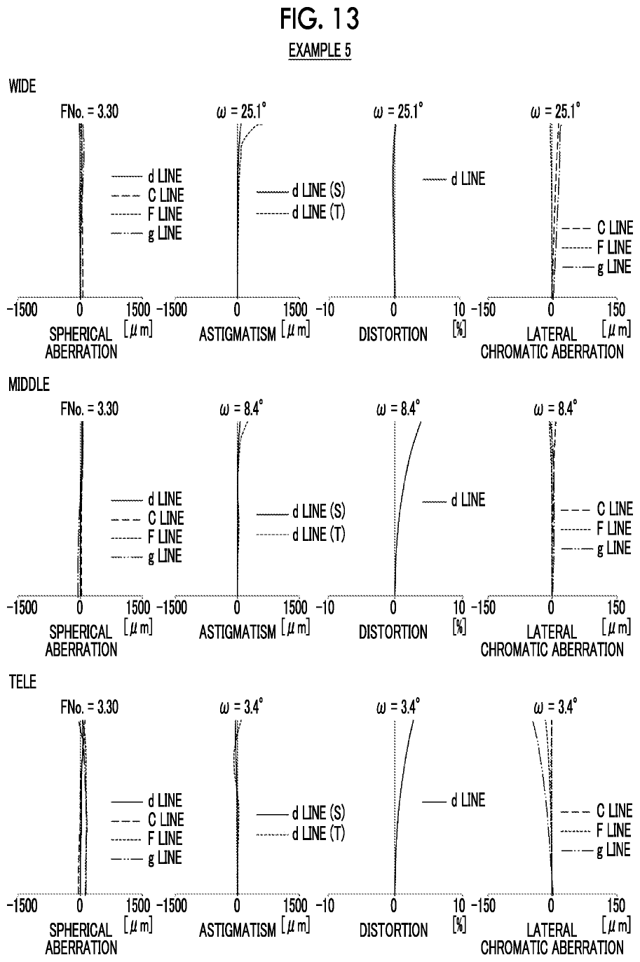

Regarding the variable magnification optical system of Example 5, Tables 13A and 13B show the basic lens data, Table 14 shows the specifications and the variable surface spacings, Table 15 shows the aspherical coefficients, and FIG. 13 shows a diagram of aberrations in a state in which the infinite distance object is in focus.

TABLE 13A
Example 5

| Sn | R | D | Nd | vd | θgF | ED | Sg |
|---|---|---|---|---|---|---|---|
| *1 | 8205.66128 | 4.500 | 1.72916 | 54.68 | 0.54451 | 147.00 | 4.18 |
| 2 | 170.01677 | 1.051 | | | | 137.23 | |
| 3 | 169.27154 | 9.329 | 1.84666 | 23.84 | 0.62012 | 137.04 | 3.50 |
| 4 | 332.18582 | 13.699 | | | | 136.14 | |
| 5 | −362.92401 | 4.100 | 1.77250 | 49.62 | 0.55188 | 136.03 | 4.26 |
| 6 | 365.82303 | 6.842 | | | | 134.13 | |
| 7 | 997.04627 | 14.226 | 1.49700 | 81.64 | 0.53714 | 134.38 | 3.65 |
| 8 | −226.41462 | 0.120 | | | | 134.40 | |
| 9 | 177.95993 | 17.273 | 1.43875 | 94.66 | 0.53402 | 136.88 | 3.59 |
| 10 | −1342.19481 | 0.120 | | | | 136.55 | |
| 11 | 225.89048 | 3.801 | 1.84666 | 23.84 | 0.62012 | 135.77 | 3.50 |
| 12 | 143.43738 | 42.945 | | | | 132.69 | |
| 13 | 186.71399 | 19.191 | 1.43875 | 94.66 | 0.53402 | 142.98 | 3.59 |
| 14 | −829.47251 | 0.120 | | | | 142.84 | |
| 15 | 197.61097 | 11.944 | 1.49700 | 81.64 | 0.53714 | 140.43 | 3.65 |
| 16 | 895.75518 | 0.121 | | | | 139.82 | |
| 17 | 115.75622 | 11.999 | 1.49700 | 81.64 | 0.53714 | 131.82 | 3.65 |
| 18 | 213.25427 | DD[18] | | | | 130.61 | |
| *19 | 119.66301 | 4.001 | 1.49700 | 81.64 | 0.53714 | 66.08 | |
| 20 | 222.20668 | DD[20] | | | | 64.83 | |
| 21 | 1544.71826 | 1.500 | 1.90043 | 37.37 | 0.57668 | 47.07 | |
| 22 | 54.90034 | 5.543 | | | | 43.90 | |
| 23 | −362.43501 | 1.500 | 1.77250 | 49.62 | 0.55188 | 43.82 | |
| 24 | 223.29180 | 5.553 | | | | 43.54 | |
| 25 | −63.62880 | 1.373 | 1.84850 | 43.79 | 0.56197 | 43.55 | |
| 26 | 352.27252 | 4.939 | 1.80518 | 25.43 | 0.61027 | 45.92 | |
| 27 | −100.17466 | 17.899 | | | | 46.51 | |
| 28 | −95.70171 | 1.654 | 1.61997 | 63.88 | 0.54252 | 52.54 | |
| 29 | −222.69281 | 4.269 | 1.61266 | 44.46 | 0.56403 | 54.16 | |
| 30 | −82.29980 | 6.290 | | | | 54.69 | |
| 31 | 286.25058 | 4.499 | 1.74400 | 44.90 | 0.56308 | 58.19 | |
| 32 | −322.82481 | DD[32] | | | | 58.31 | |
| 33 | −67.13021 | 1.671 | 1.43875 | 94.66 | 0.53402 | 58.09 | |
| 34 | 227.55028 | 2.890 | 1.80518 | 25.43 | 0.61027 | 60.97 | |
| 35 | 1328.07583 | DD[35] | | | | 61.16 | |

TABLE 13B
Example 5

| Sn | R | D | Nd | νd | θgF | ED |
|---|---|---|---|---|---|---|
| 36(St) | ∞ | 1.990 | | | | 62.00 |
| 37 | 197.07441 | 12.591 | 1.53775 | 74.70 | 0.53936 | 63.54 |
| 38 | −65.79695 | 1.650 | 1.81600 | 46.59 | 0.55661 | 63.72 |
| 39 | −118.97582 | 2.800 | | | | 65.04 |
| 40 | 57.34935 | 14.414 | 1.53775 | 74.70 | 0.53936 | 64.90 |
| 41 | −259.02339 | 1.670 | 1.54072 | 47.23 | 0.56511 | 63.79 |
| 42 | 1953.40832 | 10.132 | | | | 62.01 |
| 43 | 54.45164 | 11.310 | 1.49700 | 81.64 | 0.53714 | 50.49 |
| 44 | −99.12410 | 1.300 | 1.90043 | 37.37 | 0.57668 | 48.80 |
| 45 | 85.25076 | 6.535 | | | | 45.18 |
| 46 | −165.28070 | 4.001 | 1.80518 | 25.43 | 0.61027 | 44.31 |
| 47 | −62.64231 | 1.409 | 1.53775 | 74.70 | 0.53936 | 44.14 |
| 48 | −95.65383 | 17.043 | | | | 43.36 |
| 49 | 48.54391 | 7.592 | 1.43875 | 94.66 | 0.53402 | 34.25 |
| 50 | −57.96409 | 1.000 | 1.90043 | 37.37 | 0.57668 | 33.21 |
| 51 | 26.30450 | 7.659 | 1.58144 | 40.98 | 0.57640 | 31.34 |
| 52 | −221.48432 | 2.483 | | | | 31.40 |
| 53 | −59.54995 | 4.025 | 1.58313 | 59.37 | 0.54345 | 31.37 |
| 54 | −29.96692 | 0.900 | 1.88300 | 40.69 | 0.56730 | 31.65 |
| 55 | −252.71900 | 9.609 | | | | 33.29 |
| 56 | 632.94260 | 3.780 | 1.80518 | 25.43 | 0.61027 | 38.80 |
| 57 | −94.19992 | 57.014 | | | | 39.17 |
| 58 | ∞ | 4.150 | 1.51633 | 64.14 | | |
| 59 | ∞ | 0.994 | | | | |

TABLE 14
Example 5

| | WIDE | MIDDLE | TELE |
|---|---|---|---|
| Zr | 1.0 | 3.0 | 7.7 |
| f | 50.005 | 152.356 | 385.538 |
| Bf | 60.745 | 60.745 | 60.745 |
| FNo. | 3.30 | 3.30 | 3.30 |
| 2ω(°) | 50.2 | 16.8 | 6.8 |
| Ims | 23.4 | 23.4 | 23.4 |
| DD[18] | 1.474 | 59.318 | 111.943 |
| DD[20] | 2.733 | 19.533 | 2.792 |
| DD[32] | 70.968 | 9.522 | 25.645 |
| DD[35] | 67.589 | 54.391 | 2.385 |

TABLE 15
Example 5

| Sn | 1 | 19 |
|---|---|---|
| KA | 1.0000000E+00 | 1.0000000E+00 |
| A3 | −5.3857896E−09 | 1.7256063E−07 |
| A4 | 1.3877300E−08 | 9.0352072E−08 |
| A5 | 1.9518303E−10 | 9.7583129E−10 |
| A6 | −1.4247728E−11 | 7.1325586E−11 |
| A7 | 4.9246088E−13 | −2.2253642E−12 |
| A8 | −7.7399125E−15 | −2.3301971E−14 |
| A9 | 3.1297320E−17 | 1.8937780E−16 |
| A10 | 3.5660511E−19 | −7.1216157E−18 |
| A11 | −6.7930835E−22 | 2.7351114E−18 |
| A12 | −1.0682671E−23 | 3.7184629E−22 |
| A13 | −2.9321485E−25 | −6.8228596E−24 |
| A14 | 3.9253044E−28 | −5.1627438E−23 |
| A15 | −2.4799576E−29 | −1.0279215E−24 |
| A16 | 2.1727276E−31 | −3.2528888E−26 |
| A17 | 1.2731769E−33 | 2.1469551E−27 |
| A18 | 1.0798389E−34 | 5.3912796E−31 |
| A19 | −3.8971441E−37 | 1.0885495E−30 |
| A20 | −7.7345659E−39 | −3.4464014E−32 |

### Example 6

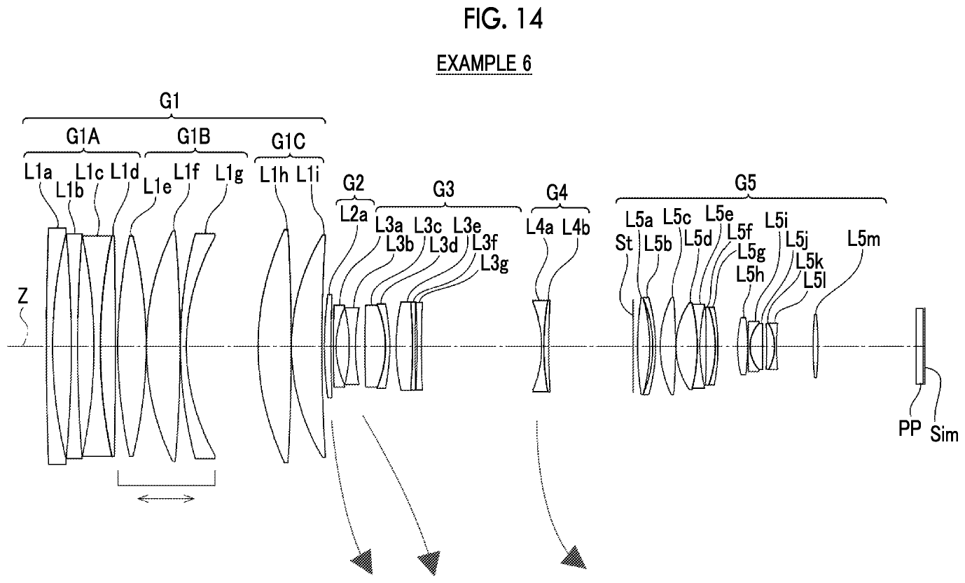

FIG. 14 shows a configuration and movement loci of the variable magnification optical system of Example 6. The variable magnification optical system in Example 6 consists of, in order from the object side to the image side, a first lens group G1 having a positive refractive power, a second lens group G2 having a positive refractive power, a third lens group G3 having a negative refractive power, a fourth lens group G4 having a negative refractive power, and a fifth lens group G5 having a positive refractive power.

During changing magnification, the first lens group G1 and the fifth lens group G5 remain stationary with respect to the image plane Sim, and the second lens group G2, the third lens group G3, and the fourth lens group G4 move along the optical axis Z by changing the spacing from the adjacent lens groups. The middle group GM consists of a second lens group G2 and a third lens group G3. The negative movable lens group GN consists of a fourth lens group G4.

The first lens group G1 consists of a first A subgroup G1A, a first B subgroup G1B, and a first C subgroup G1C in order from the object side to the image side. The focus group is the first B subgroup G1B. The first A subgroup G1A consists of four lenses L1a to L1d in order from the object side to the image side. The first B subgroup G1B consists of three lenses L1e to L1g in order from the object side to the image side. The first C subgroup G1C consists of two lenses L1h and L1i in order from the object side to the image side.

The second lens group G2 consists of one lens L2a. The third lens group G3 consists of seven lenses L3a to L3g in order from the object side to the image side. The fourth lens group G4 consists of two lenses L4a and L4b in order from the object side to the image side. The fifth lens group G5 consists of an aperture stop St and thirteen lenses L5a to L5m in order from the object side to the image side.

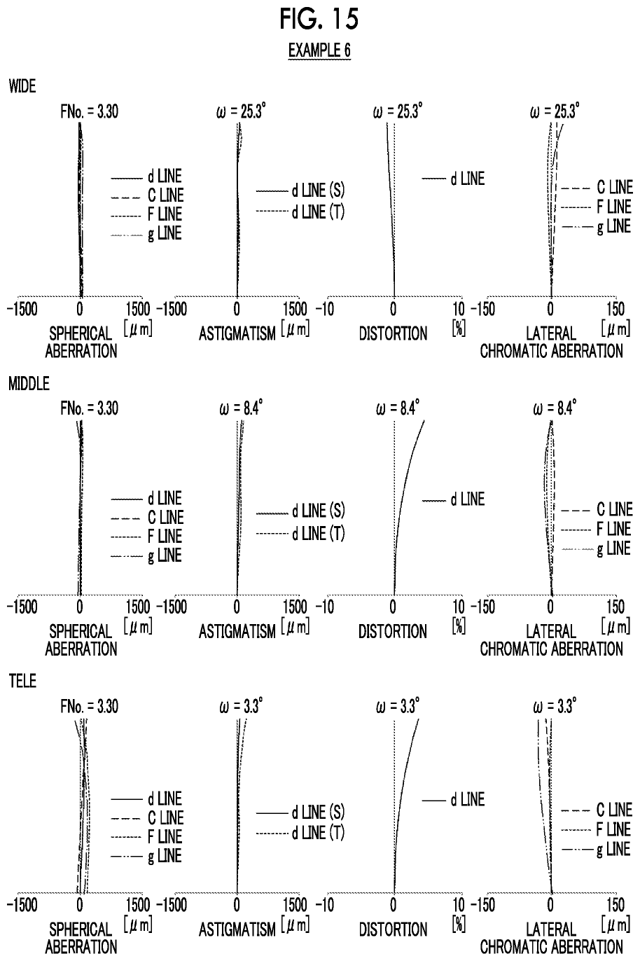

Regarding the variable magnification optical system of Example 6, Tables 16A and 16B show the basic lens data, Table 17 shows the specifications and the variable surface spacings, Table 18 shows the aspherical coefficients, and FIG. 15 shows a diagram of aberrations in a state in which the infinite distance object is in focus.

TABLE 16A
Example 6

| Sn | R | D | Nd | vd | θgF | ED | Sg |
|---|---|---|---|---|---|---|---|
| 1 | 2112.12382 | 3.800 | 1.73402 | 54.60 | 0.54448 | 146.24 | 4.13 |
| 2 | 305.99931 | 11.288 | | | | 145.06 | |
| 3 | −787.87764 | 3.801 | 1.74344 | 53.66 | 0.54583 | 139.31 | 4.17 |
| 4 | 879.98837 | 9.929 | | | | 139.21 | |
| 5 | −336.59454 | 3.820 | 1.77250 | 49.60 | 0.55212 | 136.79 | 4.23 |
| 6 | 335.14369 | 9.170 | 1.84666 | 23.83 | 0.61603 | 136.76 | 5.51 |
| 7 | −3517.81701 | 1.500 | | | | 136.76 | |
| *8 | 316.09003 | 17.109 | 1.49700 | 81.54 | 0.53748 | 136.74 | 3.62 |
| 9 | −296.70000 | 0.200 | | | | 136.20 | |
| 10 | 169.21266 | 20.399 | 1.43875 | 94.66 | 0.53402 | 138.91 | 3.59 |
| 11 | −882.55556 | 0.200 | | | | 142.80 | |
| 12 | 274.21910 | 3.601 | 1.85478 | 24.80 | 0.61232 | 142.60 | 3.49 |
| 13 | 140.71353 | 43.083 | | | | 139.66 | |
| *14 | 163.78127 | 20.099 | 1.53775 | 74.70 | 0.53936 | 135.25 | 3.64 |
| 15 | −1361.49906 | 0.201 | | | | 144.81 | |
| 16 | 135.80126 | 18.394 | 1.49700 | 81.54 | 0.53748 | 143.80 | 3.62 |
| 17 | 1109.06277 | DD[17] | | | | 137.98 | |
| 18 | 241.88045 | 4.000 | 1.43875 | 94.66 | 0.53402 | 137.00 | |
| 19 | 895.42383 | DD[19] | | | | 63.61 | |
| *20 | 2256.20719 | 1.621 | 1.90043 | 37.37 | 0.57668 | 51.07 | |
| 21 | 57.70558 | 7.981 | | | | 50.69 | |
| 22 | −102.74826 | 3.669 | 1.80706 | 47.75 | 0.55504 | 46.98 | |
| 23 | 125.33668 | 5.784 | | | | 46.89 | |
| 24 | 740.58097 | 12.460 | 1.59270 | 35.31 | 0.59336 | 47.21 | |
| 25 | −67.52364 | 2.555 | 1.59282 | 68.62 | 0.54414 | 50.64 | |
| 26 | −133.67229 | 3.872 | | | | 50.64 | |
| 27 | 127.93660 | 9.987 | 1.78213 | 32.82 | 0.59360 | 52.17 | |
| 28 | −312.29512 | 1.583 | 1.49700 | 81.61 | 0.53887 | 54.33 | |
| 29 | 2317.04449 | 1.150 | | | | 54.33 | |
| 30 | −476.06392 | 2.713 | 1.67545 | 57.73 | 0.54287 | 54.06 | |
| 31 | 782.31379 | DD[31] | | | | 54.04 | |
| 32 | −72.24096 | 1.311 | 1.52271 | 77.69 | 0.53897 | 53.92 | |
| 33 | 165.35287 | 3.000 | 1.84999 | 23.69 | 0.62126 | 56.31 | |
| 34 | 478.33025 | DD[34] | | | | 56.31 | |

TABLE 16B
Example 6

| Sn | R | D | Nd | νd | θgF | ED |
|---|---|---|---|---|---|---|
| 35(St) | ∞ | 2.785 | | | | 56.53 |
| 36 | 217.32899 | 7.353 | 1.70287 | 56.36 | 0.54348 | 57.32 |
| 37 | −112.83667 | 1.818 | | | | 59.24 |
| 38 | −79.78275 | 1.701 | 1.73800 | 32.33 | 0.59005 | 59.39 |
| 39 | −110.91198 | 2.801 | | | | 59.38 |
| 40 | 70.23303 | 9.431 | 1.55532 | 66.05 | 0.53856 | 60.13 |
| 41 | −359.62847 | 0.151 | | | | 59.94 |
| 42 | 48.79175 | 12.838 | 1.43700 | 95.10 | 0.53364 | 59.44 |
| 43 | −115.55063 | 1.601 | 1.90366 | 31.31 | 0.59481 | 51.83 |
| 44 | 112.02454 | 4.006 | | | | 51.82 |
| 45 | −408.45943 | 5.384 | 1.84661 | 23.88 | 0.62072 | 48.48 |
| 46 | −75.08207 | 1.600 | 1.84850 | 43.79 | 0.56197 | 47.73 |
| 47 | −127.38079 | 11.516 | | | | 47.73 |
| 48 | 75.30319 | 6.136 | 1.49700 | 81.61 | 0.53887 | 47.07 |
| 49 | −136.34693 | 0.233 | | | | 35.17 |
| 50 | 519.90262 | 1.201 | 1.82684 | 46.59 | 0.55696 | 33.15 |
| 51 | 21.85654 | 7.579 | 1.43700 | 95.10 | 0.53364 | 28.71 |
| 52 | −1161.38463 | 2.472 | | | | 28.71 |
| 53 | −363.17151 | 4.855 | 1.49700 | 81.61 | 0.53887 | 28.56 |
| 54 | −29.03187 | 1.101 | 1.79754 | 48.25 | 0.55426 | 28.23 |
| 55 | 152.11880 | 22.175 | | | | 28.23 |
| 56 | 211.33901 | 2.995 | 1.74460 | 28.54 | 0.60738 | 29.02 |
| 57 | −196.47086 | 59.418 | | | | 38.46 |
| 58 | ∞ | 4.150 | 1.51680 | 64.20 | | |
| 59 | ∞ | 1.010 | | | | |

TABLE 17
Example 6

| | WIDE | MIDDLE | TELE |
|---|---|---|---|
| Zr | 1.0 | 3.1 | 7.7 |
| f | 50.004 | 152.572 | 386.536 |
| Bf | 63.164 | 63.164 | 63.164 |
| FNo. | 3.30 | 3.30 | 3.30 |
| 2ω(°) | 50.6 | 16.8 | 6.6 |
| Ims | 23.4 | 23.4 | 23.4 |
| DD[17] | 1.500 | 58.101 | 103.301 |
| DD[19] | 1.507 | 15.091 | 1.507 |
| DD[31] | 72.728 | 9.707 | 19.660 |
| DD[34] | 51.058 | 43.895 | 2.325 |

TABLE 18
Example 6

| Sn | 8 | 14 | 20 |
|---|---|---|---|
| KA | 1.0000000E+00 | 1.0000000E+00 | 1.0000000E+00 |
| A4 | −2.1692043E−08 | −2.7727773E−08 | 2.5320472E−07 |
| A6 | 1.2768740E−12 | −1.1067827E−12 | 2.1091895E−10 |
| A8 | −4.8788496E−16 | −2.3233665E−16 | −7.1740421E−13 |
| A10 | 6.0679808E−20 | 2.4327059E−19 | 7.8662068E−16 |
| A12 | −2.9066987E−24 | −6.8936760E−23 | 8.0200926E−19 |
| A14 | 7.0801276E−28 | 5.0247986E−27 | −2.7607559E−21 |
| A16 | −2.4183654E−31 | 1.3256291E−30 | 8.2237000E−25 |
| A18 | 2.9233605E−35 | −2.9285922E−34 | 3.1613332E−27 |
| A20 | −1.2019237E−39 | 1.6932459E−38 | −2.4662852E−30 |

### Example 7

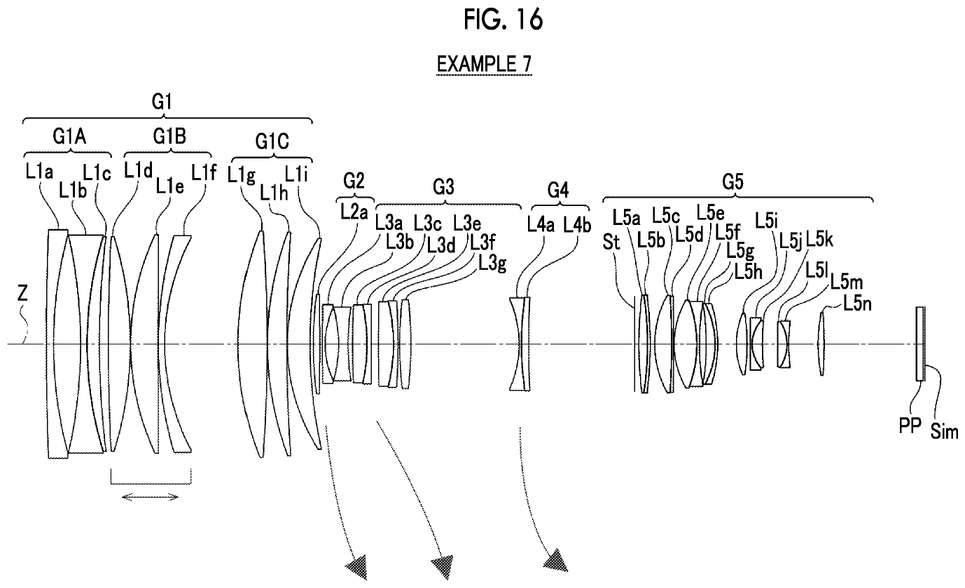

FIG. 16 shows a configuration and movement loci of the variable magnification optical system of Example 7. The variable magnification optical system in Example 7 consists of, in order from the object side to the image side, a first lens group G1 having a positive refractive power, a second lens group G2 having a positive refractive power, a third lens group G3 having a negative refractive power, a fourth lens group G4 having a negative refractive power, and a fifth lens group G5 having a positive refractive power.

During changing magnification, the first lens group G1 and the fifth lens group G5 remain stationary with respect to the image plane Sim, and the second lens group G2, the third lens group G3, and the fourth lens group G4 move along the optical axis Z by changing the spacing from the adjacent lens groups. The middle group GM consists of a second lens group G2 and a third lens group G3. The negative movable lens group GN consists of a fourth lens group G4.

The first lens group G1 consists of a first A subgroup G1A, a first B subgroup G1B, and a first C subgroup G1C in order from the object side to the image side. The focus group is the first B subgroup G1B. The first A subgroup G1A consists of three lenses L1a to L1c in order from the object side to the image side. The first B subgroup G1B consists of three lenses L1d to L1f in order from the object side to the image side. The first C subgroup G1C consists of three lenses L1g to L1i in order from the object side to the image side.

The second lens group G2 consists of one lens L2a. The third lens group G3 consists of seven lenses L3a to L3g in order from the object side to the image side. The fourth lens group G4 consists of two lenses L4a and L4b in order from the object side to the image side. The fifth lens group G5 consists of an aperture stop St and fourteen lenses L5a to L5n in order from the object side to the image side.

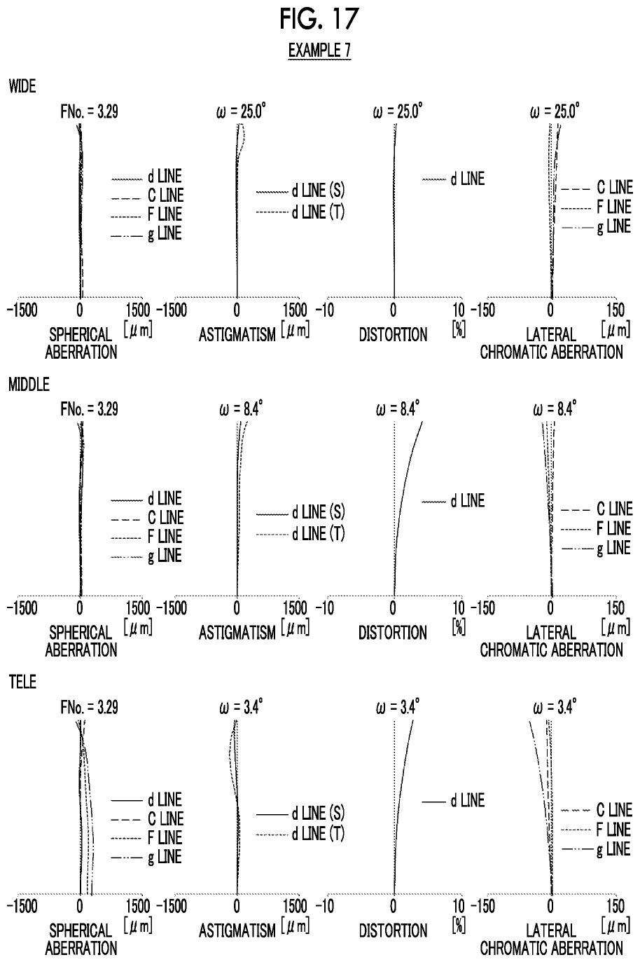

Regarding the variable magnification optical system of Example 7, Tables 19A and 19B show the basic lens data, Table 20 shows the specifications and the variable surface spacings, Table 21 shows the aspherical coefficients, and FIG. 17 shows a diagram of aberrations in a state in which the infinite distance object is in focus.

TABLE 19A
Example 7

| Sn | R | D | Nd | vd | θgF | ED | Sg |
|---|---|---|---|---|---|---|---|
| *1 | 2499.51160 | 4.500 | 1.72916 | 54.68 | 0.54451 | 148.22 | 4.18 |
| 2 | 277.11484 | 16.918 | | | | 147.00 | |
| 3 | −326.07416 | 4.220 | 1.75500 | 52.32 | 0.54757 | 136.06 | 4.17 |
| 4 | 244.14465 | 7.653 | 1.84666 | 23.84 | 0.62012 | 137.98 | 3.50 |
| 5 | 582.65242 | 5.581 | | | | 137.98 | |
| 6 | 1362.74691 | 13.839 | 1.59282 | 68.62 | 0.54414 | 137.75 | 4.13 |
| 7 | −237.95589 | 0.201 | | | | 137.83 | |
| 8 | 168.74635 | 17.219 | 1.43875 | 94.66 | 0.53402 | 138.87 | 3.59 |
| 9 | 34365.73168 | 0.200 | | | | 140.36 | |
| 10 | 253.77606 | 3.900 | 1.84666 | 23.84 | 0.62012 | 140.20 | 3.50 |
| 11 | 148.30858 | 45.916 | | | | 139.16 | |
| 12 | 202.87000 | 18.094 | 1.43875 | 94.66 | 0.53402 | 135.80 | 3.59 |
| 13 | −1021.95507 | 0.201 | | | | 145.51 | |
| 14 | 209.06059 | 12.095 | 1.55032 | 75.50 | 0.54001 | 145.44 | 4.09 |
| 15 | 1049.16749 | 0.320 | | | | 143.63 | |
| 16 | 127.89764 | 14.177 | 1.49700 | 81.64 | 0.53714 | 143.03 | 3.65 |
| 17 | 318.59302 | DD[17] | | | | 135.44 | |
| 18 | 255.79334 | 4.001 | 1.43875 | 94.66 | 0.53402 | 134.11 | |
| 19 | −2257.14682 | DD[19] | | | | 63.18 | |
| *20 | 4164.96215 | 1.701 | 1.90043 | 37.37 | 0.57668 | 50.51 | |
| 21 | 57.33914 | 8.408 | | | | 50.30 | |
| 22 | −85.72601 | 6.000 | 1.75500 | 52.32 | 0.54757 | 46.47 | |
| 23 | 165.19750 | 2.805 | | | | 46.36 | |
| 24 | 514.22796 | 9.009 | 1.59270 | 35.31 | 0.59336 | 47.20 | |
| 25 | −122.09232 | 2.799 | 1.59282 | 68.62 | 0.54414 | 49.64 | |
| 26 | −1465.25772 | 4.438 | | | | 49.64 | |
| 27 | 1532.23624 | 9.399 | 1.78880 | 28.43 | 0.60092 | 52.98 | |
| 28 | −112.23786 | 2.899 | 1.88300 | 40.76 | 0.56679 | 54.32 | |
| 29 | −407.72911 | 0.932 | | | | 54.32 | |
| 30 | 242.07778 | 6.999 | 1.67300 | 38.26 | 0.57580 | 55.53 | |
| 31 | −262.39281 | DD[31] | | | | 56.63 | |
| 32 | −72.02829 | 1.411 | 1.43875 | 94.66 | 0.53402 | 56.95 | |
| 33 | 211.19701 | 4.442 | 1.84666 | 23.83 | 0.61603 | 59.32 | |
| 34 | 525.10338 | DD[34] | | | | 59.32 | |

TABLE 19B
Example 7

| Sn | R | D | Nd | νd | θgF | ED |
|---|---|---|---|---|---|---|
| 35(St) | ∞ | 2.500 | | | | 59.75 |
| 36 | 259.55021 | 5.436 | 1.72916 | 54.68 | 0.54451 | 60.55 |
| 37 | −217.15012 | 1.700 | 1.73800 | 32.33 | 0.59005 | 62.22 |
| 38 | −256.41303 | 2.800 | | | | 62.22 |
| 39 | 65.82243 | 10.567 | 1.53775 | 74.70 | 0.53936 | 62.42 |
| 40 | −574.67204 | 1.311 | 1.54072 | 47.23 | 0.56511 | 61.59 |
| 41 | −2932.07333 | 0.340 | | | | 61.59 |
| 42 | 57.01484 | 14.236 | 1.43700 | 95.10 | 0.53364 | 60.86 |
| 43 | −80.63266 | 1.601 | 1.88300 | 40.76 | 0.56679 | 54.62 |
| 44 | 163.92294 | 4.285 | | | | 54.61 |
| 45 | −162.46986 | 5.599 | 1.73800 | 32.33 | 0.59005 | 51.70 |
| 46 | −56.32939 | 1.611 | 1.72916 | 54.68 | 0.54451 | 51.54 |
| 47 | −86.86479 | 11.289 | | | | 51.54 |
| 48 | 50.82282 | 6.764 | 1.51860 | 69.89 | 0.53184 | 51.25 |
| 49 | −138.90444 | 2.001 | | | | 39.16 |
| 50 | −6131.02993 | 1.201 | 1.87070 | 40.73 | 0.56825 | 38.09 |
| 51 | 23.48588 | 6.384 | 1.43700 | 95.10 | 0.53364 | 30.22 |
| 52 | 152.88153 | 9.656 | | | | 30.22 |
| 53 | 937.32783 | 5.874 | 1.49700 | 81.64 | 0.53714 | 30.01 |
| 54 | −27.27776 | 1.100 | 1.81600 | 46.62 | 0.55682 | 28.99 |
| 55 | 153.58623 | 18.350 | | | | 28.99 |
| 56 | 104.83403 | 3.734 | 1.78880 | 28.43 | 0.60092 | 29.92 |
| 57 | −333.03023 | 57.970 | | | | 39.87 |
| 58 | ∞ | 4.150 | 1.51680 | 64.20 | | |
| 59 | ∞ | 1.002 | | | | |

TABLE 20
Example 7

| | WIDE | MIDDLE | TELE |
|---|---|---|---|
| Zr | 1.0 | 3.1 | 7.7 |
| f | 49.993 | 152.539 | 386.452 |
| Bf | 61.708 | 61.708 | 61.708 |
| FNo. | 3.29 | 3.29 | 3.29 |
| 2ω(°) | 50.0 | 16.8 | 6.8 |
| Ims | 23.4 | 23.4 | 23.4 |
| DD[17] | 2.166 | 62.577 | 104.679 |
| DD[19] | 1.715 | 12.451 | 1.716 |
| DD[31] | 68.059 | 8.015 | 29.459 |
| DD[34] | 66.731 | 55.628 | 2.817 |

TABLE 21
Example 7

| Sn | 1 | 20 |
|---|---|---|
| KA | 1.0000000E+00 | 1.0000000E+00 |
| A4 | 7.7879396E−09 | 1.6442102E−07 |
| A6 | 6.9131651E−13 | −1.9498855E−11 |
| A8 | −3.8836286E−16 | −1.0582242E−13 |
| A10 | 9.0639926E−20 | 1.6685707E−16 |
| A12 | −1.0085685E−23 | 1.3708912E−19 |
| A14 | 9.2869034E−28 | −4.8057576E−22 |
| A16 | −3.0706896E−31 | −8.4674094E−26 |
| A18 | 5.3311497E−35 | 7.2952808E−28 |
| A20 | −2.8029557E−39 | −3.5929459E−31 |

### Example 8

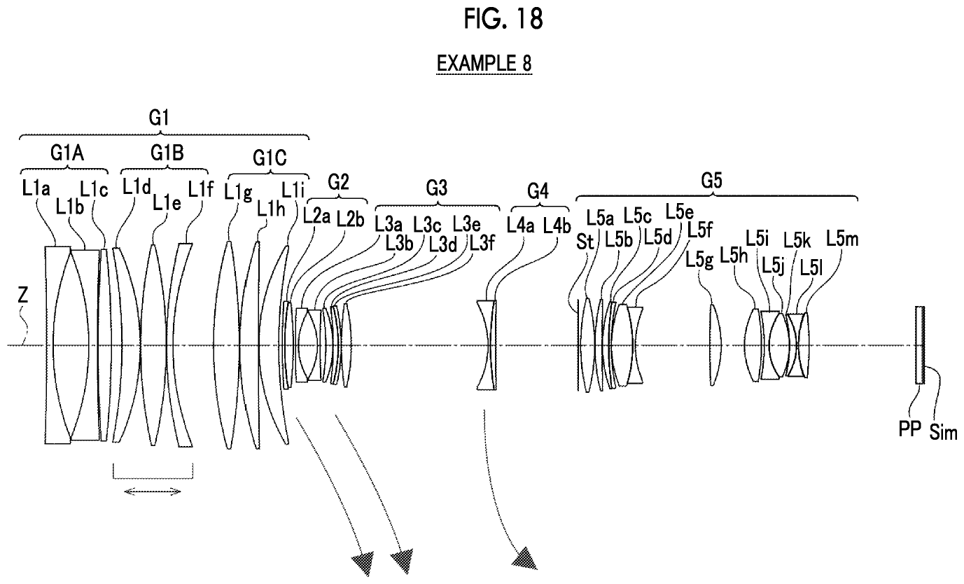

FIG. 18 shows a configuration and movement loci of the variable magnification optical system of Example 8. The variable magnification optical system in Example 8 consists of, in order from the object side to the image side, a first lens group G1 having a positive refractive power, a second lens group G2 having a positive refractive power, a third lens group G3 having a negative refractive power, a fourth lens group G4 having a negative refractive power, and a fifth lens group G5 having a positive refractive power.

During changing magnification, the first lens group G1 and the fifth lens group G5 remain stationary with respect to the image plane Sim, and the second lens group G2, the third lens group G3, and the fourth lens group G4 move along the optical axis Z by changing the spacing from the adjacent lens groups. The middle group GM consists of a second lens group G2 and a third lens group G3. The negative movable lens group GN consists of a fourth lens group G4.

The first lens group G1 consists of a first A subgroup G1A, a first B subgroup G1B, and a first C subgroup G1C in order from the object side to the image side. The focus group is the first B subgroup G1B. The first A subgroup G1A consists of three lenses L1a to L1c in order from the object side to the image side. The first B subgroup G1B consists of three lenses L1d to L1f in order from the object side to the image side. The first C subgroup G1C consists of three lenses L1g to L1i in order from the object side to the image side.

The second lens group G2 consists of two lenses L2a and L2b in order from the object side to the image side. The third lens group G3 consists of six lenses L3a to L3f in order from the object side to the image side. The fourth lens group G4 consists of two lenses L4a and L4b in order from the object side to the image side. The fifth lens group G5 consists of an aperture stop St and thirteen lenses L5a to L5m in order from the object side to the image side.

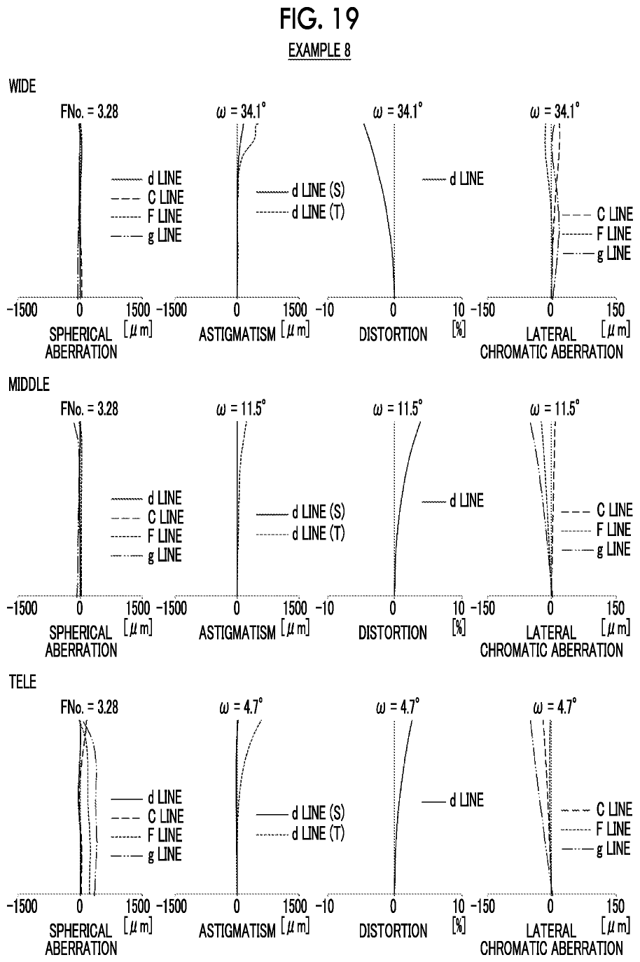

Regarding the variable magnification optical system of Example 8, Tables 22A and 22B show the basic lens data, Table 23 shows the specifications and the variable surface spacings, Table 24 shows the aspherical coefficients, and FIG. 19 shows a diagram of aberrations in a state in which the infinite distance object is in focus.

TABLE 22A
Example 8

| Sn | R | D | Nd | vd | θgF | ED | Sg |
|---|---|---|---|---|---|---|---|
| 1 | −2092.05259 | 3.900 | 1.77250 | 49.60 | 0.55212 | 120.09 | 4.23 |
| 2 | 160.85043 | 21.334 | | | | 121.00 | |
| 3 | −155.79649 | 5.199 | 1.84850 | 43.79 | 0.56197 | 113.32 | 5.08 |
| 4 | 1552.62293 | 0.350 | | | | 113.20 | |
| 5 | 907.26461 | 7.899 | 1.84666 | 23.84 | 0.62012 | 116.04 | 3.50 |
| 6 | −582.94373 | 6.432 | | | | 116.82 | |
| 7 | −312.95252 | 10.900 | 1.43875 | 94.66 | 0.53402 | 117.31 | 3.59 |
| 8 | −147.40107 | 0.200 | | | | 118.26 | |
| 9 | 292.76666 | 15.356 | 1.55032 | 75.50 | 0.54001 | 121.35 | 4.09 |
| 10 | −280.30347 | 0.200 | | | | 122.56 | |
| 11 | 262.26032 | 3.801 | 1.84666 | 23.84 | 0.62012 | 123.02 | 3.50 |
| 12 | 169.21456 | 24.288 | | | | 124.56 | |
| 13 | 246.65538 | 15.430 | 1.43875 | 94.66 | 0.53402 | 123.24 | 3.59 |
| 14 | −396.56899 | 0.200 | | | | 126.92 | |
| 15 | 212.75394 | 10.852 | 1.55032 | 75.50 | 0.54001 | 127.10 | 4.09 |
| 16 | 3020.30811 | 0.320 | | | | 126.96 | |
| 17 | 122.62116 | 11.890 | 1.55032 | 75.50 | 0.54001 | 126.55 | 4.09 |
| 18 | 300.45730 | DD[18] | | | | 121.39 | |
| 19 | 406.08762 | 1.501 | 1.84666 | 23.78 | 0.62054 | 120.25 | |
| 20 | 169.73028 | 5.081 | 1.43875 | 94.66 | 0.53402 | 51.63 | |
| 21 | −238.64231 | DD[21] | | | | 51.62 | |
| *22 | 4164.93188 | 1.701 | 1.95375 | 32.32 | 0.59015 | 45.55 | |
| 23 | 40.47955 | 11.332 | | | | 44.94 | |
| 24 | −39.65174 | 1.601 | 1.83400 | 37.16 | 0.57759 | 40.34 | |
| 25 | 397.31662 | 3.389 | | | | 40.21 | |
| 26 | −143.07299 | 4.305 | 1.78879 | 25.56 | 0.61605 | 45.44 | |
| 27 | −61.70130 | 0.121 | | | | 44.01 | |
| 28 | −186.18557 | 3.046 | 1.59270 | 35.31 | 0.59336 | 45.05 | |
| 29 | −93.10425 | 1.701 | 1.59282 | 68.62 | 0.54414 | 46.98 | |
| 30 | −111.48612 | 0.121 | | | | 46.98 | |
| 31 | 174.05349 | 5.988 | 1.78737 | 27.99 | 0.60816 | 49.47 | |
| 32 | −117.18312 | DD[32] | | | | 50.63 | |
| 33 | −53.09913 | 1.411 | 1.43875 | 94.66 | 0.53402 | 50.90 | |
| 34 | 170.35545 | 3.209 | 1.78880 | 28.43 | 0.60092 | 54.35 | |
| 35 | 2933.09642 | DD[35] | | | | 54.35 | |

TABLE 22B
Example 8

| Sn | R | D | Nd | νd | θgF | ED |
|---|---|---|---|---|---|---|
| 36(St) | ∞ | 1.600 | | | | 54.58 |
| 37 | 120.47829 | 8.424 | 1.59282 | 68.62 | 0.54414 | 55.40 |
| 38 | −117.46763 | 0.121 | | | | 57.30 |
| 39 | 115.02056 | 4.391 | 1.59976 | 46.84 | 0.56463 | 57.36 |
| 40 | 1742.87794 | 0.121 | | | | 55.71 |
| 41 | 81.11516 | 3.731 | 1.53775 | 74.70 | 0.53936 | 55.32 |
| 42 | 186.69095 | 1.500 | 1.54072 | 47.23 | 0.56511 | 52.41 |
| 43 | 123.85947 | 0.120 | | | | 52.41 |
| 44 | 68.01632 | 12.752 | 1.43700 | 95.10 | 0.53364 | 51.08 |
| 45 | −85.63704 | 1.601 | 1.88300 | 40.76 | 0.56679 | 46.57 |
| 46 | 57.54886 | 44.497 | | | | 46.56 |
| 47 | 470.88608 | 6.893 | 1.56196 | 43.38 | 0.57306 | 43.63 |
| 48 | −64.61931 | 13.569 | | | | 49.00 |
| 49 | 48.37800 | 10.108 | 1.48749 | 70.24 | 0.53007 | 45.25 |
| 50 | −132.81839 | 1.695 | | | | 44.10 |
| 51 | −109.66760 | 2.913 | 1.88300 | 40.76 | 0.56679 | 42.67 |
| 52 | 34.01968 | 12.195 | 1.52001 | 76.92 | 0.53806 | 38.46 |
| 53 | −45.97127 | 0.120 | | | | 38.46 |
| 54 | −73.95460 | 4.113 | 1.49700 | 81.54 | 0.53748 | 38.44 |
| 55 | −36.24778 | 1.101 | 1.86969 | 41.23 | 0.56776 | 37.17 |
| 56 | 59.10103 | 0.150 | | | | 37.17 |
| 57 | 52.91858 | 6.209 | 1.67270 | 32.10 | 0.59891 | 38.18 |
| 58 | −184.91465 | 63.876 | | | | 38.82 |
| 59 | ∞ | 4.100 | 1.51680 | 64.20 | | |
| 60 | ∞ | 0.984 | | | | |

TABLE 23
Example 8

| | WIDE | MIDDLE | TELE |
|---|---|---|---|
| Zr | 1.0 | 3.1 | 7.7 |
| f | 36.224 | 110.525 | 279.646 |
| Bf | 67.563 | 67.563 | 67.563 |
| FNo. | 3.28 | 3.28 | 3.28 |
| 2ω(°) | 68.2 | 23.0 | 9.4 |
| Ims | 23.4 | 23.4 | 23.4 |
| DD[18] | 2.124 | 72.163 | 100.360 |
| DD[21] | 1.401 | 8.538 | 11.734 |
| DD[32] | 81.923 | 8.986 | 20.569 |
| DD[35] | 49.106 | 44.867 | 1.890 |

TABLE 24
Example 8

| Sn | 22 |
|---|---|
| KA | 1.0000000E+00 |
| A4 | 1.4615104E−06 |
| A6 | 1.6250388E−10 |
| A8 | −5.8075217E−12 |
| A10 | 2.0908064E−14 |
| A12 | −3.0611068E−17 |
| A14 | −1.1150205E−20 |
| A16 | 8.1084157E−23 |
| A18 | −6.4259403E−26 |
| A20 | 8.6247942E−31 |

### Example 9

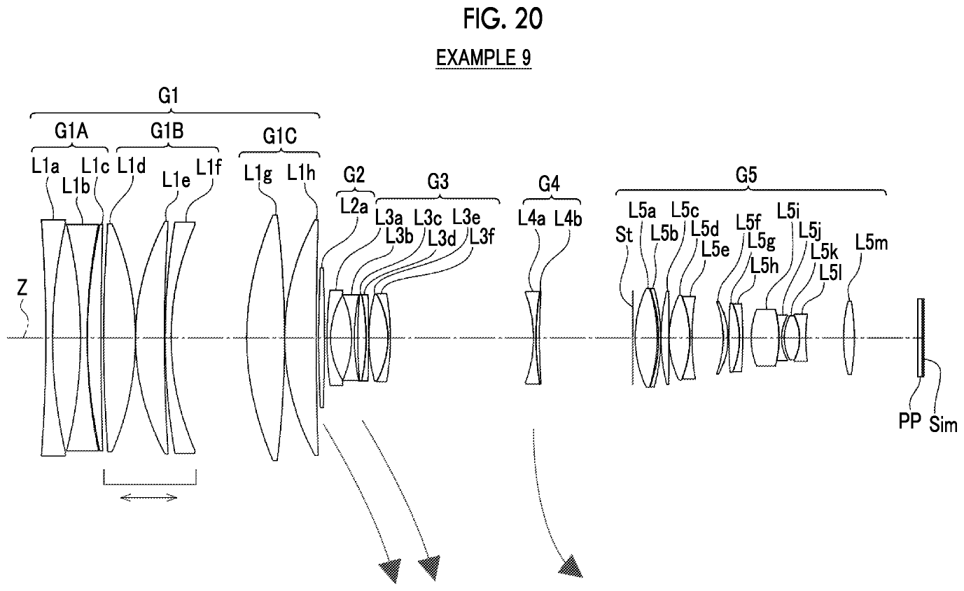

FIG. 20 shows a configuration and movement loci of the variable magnification optical system of Example 9. The variable magnification optical system in Example 9 consists of, in order from the object side to the image side, a first lens group G1 having a positive refractive power, a second lens group G2 having a positive refractive power, a third lens group G3 having a negative refractive power, a fourth lens group G4 having a negative refractive power, and a fifth lens group G5 having a positive refractive power.

During changing magnification, the first lens group G1 and the fifth lens group G5 remain stationary with respect to the image plane Sim, and the second lens group G2, the third lens group G3, and the fourth lens group G4 move along the optical axis Z by changing the spacing from the adjacent lens groups. The middle group GM consists of a second lens group G2 and a third lens group G3. The negative movable lens group GN consists of a fourth lens group G4.

The first lens group G1 consists of a first A subgroup G1A, a first B subgroup G1B, and a first C subgroup G1C in order from the object side to the image side. The focus group is the first B subgroup G1B. The first A subgroup G1A consists of three lenses L1a to L1c in order from the object side to the image side. The first B subgroup G1B consists of three lenses L1d to L1f in order from the object side to the image side. The first C subgroup G1C consists of two lenses L1g and L1h in order from the object side to the image side.

The second lens group G2 consists of one lens L2a. The third lens group G3 consists of six lenses L3a to L3f in order from the object side to the image side. The fourth lens group G4 consists of two lenses L4a and L4b in order from the object side to the image side. The fifth lens group G5 consists of an aperture stop St and thirteen lenses L5a to L5m in order from the object side to the image side.

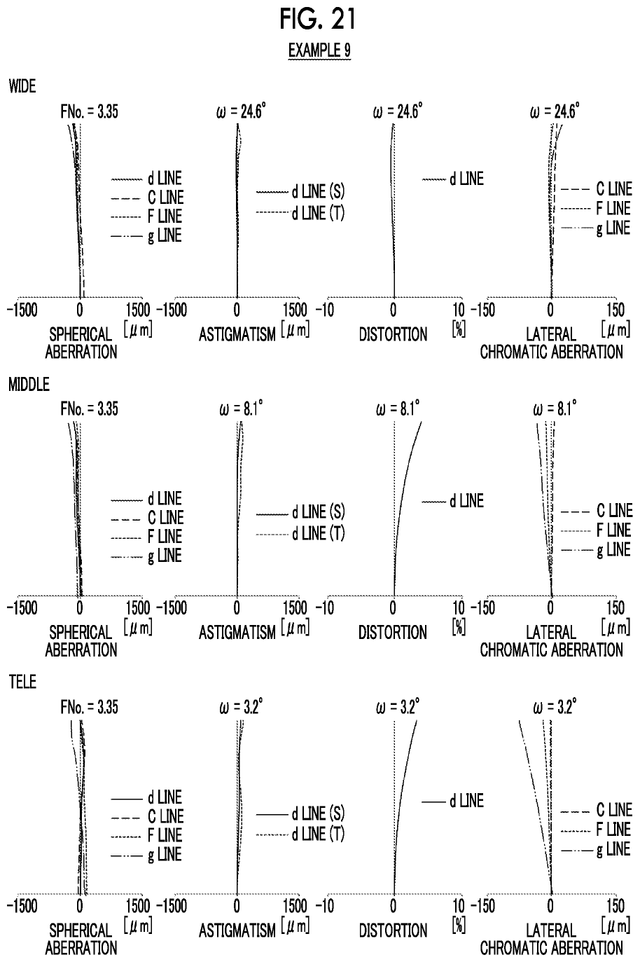

Regarding the variable magnification optical system of Example 9, Tables 25A and 25B show the basic lens data, Table 26 shows the specifications and the variable surface spacings, Table 27 shows the aspherical coefficients, and FIG. 21 shows a diagram of aberrations in a state in which the infinite distance object is in focus.

TABLE 25A
Example 9

| Sn | R | D | Nd | vd | θgF | ED | Sg |
|---|---|---|---|---|---|---|---|
| 1 | −962.21938 | 3.900 | 1.73002 | 55.00 | 0.54410 | 140.33 | 4.11 |
| 2 | 315.58160 | 16.539 | | | | 140.33 | |
| 3 | −288.09065 | 3.900 | 1.74726 | 53.27 | 0.54639 | 142.71 | 4.19 |
| 4 | 352.54236 | 0.186 | | | | 136.86 | |
| 5 | 324.26593 | 8.016 | 1.84666 | 23.83 | 0.61603 | 136.53 | 5.51 |
| 6 | 2466.25372 | 1.462 | | | | 136.37 | |
| *7 | 837.13277 | 18.781 | 1.49700 | 81.54 | 0.53748 | 136.62 | 3.62 |
| 8 | −178.63525 | 0.120 | | | | 136.64 | |
| 9 | 150.94320 | 16.882 | 1.43875 | 94.94 | 0.53433 | 138.79 | 3.62 |
| 10 | 1064.52242 | 0.530 | | | | 138.79 | |
| 11 | 429.52734 | 3.500 | 1.81008 | 26.49 | 0.61277 | 140.20 | 3.78 |
| 12 | 170.94625 | 44.185 | | | | 139.70 | |
| *13 | 172.91496 | 22.327 | 1.49700 | 81.54 | 0.53748 | 138.99 | 3.62 |
| 14 | −628.30923 | 0.120 | | | | 136.04 | |
| 15 | 150.73545 | 18.472 | 1.43875 | 94.94 | 0.53433 | 146.17 | 3.62 |
| 16 | 2072.41802 | DD[16] | | | | 146.17 | |
| 17 | 802.92340 | 3.471 | 1.49700 | 81.64 | 0.53714 | 141.39 | |
| 18 | −1226.87707 | DD[18] | | | | 140.36 | |
| *19 | 278.34652 | 2.000 | 1.85740 | 42.24 | 0.56561 | 84.25 | |
| 20 | 49.53050 | 12.435 | | | | 83.43 | |
| 21 | −64.14608 | 1.600 | 1.59282 | 68.62 | 0.54414 | 57.21 | |
| 22 | 129.74193 | 2.095 | | | | 51.15 | |
| 23 | 391.38931 | 4.792 | 1.85581 | 26.69 | 0.61103 | 51.15 | |
| 24 | −130.13512 | 1.510 | 1.59282 | 68.62 | 0.54414 | 51.53 | |
| 25 | −1020.94831 | 0.120 | | | | 51.66 | |
| 26 | 103.99598 | 11.249 | 1.61800 | 40.25 | 0.57772 | 51.66 | |
| 27 | −54.90794 | 1.500 | 1.90043 | 37.37 | 0.57720 | 51.97 | |
| 28 | −155.03440 | DD[28] | | | | 51.93 | |
| 29 | −79.75372 | 1.510 | 1.49700 | 81.54 | 0.53748 | 51.93 | |
| 30 | 172.02166 | 2.079 | 1.80518 | 25.42 | 0.61616 | 53.41 | |
| 31 | 437.12766 | DD[31] | | | | 55.49 | |

TABLE 25B
Example 9

| Sn | R | D | Nd | vd | θgF | ED |
|---|---|---|---|---|---|---|
| 32(St) | ∞ | 1.501 | | | | 55.49 |
| 33 | 71.39200 | 12.932 | 1.58710 | 51.23 | 0.55623 | 55.60 |
| 34 | −99.18397 | 0.849 | | | | 56.50 |
| 35 | −90.07259 | 1.229 | 1.92673 | 28.97 | 0.60175 | 59.52 |
| 36 | −115.21321 | 0.151 | | | | 59.31 |
| 37 | 116.89128 | 4.701 | 1.65804 | 57.70 | 0.54334 | 59.06 |
| 38 | −3477.55393 | 0.125 | | | | 59.18 |
| 39 | 59.89228 | 12.140 | 1.43875 | 94.94 | 0.53433 | 56.11 |
| 40 | −68.90697 | 1.300 | 2.00069 | 25.46 | 0.61364 | 50.93 |
| 41 | 157.05155 | 18.277 | | | | 49.38 |
| 42 | −65.25901 | 2.560 | 1.51984 | 53.16 | 0.55508 | 49.37 |
| 43 | −48.30770 | 0.598 | | | | 47.04 |
| 44 | 356.25689 | 6.211 | 1.90960 | 20.15 | 0.64151 | 43.14 |
| 45 | −55.10284 | 1.888 | 1.84384 | 42.71 | 0.56487 | 41.06 |
| 46 | −339.60147 | 4.982 | | | | 40.64 |
| 47 | 46.28311 | 16.434 | 1.43875 | 94.94 | 0.53433 | 40.64 |
| 48 | −66.86895 | 1.482 | 1.92463 | 35.50 | 0.58188 | 33.90 |
| 49 | 26.34668 | 1.635 | | | | 27.33 |
| 50 | 29.29295 | 9.072 | 1.43875 | 94.94 | 0.53433 | 27.33 |
| 51 | −28.61407 | 3.565 | 1.74812 | 53.19 | 0.54651 | 26.23 |
| 52 | 98.63170 | 22.285 | | | | 26.25 |
| 53 | 92.40038 | 6.308 | 1.69253 | 48.70 | 0.55724 | 26.25 |
| 54 | −142.65532 | 37.374 | | | | 28.02 |
| 55 | ∞ | 2.650 | 1.51633 | 64.14 | | |
| 56 | ∞ | 0.980 | | | | |

TABLE 26
Example 9

| | WIDE | MIDDLE | TELE |
|---|---|---|---|
| Zr | 1.0 | 3.1 | 7.8 |
| f | 51.230 | 157.277 | 399.597 |
| Bf | 40.102 | 40.102 | 40.102 |
| FNo. | 3.35 | 3.35 | 3.35 |
| 2ω(°) | 49.2 | 16.2 | 6.4 |
| Ims | 23.4 | 23.4 | 23.4 |
| DD[16] | 1.507 | 55.813 | 79.262 |
| DD[18] | 1.536 | 27.189 | 38.088 |
| DD[28] | 84.272 | 6.782 | 21.789 |
| DD[31] | 54.897 | 52.427 | 3.072 |

TABLE 27
Example 9

| Sn | 7 | 13 | 19 |
|---|---|---|---|
| KA | 1.0000000E+00 | 1.0000000E+00 | 1.0000000E+00 |
| A4 | −1.9790294E−08 | −3.4219015E−08 | 3.6836568E−07 |
| A6 | 1.0005871E−11 | −5.2248275E−12 | −2.8884327E−10 |
| A8 | −1.1960525E−14 | 4.8142497E−15 | 1.2636902E−12 |
| A10 | 8.7194764E−18 | −3.1759469E−18 | −1.6301333E−15 |
| A12 | −3.9978648E−21 | 1.2884412E−21 | −7.5500614E−18 |
| A14 | 1.1587458E−24 | −3.2543866E−25 | 3.4863792E−20 |
| A16 | −2.0608339E−28 | 4.9870449E−29 | −6.0583776E−23 |
| A18 | 2.0513816E−32 | −4.2440131E−33 | 5.0076896E−26 |
| A20 | −8.7423556E−37 | 1.5381501E−37 | −1.6309040E−29 |

### Example 10

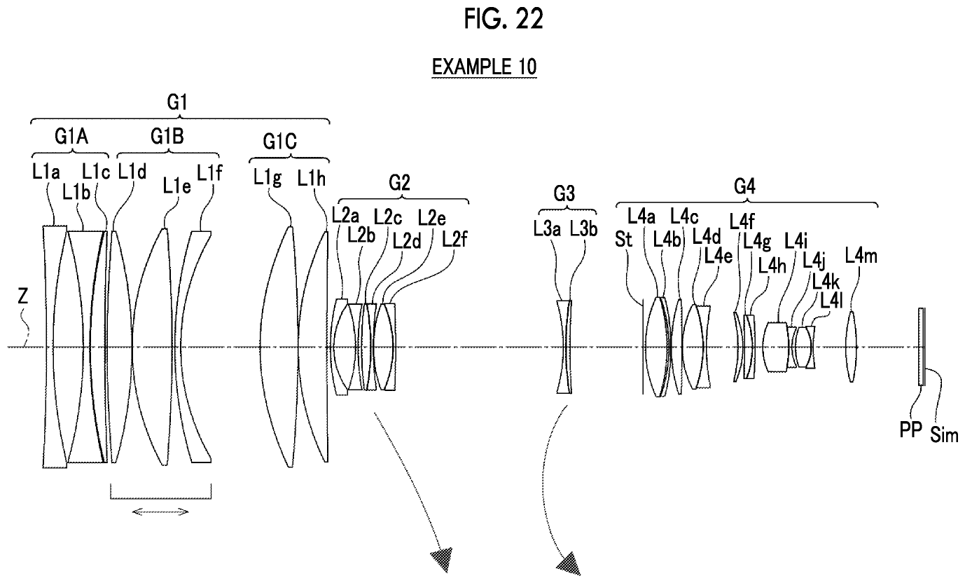

FIG. 22 shows a configuration and movement loci of the variable magnification optical system of Example 10. The variable magnification optical system of Example 10 consists of, in order from the object side to the image side, a first lens group G1 having a positive refractive power, a second lens group G2 having a negative refractive power, a third lens group G3 having a negative refractive power, and a fourth lens group G4 having a positive refractive power.

During changing magnification, the first lens group G1 and the fourth lens group G4 remain stationary with respect to the image plane Sim, and the second lens group G2 and the third lens group G3 move along the optical axis Z by changing the spacing from the adjacent lens groups. The middle group GM consists of a second lens group G2. The negative movable lens group GN consists of a third lens group G3.

The first lens group G1 consists of a first A subgroup G1A, a first B subgroup G1B, and a first C subgroup G1C in order from the object side to the image side. The focus group is the first B subgroup G1B. The first A subgroup G1A consists of three lenses L1a to L1c in order from the object side to the image side. The first B subgroup G1B consists of three lenses L1d to L1f in order from the object side to the image side. The first C subgroup G1C consists of two lenses L1g and L1h in order from the object side to the image side.

The second lens group G2 consists of six lenses L2a to L2f in order from the object side to the image side. The third lens group G3 consists of two lenses L3a and L3b in order from the object side to the image side. The fourth lens group G4 consists of an aperture stop St and thirteen lenses L4a to L4m in order from the object side to the image side.

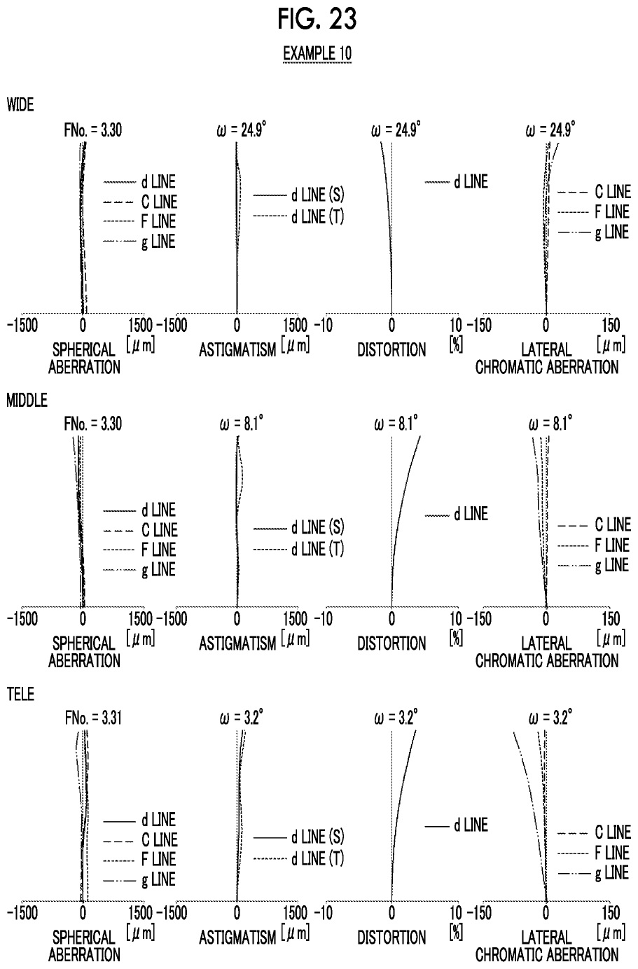

Regarding the variable magnification optical system of Example 10, Tables 28A and 28B show the basic lens data, Table 29 shows the specifications and the variable surface spacings, Table 30 shows the aspherical coefficients, and FIG. 23 shows a diagram of aberrations in a state in which the infinite distance object is in focus.

TABLE 28A
Example 10

| Sn | R | D | Nd | vd | θgF | ED | Sg |
|---|---|---|---|---|---|---|---|
| 1 | −1285.31483 | 3.900 | 1.72599 | 54.86 | 0.54440 | 147.92 | 4.11 |
| 2 | 313.65366 | 18.040 | | | | 141.64 | |
| 3 | −275.97010 | 3.900 | 1.71674 | 55.66 | 0.54379 | 141.32 | 4.07 |
| 4 | 315.74766 | 0.266 | | | | 140.97 | |
| 5 | 300.40423 | 8.679 | 1.84666 | 23.83 | 0.61603 | 141.19 | 5.51 |
| 6 | 1820.42445 | 1.401 | | | | 141.09 | |
| *7 | 793.39232 | 14.778 | 1.49700 | 81.54 | 0.53748 | 140.77 | 3.62 |
| 8 | −263.29676 | 0.120 | | | | 141.35 | |
| 9 | 154.82343 | 23.841 | 1.43875 | 94.94 | 0.53433 | 144.52 | 3.62 |
| 10 | −875.82123 | 1.658 | | | | 143.83 | |
| 11 | 253.71181 | 3.500 | 1.80518 | 25.42 | 0.61616 | 140.69 | 3.37 |
| 12 | 137.79690 | 47.003 | | | | 136.35 | |
| *13 | 158.00303 | 22.626 | 1.49700 | 81.54 | 0.53748 | 146.68 | 3.62 |
| 14 | −829.82676 | 0.120 | | | | 146.29 | |
| 15 | 163.9556 | 17.1218 | 1.43875 | 94.94 | 0.53433 | 140.25 | 3.62 |
| 16 | 3967.1934 | DD[16] | | | | 139.26 | |
| *17 | 119.0258 | 2.0000 | 2.00100 | 29.13 | 0.59952 | 58.20 | |
| 18 | 45.7411 | 12.9117 | | | | 52.41 | |
| 19 | −82.9613 | 1.6000 | 1.59282 | 68.62 | 0.54414 | 52.22 | |
| 20 | 148.5453 | 2.0949 | | | | 52.19 | |
| 21 | 209.3014 | 5.4597 | 1.88311 | 25.04 | 0.61745 | 52.49 | |
| 22 | −149.6083 | 1.5100 | 1.59282 | 68.62 | 0.54414 | 52.47 | |
| 23 | 184.6792 | 0.1390 | | | | 52.04 | |
| 24 | 78.7031 | 11.6627 | 1.64484 | 34.48 | 0.59250 | 52.17 | |
| 25 | −66.8732 | 1.5000 | 1.90043 | 37.37 | 0.57720 | 52.03 | |
| 26 | −836.9307 | DD[26] | | | | 52.54 | |
| 27 | −99.8606 | 1.5100 | 1.49700 | 81.54 | 0.53748 | 54.49 | |
| 28 | 192.2612 | 2.4635 | 1.80518 | 25.42 | 0.61616 | 56.34 | |
| 29 | 474.0611 | DD[29] | | | | 56.54 | |

TABLE 28B
Example 10

| Sn | R | D | Nd | vd | θgF | ED |
|---|---|---|---|---|---|---|
| 30(St) | ∞ | 1.5000 | | | | 57.53 |
| 31 | 75.6891 | 12.8861 | 1.59711 | 50.80 | 0.55667 | 60.53 |
| 32 | −105.8650 | 1.1448 | | | | 60.32 |
| 33 | −91.7619 | 1.2000 | 1.90973 | 30.30 | 0.59791 | 60.05 |
| 34 | −123.6900 | 0.1200 | | | | 60.22 |
| 35 | 94.3730 | 6.3113 | 1.61532 | 61.62 | 0.54313 | 57.34 |
| 36 | −1789.2338 | 0.2981 | | | | 56.60 |
| 37 | 56.6857 | 12.3733 | 1.43875 | 94.94 | 0.53433 | 51.32 |
| 38 | −77.4296 | 1.9819 | 1.97999 | 27.01 | 0.60670 | 49.45 |
| 39 | 123.8422 | 18.4875 | | | | 46.43 |
| 40 | −89.2534 | 2.9893 | 1.54029 | 47.94 | 0.56458 | 41.56 |
| 41 | −53.8350 | 0.9997 | | | | 41.49 |
| 42 | −592.7430 | 4.6568 | 1.91135 | 19.74 | 0.64405 | 38.63 |
| 43 | −55.1196 | 1.6563 | 1.83200 | 44.80 | 0.56072 | 38.22 |
| 44 | −211.6326 | 4.5019 | | | | 36.88 |
| 45 | 36.3298 | 15.5093 | 1.43875 | 94.94 | 0.53433 | 30.23 |
| 46 | −75.4122 | 1.9144 | 1.93410 | 34.47 | 0.58454 | 24.65 |
| 47 | 26.8763 | 2.0991 | | | | 23.18 |
| 48 | 36.8052 | 9.4574 | 1.43875 | 94.94 | 0.53433 | 23.85 |
| 49 | −24.7718 | 1.1999 | 1.77527 | 50.47 | 0.55041 | 24.24 |
| 50 | 90.5612 | 19.3814 | | | | 25.71 |
| 51 | 83.2129 | 6.4045 | 1.66527 | 37.39 | 0.58362 | 42.28 |
| 52 | −107.8393 | 37.1424 | | | | 42.60 |
| 53 | ∞ | 2.6500 | 1.51633 | 64.14 | 0.53531 | |
| 54 | ∞ | 0.988 | | | | |

TABLE 29
Example 10

| | WIDE | MIDDLE | TELE |
|---|---|---|---|
| Zr | 1.0 | 3.1 | 7.8 |
| f | 51.261 | 157.370 | 399.833 |
| Bf | 39.878 | 39.878 | 39.878 |
| FNo. | 3.30 | 3.30 | 3.32 |
| 2ω(°) | 49.8 | 16.2 | 6.4 |
| Ims | 23.4 | 23.4 | 23.4 |
| DD[16] | 2.110 | 84.158 | 119.769 |
| DD[26] | 100.134 | 10.502 | 23.487 |
| DD[29] | 43.519 | 51.103 | 2.507 |

TABLE 30
Example 10

| Sn | 7 | 13 | 17 |
|---|---|---|---|
| KA | 1.0000000E+00 | 1.0000000E+00 | 1.0000000E+00 |
| A4 | −1.4424937E−08 | −3.4710407E−08 | 5.0925308E−08 |
| A6 | 8.6511285E−12 | −6.6213150E−12 | 3.1434924E−10 |
| A8 | −7.2090216E−15 | 3.5648677E−15 | −2.8030268E−12 |
| A10 | 3.5595347E−18 | −1.3121584E−18 | 1.2069904E−14 |
| A12 | −1.2289455E−21 | 3.1219440E−22 | −2.9274324E−17 |
| A14 | 2.9490477E−25 | −5.2285338E−26 | 4.1079045E−20 |
| A16 | −4.6599178E−29 | 6.4473853E−30 | −3.1855847E−23 |
| A18 | 4.3155201E−33 | −5.4624566E−34 | 1.1717531E−26 |
| A20 | −1.7586609E−37 | 2.2752502E−38 | −1.2320305E−30 |

### Example 11

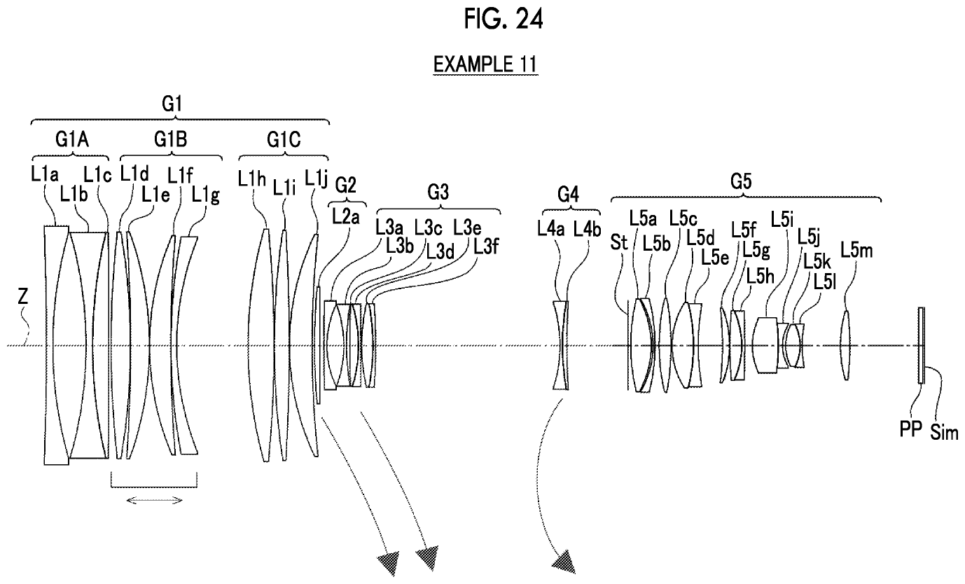

FIG. 24 shows a configuration and movement loci of the variable magnification optical system of Example 11. The variable magnification optical system in Example 11 consists of, in order from the object side to the image side, a first lens group G1 having a positive refractive power, a second lens group G2 having a positive refractive power, a third lens group G3 having a negative refractive power, a fourth lens group G4 having a negative refractive power, and a fifth lens group G5 having a positive refractive power.

During changing magnification, the first lens group G1 and the fifth lens group G5 remain stationary with respect to the image plane Sim, and the second lens group G2, the third lens group G3, and the fourth lens group G4 move along the optical axis Z by changing the spacing from the adjacent lens groups. The middle group GM consists of a second lens group G2 and a third lens group G3. The negative movable lens group GN consists of a fourth lens group G4.

The first lens group G1 consists of a first A subgroup G1A, a first B subgroup G1B, and a first C subgroup G1C in order from the object side to the image side. The focus group is the first B subgroup G1B. The first A subgroup G1A consists of three lenses L1a to L1c in order from the object side to the image side. The first B subgroup G1B consists of four lenses L1d to L1g in order from the object side to the image side. The first C subgroup G1C consists of three lenses L1h to L1j in order from the object side to the image side.

The second lens group G2 consists of one lens L2a. The third lens group G3 consists of six lenses L3a to L3f in order from the object side to the image side. The fourth lens group G4 consists of two lenses L4a and L4b in order from the object side to the image side. The fifth lens group G5 consists of an aperture stop St and thirteen lenses L5a to L5m in order from the object side to the image side.

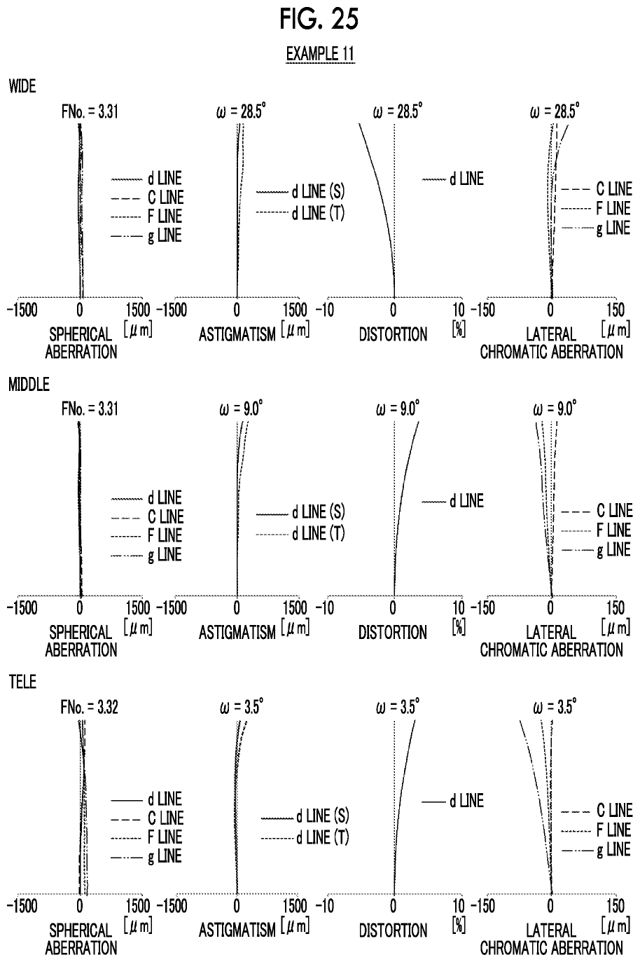

Regarding the variable magnification optical system of Example 11, Tables 31A and 31B show the basic lens data, Table 32 shows the specifications and the variable surface spacings, Table 33 shows the aspherical coefficients, and FIG. 25 shows a diagram of aberrations in a state in which the infinite distance object is in focus.

TABLE 31A
Example 11

| Sn | R | D | Nd | vd | θgF | ED | Sg |
|---|---|---|---|---|---|---|---|
| 1 | −2058.83443 | 3.900 | 1.80493 | 47.51 | 0.55567 | 148.60 | 4.50 |
| 2 | 261.15350 | 20.223 | | | | 141.07 | |
| 3 | −258.28392 | 3.900 | 1.72974 | 54.95 | 0.54417 | 140.72 | 4.11 |
| 4 | 307.11074 | 0.120 | | | | 140.55 | |
| 5 | 306.57986 | 9.760 | 1.84666 | 23.83 | 0.61603 | 140.62 | 5.51 |
| 6 | −15563.10980 | 1.351 | | | | 140.66 | |
| *7 | 589.56688 | 11.839 | 1.49700 | 81.54 | 0.53748 | 140.95 | 3.62 |
| 8 | −429.82512 | 0.120 | | | | 141.28 | |
| 9 | −1015.59539 | 11.428 | 1.43875 | 94.94 | 0.53433 | 141.47 | 3.62 |
| 10 | −212.86658 | 0.120 | | | | 141.62 | |
| 11 | 178.11518 | 12.876 | 1.43875 | 94.94 | 0.53433 | 136.58 | 3.62 |
| 12 | 845.26883 | 0.120 | | | | 135.85 | |
| 13 | 372.60266 | 3.500 | 1.84666 | 23.78 | 0.62054 | 135.54 | 3.54 |
| 14 | 181.63962 | 42.962 | | | | 133.40 | |
| 15 | 271.9276 | 15.8409 | 1.49700 | 81.54 | 0.53748 | 144.46 | 3.62 |
| 16 | −765.7310 | 0.1200 | | | | 144.45 | |
| 17 | 499.0874 | 9.1667 | 1.43875 | 94.94 | 0.53433 | 143.58 | 3.62 |
| 18 | −1178.2326 | 0.1201 | | | | 143.30 | |
| 19 | 163.8672 | 13.6622 | 1.49700 | 81.54 | 0.53748 | 138.31 | 3.62 |
| 20 | 662.8697 | DD[20] | | | | 137.37 | |
| *21 | 455.9303 | 3.2457 | 1.49700 | 81.64 | 0.53714 | 72.49 | |
| 22 | 48096.9278 | DD[22] | | | | 71.64 | |
| *23 | 1244.1367 | 1.8000 | 2.00100 | 29.13 | 0.59952 | 54.96 | |
| 24 | 59.9336 | 10.2626 | | | | 50.40 | |
| 25 | −73.4695 | 1.6000 | 1.59282 | 68.62 | 0.54414 | 50.30 | |
| 26 | 143.6538 | 2.0949 | | | | 50.66 | |
| 27 | 724.5225 | 5.1917 | 1.71098 | 29.45 | 0.60519 | 50.75 | |
| 28 | −90.1793 | 1.5100 | 1.55032 | 75.50 | 0.54001 | 50.90 | |
| 29 | −4756.1962 | 0.4245 | | | | 51.37 | |
| 30 | 113.7660 | 6.9043 | 1.69988 | 30.01 | 0.60390 | 51.85 | |
| 31 | −135.5507 | 1.5000 | 1.70240 | 43.96 | 0.56702 | 51.86 | |
| 32 | −432.9800 | DD[32] | | | | 51.89 | |
| 33 | −89.4335 | 1.5100 | 1.49700 | 81.54 | 0.53748 | 52.56 | |
| 34 | 155.1968 | 2.5931 | 1.80518 | 25.42 | 0.61616 | 54.57 | |
| 35 | 358.0595 | DD[35] | | | | 54.75 | |

TABLE 31B
Example 11

| Sn | R | D | Nd | νd | θgF | ED |
|---|---|---|---|---|---|---|
| 36(St) | ∞ | 1.5000 | | | | 55.47 |
| 37 | 122.4770 | 12.5054 | 1.59222 | 45.62 | 0.56738 | 57.44 |
| 38 | −60.7844 | 1.0793 | | | | 57.55 |
| 39 | −58.1163 | 1.1999 | 1.86125 | 40.98 | 0.56863 | 57.03 |
| 40 | −119.5327 | 2.5000 | | | | 58.19 |
| 41 | 127.1840 | 7.2396 | 1.52227 | 75.97 | 0.53783 | 58.13 |
| 42 | −172.5256 | 0.6901 | | | | 57.90 |
| 43 | 50.6231 | 12.9515 | 1.43875 | 94.94 | 0.53433 | 53.17 |
| 44 | −107.4967 | 2.8968 | 2.00069 | 25.46 | 0.61364 | 51.65 |
| 45 | 144.8824 | 14.7914 | | | | 49.16 |
| 46 | −182.9085 | 3.8422 | 1.57281 | 42.52 | 0.57447 | 46.19 |
| 47 | −69.1159 | 0.2905 | | | | 46.11 |
| 48 | 270.9285 | 7.1204 | 1.80518 | 25.43 | 0.61027 | 43.32 |
| 49 | −53.6462 | 1.8391 | 1.79845 | 47.43 | 0.55609 | 42.64 |
| 50 | −925.1673 | 4.7081 | | | | 40.40 |
| 51 | 41.3191 | 15.6609 | 1.43875 | 94.94 | 0.53433 | 34.09 |
| 52 | −154.2579 | 2.5887 | 1.88041 | 39.54 | 0.57177 | 27.91 |
| 53 | 25.5242 | 1.9214 | | | | 25.56 |
| 54 | 29.39680 | 8.842 | 1.43875 | 94.94 | 0.53433 | 26.20 |
| 55 | −30.12441 | 1.200 | 1.78953 | 46.15 | 0.55928 | 26.09 |
| 56 | 71.62301 | 23.253 | | | | 26.93 |
| 57 | 76.34531 | 5.738 | 1.61181 | 41.26 | 0.57581 | 42.40 |
| 58 | −188.47804 | 41.796 | | | | 42.60 |
| 59 | ∞ | 2.650 | 1.51633 | 64.14 | | |
| 60 | ∞ | 0.991 | | | | |

TABLE 32
Example 11

| | WIDE | MIDDLE | TELE |
|---|---|---|---|
| Zr | 1.0 | 3.1 | 8.2 |
| f | 45.517 | 142.925 | 370.968 |
| Bf | 44.535 | 44.535 | 44.535 |
| FNo. | 3.31 | 3.31 | 3.32 |
| 2ω(°) | 57.0 | 18.0 | 7.0 |
| Ims | 23.4 | 23.4 | 23.4 |
| DD[20] | 1.563 | 69.044 | 103.774 |
| DD[22] | 2.464 | 26.030 | 33.146 |
| DD[32] | 112.139 | 14.697 | 14.368 |
| DD[35] | 37.397 | 43.793 | 2.275 |

TABLE 33
Example 11

| Sn | 7 | 21 | 23 |
|---|---|---|---|
| KA | 1.0000000E+00 | 1.0000000E+00 | 1.0000000E+00 |
| A4 | −1.9129049E−08 | 3.7325949E−08 | −4.0674003E−08 |
| A6 | −7.4602781E−13 | −9.5183284E−11 | 5.3090567E−10 |
| A8 | 1.5600772E−15 | 2.6163401E−13 | −3.1705419E−12 |
| A10 | −1.1407900E−18 | −5.4284140E−16 | 1.1326971E−14 |
| A12 | 5.0864661E−22 | 7.6574840E−19 | −2.5425680E−17 |
| A14 | −1.4463727E−25 | −6.9712703E−22 | 3.5106929E−20 |
| A16 | 2.5577733E−29 | 3.8828941E−25 | −2.8307328E−23 |
| A18 | −2.5524545E−33 | −1.1974725E−28 | 1.1734240E−26 |
| A20 | 1.0916617E−37 | 1.5586811E−32 | −1.7515774E−30 |

### Example 12

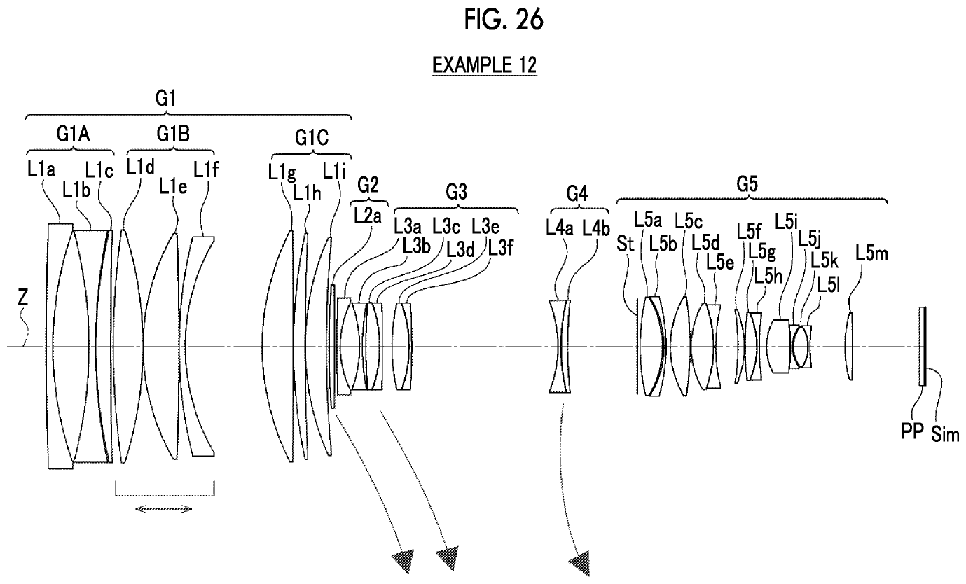

FIG. 26 shows a configuration and movement loci of the variable magnification optical system of Example 12. The variable magnification optical system in Example 12 consists of, in order from the object side to the image side, a first lens group G1 having a positive refractive power, a second lens group G2 having a positive refractive power, a third lens group G3 having a negative refractive power, a fourth lens group G4 having a negative refractive power, and a fifth lens group G5 having a positive refractive power.

During changing magnification, the first lens group G1 and the fifth lens group G5 remain stationary with respect to the image plane Sim, and the second lens group G2, the third lens group G3, and the fourth lens group G4 move along the optical axis Z by changing the spacing from the adjacent lens groups. The middle group GM consists of a second lens group G2 and a third lens group G3. The negative movable lens group GN consists of a fourth lens group G4.

The first lens group G1 consists of a first A subgroup G1A, a first B subgroup G1B, and a first C subgroup G1C in order from the object side to the image side. The focus group is the first B subgroup G1B. The first A subgroup G1A consists of three lenses L1a to L1c in order from the object side to the image side. The first B subgroup G1B consists of three lenses L1d to L1f in order from the object side to the image side. The first C subgroup G1C consists of three lenses L1g to L1i in order from the object side to the image side.

The second lens group G2 consists of one lens L2a. The third lens group G3 consists of six lenses L3a to L3f in order from the object side to the image side. The fourth lens group G4 consists of two lenses L4a and L4b in order from the object side to the image side. The fifth lens group G5 consists of an aperture stop St and thirteen lenses L5a to L5m in order from the object side to the image side.

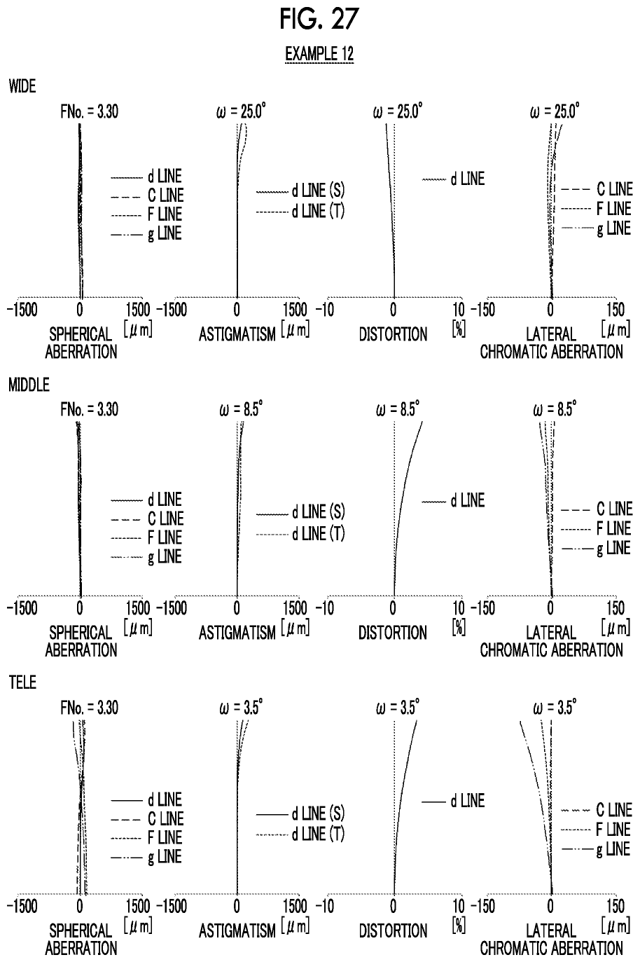

Regarding the variable magnification optical system of Example 12, Tables 34A and 34B show the basic lens data, Table 35 shows the specifications and the variable surface spacings, Table 36 shows the aspherical coefficients, and FIG. 27 shows a diagram of aberrations in a state in which the infinite distance object is in focus.

TABLE 34A
Example 12

| Sn | R | D | Nd | vd | θgF | ED | Sg |
|---|---|---|---|---|---|---|---|
| 1 | 2180.90852 | 3.900 | 1.74393 | 53.61 | 0.54591 | 147.03 | 4.17 |
| 2 | 214.98435 | 21.162 | | | | 139.48 | |
| 3 | −272.10755 | 3.900 | 1.73229 | 54.77 | 0.54428 | 139.28 | 4.12 |
| 4 | 349.53428 | 0.120 | | | | 139.19 | |
| 5 | 316.12676 | 8.614 | 1.84666 | 23.83 | 0.61603 | 139.46 | 5.51 |
| 6 | 2677.43692 | 1.452 | | | | 139.38 | |
| *7 | 454.27466 | 17.477 | 1.49700 | 81.54 | 0.53748 | 139.46 | 3.62 |
| 8 | −234.54919 | 0.120 | | | | 139.68 | |
| 9 | 138.56004 | 20.952 | 1.43875 | 94.94 | 0.53433 | 135.71 | 3.62 |
| 10 | −2126.25082 | 0.120 | | | | 134.81 | |
| 11 | 276.15823 | 3.500 | 1.81766 | 28.38 | 0.60618 | 131.68 | 3.95 |
| 12 | 128.21434 | 44.783 | | | | 127.06 | |
| *13 | 151.99613 | 18.208 | 1.49700 | 81.54 | 0.53748 | 137.60 | 3.62 |
| 14 | −7291.32432 | 0.120 | | | | 137.29 | |
| 15 | 343.7853 | 6.8204 | 1.43875 | 94.94 | 0.53433 | 135.56 | 3.62 |
| 16 | 1439.7786 | 0.1201 | | | | 135.07 | |
| 17 | 165.5541 | 12.3522 | 1.49700 | 81.54 | 0.53748 | 130.56 | 3.62 |
| 18 | 721.6286 | DD[18] | | | | 129.17 | |
| 19 | 477.6475 | 3.2330 | 1.49700 | 81.64 | 0.53714 | 74.21 | |
| 20 | −3861.9068 | DD[20] | | | | 73.02 | |
| *21 | 2510.5174 | 1.8000 | 1.90043 | 37.37 | 0.57668 | 57.70 | |
| 22 | 59.6083 | 11.4374 | | | | 52.32 | |
| 23 | −75.7451 | 1.6000 | 1.59282 | 68.62 | 0.54414 | 51.92 | |
| 24 | 133.3992 | 2.0949 | | | | 51.79 | |
| 25 | 386.8067 | 8.0737 | 1.72138 | 29.54 | 0.60467 | 51.89 | |
| 26 | −76.5498 | 1.5100 | 1.54163 | 73.60 | 0.53926 | 52.06 | |
| 27 | −932.9580 | 5.6455 | | | | 52.01 | |
| 28 | 118.8044 | 10.0239 | 1.58964 | 39.12 | 0.58091 | 51.63 | |
| 29 | −77.9414 | 1.5000 | 1.76950 | 39.14 | 0.57591 | 51.56 | |
| 30 | −449.0878 | DD[30] | | | | 51.94 | |
| 31 | −75.9829 | 1.8100 | 1.49700 | 81.54 | 0.53748 | 52.51 | |
| 32 | 121.2417 | 3.8525 | 1.80518 | 25.42 | 0.61616 | 55.09 | |
| 33 | 261.8105 | DD[33] | | | | 55.39 | |

TABLE 34B
Example 12

| Sn | R | D | Nd | νd | θgF | ED |
|---|---|---|---|---|---|---|
| 34(St) | ∞ | 1.5000 | | | | 56.37 |
| 35 | 131.2135 | 13.1539 | 1.59338 | 48.10 | 0.56227 | 58.44 |
| 36 | −57.8310 | 0.9415 | | | | 58.61 |
| 37 | −55.4837 | 1.2000 | 1.81820 | 43.53 | 0.56396 | 58.18 |
| 38 | −109.4473 | 2.5000 | | | | 59.48 |
| 39 | 60.1599 | 11.5036 | 1.49700 | 81.64 | 0.53714 | 59.28 |
| 40 | −193.0423 | 0.6262 | | | | 58.74 |
| 41 | 52.3573 | 13.0886 | 1.43875 | 94.94 | 0.53433 | 51.40 |
| 42 | −77.0480 | 1.4463 | 2.00069 | 25.46 | 0.61364 | 49.42 |
| 43 | 111.3966 | 12.5518 | | | | 46.56 |
| 44 | −139.0009 | 3.7132 | 1.71263 | 29.51 | 0.60498 | 44.14 |
| 45 | −61.0088 | 0.3702 | | | | 44.15 |
| 46 | 153.7009 | 6.9885 | 1.80518 | 25.43 | 0.61027 | 40.68 |
| 47 | −50.1284 | 1.3914 | 1.72653 | 55.17 | 0.54401 | 40.03 |
| 48 | 144.0527 | 4.2720 | | | | 36.56 |
| 49 | 34.8003 | 13.9019 | 1.43875 | 94.94 | 0.53433 | 31.69 |
| 50 | −132.1199 | 1.2000 | 1.89345 | 38.66 | 0.57385 | 26.07 |
| 51 | 19.9114 | 0.6411 | | | | 23.80 |
| 52 | 20.7417 | 8.5662 | 1.43875 | 94.94 | 0.53433 | 24.19 |
| 53 | −23.8276 | 1.2000 | 1.82410 | 45.59 | 0.55927 | 24.12 |
| 54 | 129.40711 | 20.382 | | | | 25.16 |
| 55 | 76.27008 | 4.475 | 1.71503 | 29.29 | 0.60562 | 39.46 |
| 56 | −459.85567 | 39.236 | | | | 39.64 |
| 57 | ∞ | 2.650 | 1.51633 | 64.14 | 0.53531 | |
| 58 | ∞ | 0.983 | | | | |

TABLE 35
Example 12

| | WIDE | MIDDLE | TELE |
|---|---|---|---|
| Zr | 1.0 | 3.0 | 7.3 |
| f | 50.714 | 150.114 | 371.735 |
| Bf | 41.967 | 41.967 | 41.967 |
| FNo. | 3.30 | 3.30 | 3.30 |
| 2ω(°) | 50.0 | 17.0 | 7.0 |
| Ims | 23.4 | 23.4 | 23.4 |
| DD[18] | 1.516 | 49.475 | 80.669 |
| DD[20] | 1.501 | 25.319 | 27.399 |
| DD[30] | 85.653 | 15.916 | 18.093 |
| DD[33] | 40.920 | 38.881 | 3.428 |

TABLE 36
Example 12

| Sn | 7 | 13 | 21 |
|---|---|---|---|
| KA | 1.0000000E+00 | 1.0000000E4+00 | 1.0000000E+00 |
| A4 | −2.1744660E−08 | −1.9625182E−08 | 2.0840144E−07 |
| A6 | 1.1024212E−12 | −1.3810261E−12 | −9.3840881E−11 |
| A8 | −6.8770552E−16 | 4.2207417E−17 | 1.0281018E−12 |
| A10 | 2.1567459E−19 | 6.0418586E−22 | −6.1899286E−15 |
| A12 | −1.1932753E−23 | 7.0118444E−24 | 2.0745645E−17 |
| A14 | −1.6602296E−26 | −8.5120576E−27 | −4.1481301E−20 |
| A16 | 5.9220472E−30 | 2.9741153E−30 | 4.8939763E−23 |
| A18 | −8.5286728E−34 | −4.5136352E−34 | −3.1299198E−26 |
| A20 | 4.7267599E−38 | 2.5679162E−38 | 8.3416755E−30 |

### Example 13

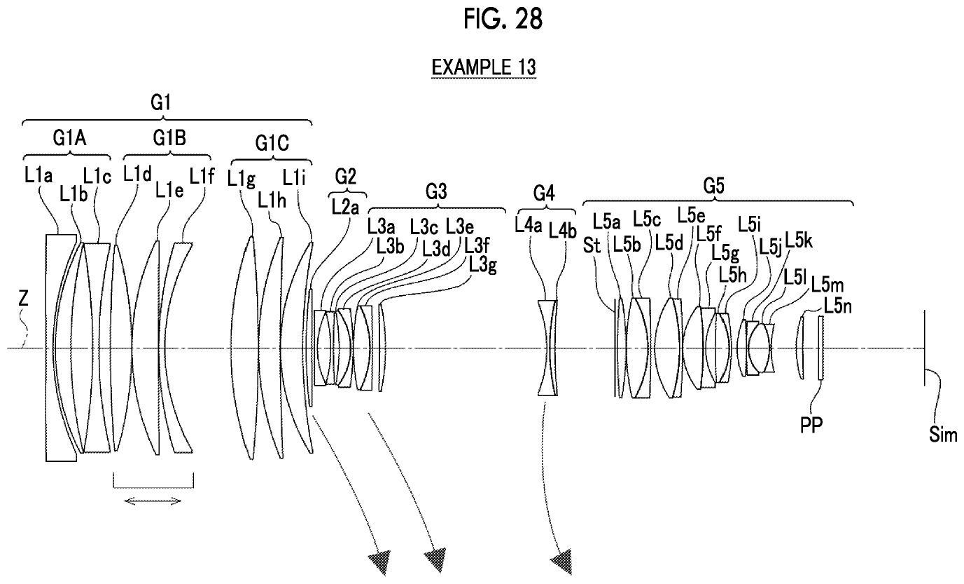

FIG. 28 shows a configuration and movement loci of the variable magnification optical system of Example 13. The variable magnification optical system in Example 13 consists of, in order from the object side to the image side, a first lens group G1 having a positive refractive power, a second lens group G2 having a positive refractive power, a third lens group G3 having a negative refractive power, a fourth lens group G4 having a negative refractive power, and a fifth lens group G5 having a positive refractive power.

During changing magnification, the first lens group G1 and the fifth lens group G5 remain stationary with respect to the image plane Sim, and the second lens group G2, the third lens group G3, and the fourth lens group G4 move along the optical axis Z by changing the spacing from the adjacent lens groups. The middle group GM consists of a second lens group G2 and a third lens group G3. The negative movable lens group GN consists of a fourth lens group G4.

The first lens group G1 consists of a first A subgroup G1A, a first B subgroup G1B, and a first C subgroup G1C in order from the object side to the image side. The focus group is the first B subgroup G1B. The first A subgroup G1A consists of three lenses L1a to L1c in order from the object side to the image side. The first B subgroup G1B consists of three lenses L1d to L1f in order from the object side to the image side. The first C subgroup G1C consists of three lenses L1g to L1i in order from the object side to the image side.

The second lens group G2 consists of one lens L2a. The third lens group G3 consists of seven lenses L3a to L3g in order from the object side to the image side. The fourth lens group G4 consists of two lenses L4a and L4b in order from the object side to the image side. The fifth lens group G5 consists of an aperture stop St and fourteen lenses L5a to L5n in order from the object side to the image side.

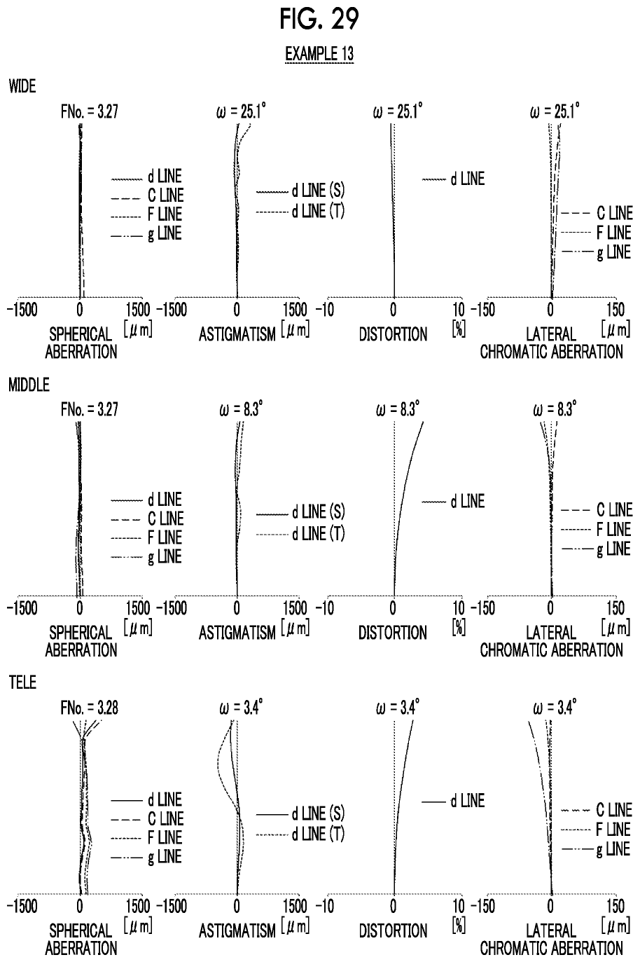

Regarding the variable magnification optical system of Example 13, Tables 37A and 37B show the basic lens data, Table 38 shows the specifications and the variable surface spacings, Table 39 shows the aspherical coefficients, and FIG. 29 shows a diagram of aberrations in a state in which the infinite distance object is in focus.

TABLE 37A
Example 13

| Sn | R | D | Nd | vd | θgF | ED | Sg |
|---|---|---|---|---|---|---|---|
| *1 | −11890.85451 | 4.500 | 1.72916 | 54.68 | 0.54451 | 145.19 | 4.18 |
| 2 | 164.00374 | 1.439 | | | | 145.19 | |
| 3 | 152.04434 | 9.700 | 1.84666 | 23.84 | 0.62012 | 145.00 | 3.50 |
| 4 | 290.12322 | 13.598 | | | | 135.22 | |
| 5 | −397.92182 | 3.900 | 1.77250 | 49.62 | 0.55188 | 134.57 | 4.26 |
| 6 | 305.75340 | 7.230 | | | | 133.54 | |
| 7 | 819.14634 | 13.354 | 1.59282 | 68.62 | 0.54414 | 133.42 | 4.13 |
| 8 | −244.62778 | 0.120 | | | | 130.46 | |
| 9 | 162.47532 | 16.657 | 1.49700 | 81.64 | 0.53714 | 133.40 | 3.65 |
| 10 | 8714.53049 | 0.120 | | | | 133.40 | |
| 11 | 233.31129 | 3.800 | 1.84666 | 23.84 | 0.62012 | 136.78 | 3.50 |
| 12 | 134.69889 | 41.314 | | | | 136.49 | |
| 13 | 223.13654 | 16.805 | 1.43875 | 94.66 | 0.53402 | 134.22 | 3.59 |
| 14 | −761.19436 | 0.120 | | | | 130.63 | |
| 15 | 190.2046 | 13.5670 | 1.43875 | 94.66 | 0.53402 | 142.36 | 3.59 |
| 16 | 1416.8939 | 0.1200 | | | | 142.38 | |
| 17 | 131.1937 | 13.9916 | 1.49700 | 81.64 | 0.53714 | 141.26 | 3.65 |
| 18 | 356.8292 | DD[18] | | | | 140.77 | |
| 19 | 316.4461 | 3.4818 | 1.49700 | 81.64 | 0.53714 | 134.55 | |
| 20 | 5633.1424 | DD[20] | | | | 133.47 | |
| *21 | 8447.2456 | 1.8000 | 1.90043 | 37.37 | 0.57668 | 74.88 | |
| 22 | 51.4998 | 8.4400 | | | | 74.09 | |
| 23 | −83.7200 | 1.6000 | 1.63246 | 63.77 | 0.54215 | 47.93 | |
| 24 | 355.9513 | 3.6053 | | | | 44.83 | |
| 25 | −133.8395 | 7.2470 | 1.59270 | 35.31 | 0.59336 | 44.83 | |
| 26 | −40.2135 | 1.5000 | 1.59282 | 68.62 | 0.14414 | 46.35 | |
| 27 | −170.3513 | 0.1201 | | | | 47.03 | |
| 28 | 133.4296 | 10.4051 | 1.67300 | 38.26 | 0.57580 | 47.04 | |
| 29 | −61.5853 | 1.5000 | 1.90043 | 37.37 | 0.57668 | 52.15 | |
| 30 | −990.5637 | 4.5118 | | | | 52.37 | |
| 31 | −849.5464 | 3.7795 | 1.78880 | 28.43 | 0.60092 | 52.37 | |
| 32 | −135.1239 | DD[32] | | | | 53.81 | |
| 33 | −80.2262 | 1.8100 | 1.49700 | 81.64 | 0.53714 | 55.35 | |
| 34 | 137.4842 | 3.2131 | 1.80518 | 25.43 | 0.61027 | 57.12 | |
| 35 | 314.3842 | DD[35] | | | | 60.38 | |

TABLE 37B
Example 13

| Sn | R | D | Nd | νd | θgF | ED |
|---|---|---|---|---|---|---|
| 36(St) | ∞ | 1.5001 | | | | 60.38 |
| 37 | 368.5249 | 5.4430 | 1.80400 | 46.60 | 0.55755 | 60.60 |
| 38 | −185.8917 | 0.1200 | | | | 61.65 |
| 39 | 144.9291 | 13.4776 | 1.56883 | 56.04 | 0.54853 | 62.97 |
| 40 | −66.5849 | 1.8000 | 1.83400 | 37.16 | 0.57759 | 63.43 |
| 41 | −683.9448 | 2.5000 | | | | 63.15 |
| 42 | 60.1964 | 15.5316 | 1.53775 | 74.70 | 0.53936 | 63.15 |
| 43 | −115.3519 | 1.8100 | 1.54072 | 47.23 | 0.56511 | 63.42 |
| 44 | −456.4774 | 0.1200 | | | | 62.51 |
| 45 | 42.4155 | 12.7882 | 1.49700 | 81.64 | 0.53714 | 62.50 |
| 46 | −220.4897 | 1.6000 | 1.91082 | 35.25 | 0.58224 | 52.63 |
| 47 | 44.1370 | 6.1916 | | | | 50.44 |
| 48 | 566.4086 | 8.1145 | 1.80518 | 25.43 | 0.61027 | 44.23 |
| 49 | −44.1956 | 1.4100 | 1.78800 | 47.35 | 0.55597 | 44.11 |
| 50 | −113.9116 | 3.5878 | | | | 43.74 |
| 51 | 46.7283 | 5.8790 | 1.49700 | 81.64 | 0.53714 | 43.74 |
| 52 | −260.7841 | 0.0369 | | | | 42.70 |
| 53 | 429.6595 | 1.2000 | 1.84850 | 43.79 | 0.56197 | 36.05 |
| 54 | 22.11894 | 13.054 | 1.48749 | 70.24 | 0.53007 | 34.39 |
| 55 | −35.30710 | 1.200 | 1.81600 | 46.59 | 0.55661 | 30.95 |
| 56 | 63.63414 | 15.552 | | | | 30.41 |
| 57 | 65.41679 | 4.106 | 1.67300 | 38.26 | 0.57580 | 30.41 |
| 58 | 544.15168 | 10.000 | | | | 30.67 |
| 59 | ∞ | 2.650 | 1.51633 | 64.14 | | |
| 60 | ∞ | 63.402 | | | | |

TABLE 38
Example 13

| | WIDE | MIDDLE | TELE |
|---|---|---|---|
| Zr | 1.0 | 3.0 | 7.7 |
| f | 50.182 | 153.056 | 386.906 |
| Bf | 75.150 | 75.150 | 75.150 |
| FNo. | 3.27 | 3.27 | 3.28 |
| 2ω(°) | 50.2 | 16.6 | 6.8 |
| Ims | 23.4 | 23.4 | 23.4 |
| DD[18] | 2.108 | 50.708 | 81.734 |
| DD[20] | 1.692 | 26.851 | 29.271 |
| DD[32] | 100.856 | 27.569 | 27.853 |
| DD[35] | 37.598 | 37.127 | 3.396 |

TABLE 39
Example 13

| Sn | 1 | 21 |
|---|---|---|
| KA | 1.0000000E+00 | 1.0000000E+00 |
| A4 | 1.2770064E−08 | 2.5682555E−07 |
| A6 | 9.9582435E−12 | −8.0409658E−09 |
| A8 | −1.0700116E−14 | 1.3472939E−10 |
| A10 | 2.3712566E−18 | −1.2323956E−12 |
| A12 | 5.5363788E−21 | 6.2406660E−15 |
| A14 | −6.3850349E−24 | −1.4228254E−17 |
| A16 | 3.3426389E−27 | −1.4701431E−20 |
| A18 | −9.6801893E−31 | 1.7570664E−22 |
| A20 | 1.3183479E−34 | −3.8231765E−25 |
| A22 | 6.7387458E−39 | −1.8534199E−29 |
| A24 | −5.9339965E−42 | 1.5867543E−30 |
| A26 | 1.0222996E−45 | −3.1296884E−33 |
| A28 | −8.2190323E−50 | 2.6759087E−36 |
| A30 | 2.6650298E−54 | −8.9548630E−40 |

### Example 14

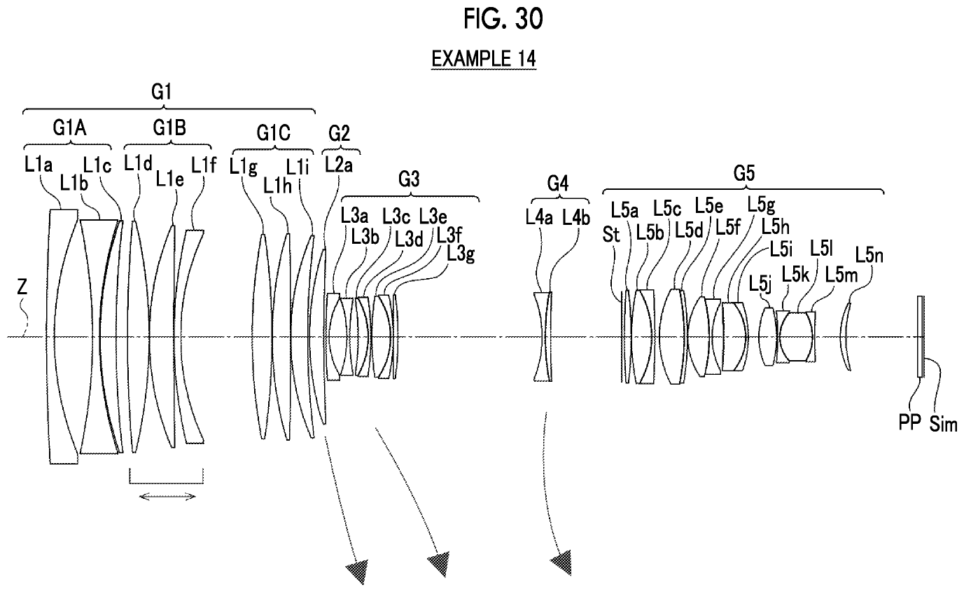

FIG. 30 shows a configuration and movement loci of the variable magnification optical system of Example 14. The variable magnification optical system in Example 14 consists of, in order from the object side to the image side, a first lens group G1 having a positive refractive power, a second lens group G2 having a positive refractive power, a third lens group G3 having a negative refractive power, a fourth lens group G4 having a negative refractive power, and a fifth lens group G5 having a positive refractive power.

During changing magnification, the first lens group G1 and the fifth lens group G5 remain stationary with respect to the image plane Sim, and the second lens group G2, the third lens group G3, and the fourth lens group G4 move along the optical axis Z by changing the spacing from the adjacent lens groups. The middle group GM consists of a second lens group G2 and a third lens group G3. The negative movable lens group GN consists of a fourth lens group G4.

The first lens group G1 consists of a first A subgroup G1A, a first B subgroup G1B, and a first C subgroup G1C in order from the object side to the image side. The focus group is the first B subgroup G1B. The first A subgroup G1A consists of three lenses L1a to L1c in order from the object side to the image side. The first B subgroup G1B consists of three lenses L1d to L1f in order from the object side to the image side. The first C subgroup G1C consists of three lenses L1g to L1i in order from the object side to the image side.

The second lens group G2 consists of one lens L2a. The third lens group G3 consists of seven lenses L3a to L3g in order from the object side to the image side. The fourth lens group G4 consists of two lenses L4a and L4b in order from the object side to the image side. The fifth lens group G5 consists of an aperture stop St and fourteen lenses L5a to L5n in order from the object side to the image side.

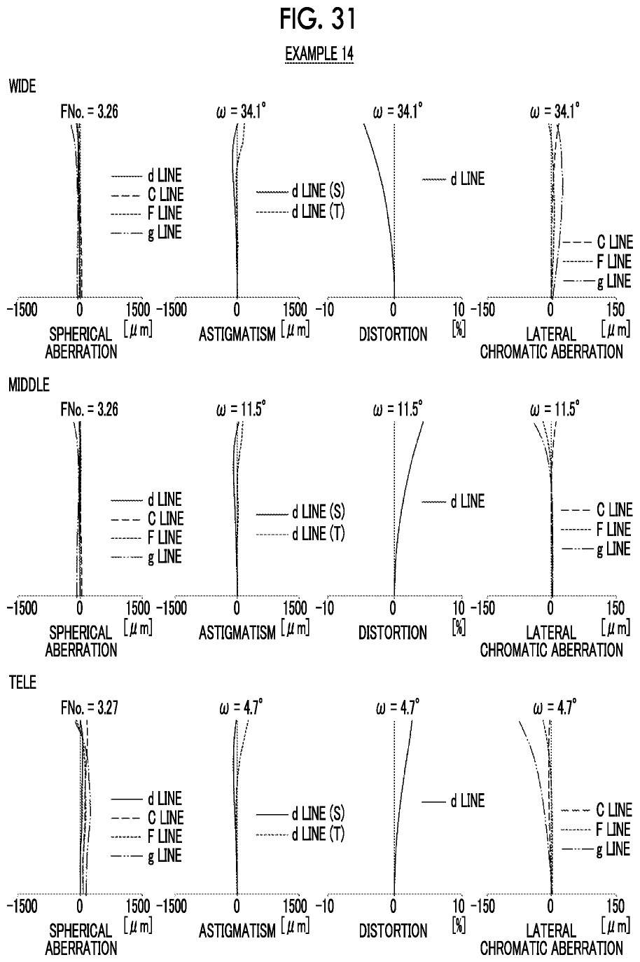

Regarding the variable magnification optical system of Example 14, Tables 40A and 40B show the basic lens data, Table 41 shows the specifications and the variable surface spacings, Table 42 shows the aspherical coefficients, and FIG. 31 shows a diagram of aberrations in a state in which the infinite distance object is in focus.

TABLE 40A
Example 14

| Sn | R | D | Nd | vd | θgF | ED | Sg |
|---|---|---|---|---|---|---|---|
| 1 | 1293.92423 | 4.500 | 1.77250 | 49.60 | 0.53531 | 149.83 | 4.23 |
| 2 | 180.82749 | 21.544 | | | | 149.83 | |
| 3 | −325.54926 | 3.900 | 1.77250 | 49.60 | 0.55212 | 147.00 | 4.23 |
| 4 | 222.50454 | 0.406 | | | | 135.69 | |
| 5 | 211.34135 | 8.945 | 1.84666 | 23.84 | 0.55212 | 135.04 | 3.50 |
| 6 | 587.01026 | 6.471 | | | | 133.68 | |
| 7 | 798.81429 | 12.225 | 1.59282 | 68.62 | 0.62012 | 134.09 | 4.13 |
| 8 | −295.33225 | 0.120 | | | | 133.90 | |
| 9 | 170.29518 | 13.759 | 1.49700 | 81.64 | 0.54414 | 131.25 | 3.65 |
| 10 | 3907.11715 | 0.120 | | | | 131.25 | |
| 11 | 272.83622 | 3.800 | 1.84666 | 23.84 | 0.53714 | 128.11 | 3.50 |
| 12 | 144.48756 | 40.053 | | | | 127.34 | |
| 13 | 329.65569 | 11.179 | 1.43875 | 94.66 | 0.62012 | 123.06 | 3.59 |
| 14 | −426.38305 | 0.120 | | | | 118.98 | |
| 15 | 220.6109 | 10.3612 | 1.43875 | 94.66 | 0.53402 | 117.97 | 3.59 |
| 16 | −3673.3651 | 0.1201 | | | | 118.20 | |
| 17 | 154.0397 | 9.5433 | 1.49700 | 81.64 | 0.53402 | 119.07 | 3.65 |
| 18 | 469.1701 | DD[18] | | | | 118.86 | |
| 19 | 167.8602 | 8.0951 | 1.49700 | 81.64 | 0.53714 | 116.56 | |
| 20 | 1044.0614 | DD[20] | | | | 115.90 | |
| *21 | 542.4660 | 1.8000 | 1.90043 | 37.37 | 0.53714 | 100.88 | |
| 22 | 44.9066 | 10.0147 | | | | 100.09 | |
| 23 | −66.6426 | 1.6000 | 1.63246 | 63.77 | 0.57668 | 50.05 | |
| 24 | 124.4449 | 4.7489 | | | | 41.36 | |
| 25 | −145.9557 | 5.6467 | 1.59270 | 35.31 | 0.54215 | 44.13 | |
| 26 | −45.5006 | 1.5100 | 1.58886 | 62.58 | | 41.00 | |
| 27 | −160.7813 | 0.5151 | | | 0.59336 | 44.34 | |
| 28 | 157.7734 | 10.6391 | 1.67300 | 38.26 | 0.54205 | 44.35 | |
| 29 | −42.9387 | 1.5000 | 1.90043 | 37.37 | | 46.28 | |
| 30 | −114.5669 | 0.1200 | | | 0.57580 | 46.52 | |
| 31 | −1332.4921 | 2.5918 | 1.90006 | 34.46 | 0.57668 | 46.52 | |
| 32 | −188.0122 | DD[32] | | | | 47.97 | |
| 33 | −66.5967 | 1.8100 | 1.49700 | 81.64 | 0.58551 | 48.19 | |
| 34 | 144.9400 | 2.9224 | 1.80518 | 25.43 | | 48.41 | |
| 35 | 514.5830 | DD[35] | | | 0.53714 | 50.87 | |

TABLE 40B
Example 14

| Sn | R | D | Nd | νd | θgF | ED |
|---|---|---|---|---|---|---|
| 36(St) | ∞ | 1.5000 | | | 0.61027 | 50.87 |
| 37 | 378.4574 | 3.8238 | 1.84674 | 33.82 | | 51.11 |
| 38 | −228.4897 | 0.1200 | | | | 51.95 |
| 39 | 131.4780 | 11.5149 | 1.56883 | 56.04 | 0.58885 | 52.98 |
| 40 | −56.0385 | 1.8000 | 1.83400 | 37.16 | | 53.62 |
| 41 | −447.6902 | 2.5000 | | | 0.54853 | 53.44 |
| 42 | 60.3416 | 14.0529 | 1.53775 | 74.70 | 0.57759 | 53.44 |
| 43 | −137.7820 | 1.8100 | 1.54072 | 47.23 | | 54.51 |
| 44 | −163.5126 | 0.1200 | | | 0.53936 | 52.94 |
| 45 | 41.0665 | 12.2139 | 1.49700 | 81.64 | 0.56511 | 52.94 |
| 46 | −93.6604 | 1.6000 | 1.95000 | 32.78 | | 45.74 |
| 47 | 42.9905 | 6.3157 | | | 0.53714 | 43.30 |
| 48 | −281.1713 | 12.3228 | 1.80518 | 25.43 | 0.58894 | 38.70 |
| 49 | −30.9889 | 1.4000 | 1.84199 | 43.80 | | 38.74 |
| 50 | −61.7263 | 6.0218 | | | 0.61027 | 38.92 |
| 51 | 41.7224 | 9.9892 | 1.49700 | 81.64 | 0.56255 | 38.92 |
| 52 | −67.1105 | 0.6259 | | | | 39.22 |
| 53 | −143.0786 | 1.2000 | 1.84850 | 43.79 | 0.53714 | 33.09 |
| 54 | 20.42273 | 18.475 | 1.48749 | 70.24 | | 29.88 |
| 55 | −27.07814 | 1.200 | 1.86215 | 41.78 | 0.56197 | 27.43 |
| 56 | 254.88111 | 14.471 | | | 0.53007 | 27.40 |
| 57 | 43.03289 | 3.174 | 1.67300 | 38.26 | 0.56660 | 27.40 |
| 58 | 68.87985 | 40.496 | | | | 28.61 |
| 59 | ∞ | 2.650 | 1.51633 | 64.14 | | |
| 60 | ∞ | 0.997 | | | | |

TABLE 41
Example 14

| | WIDE | MIDDLE | TELE |
|---|---|---|---|
| Zr | 1.0 | 3.0 | 7.7 |
| f | 36.234 | 110.514 | 279.364 |
| Bf | 43.241 | 43.241 | 43.241 |
| FNo. | 3.27 | 3.27 | 3.27 |
| 2ω(°) | 68.2 | 23.0 | 9.4 |
| Ims | 23.4 | 23.4 | 23.4 |
| DD[18] | 1.014 | 20.114 | 28.105 |
| DD[20] | 1.249 | 56.804 | 80.974 |
| DD[32] | 81.365 | 7.391 | 12.131 |
| DD[35] | 40.207 | 39.526 | 2.626 |

TABLE 42
Example 14

| Sn | 21 |
|---|---|
| KA | 1.0000000E+00 |
| A4 | 7.6072258E−07 |
| A6 | −1.8123448E−09 |
| A8 | 2.6415850E−11 |
| A10 | −2.2480917E−13 |
| A12 | 1.1568741E−15 |
| A14 | −3.6850778E−18 |
| A16 | 6.8056804E−21 |
| A18 | −4.8710434E−24 |
| A20 | −6.1399678E−27 |
| A22 | 1.4097486E−29 |
| A24 | −5.3494798E−34 |
| A26 | −2.2845342E−35 |
| A28 | 2.4742493E−38 |
| A30 | −8.5871607E−42 |

### Example 15

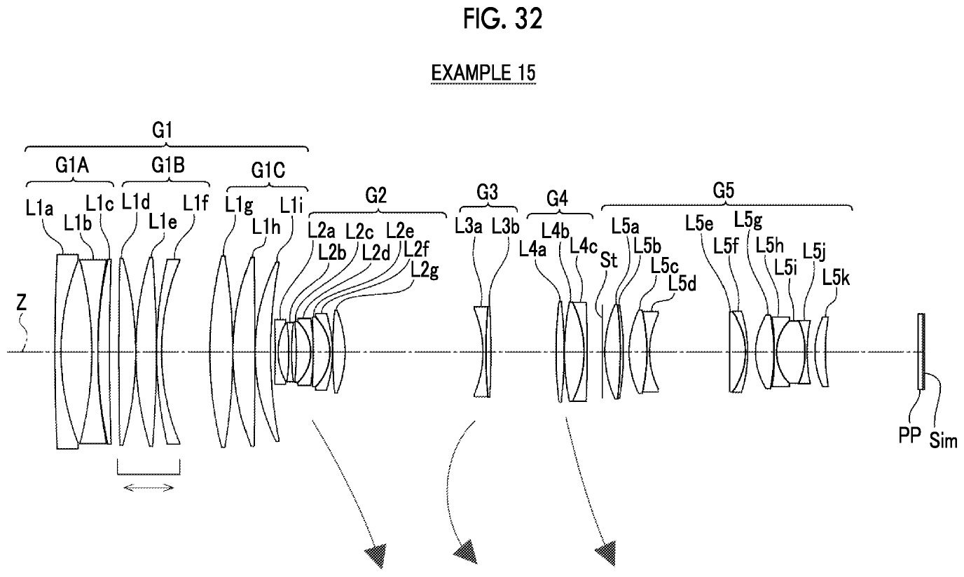

FIG. 32 shows a configuration and movement loci of the variable magnification optical system of Example 15. The variable magnification optical system in Example 15 consists of, in order from the object side to the image side, a first lens group G1 having a positive refractive power, a second lens group G2 having a negative refractive power, a third lens group G3 having a negative refractive power, a fourth lens group G4 having a positive refractive power, and a fifth lens group G5 having a positive refractive power.

During changing magnification, the first lens group G1 and the fifth lens group G5 remain stationary with respect to the image plane Sim, and the second lens group G2, the third lens group G3, and the fourth lens group G4 move along the optical axis Z by changing the spacing from the adjacent lens groups. The middle group GM consists of a second lens group G2. The negative movable lens group GN consists of a third lens group G3. The positive movable lens group consists of a fourth lens group G4.

The first lens group G1 consists of a first A subgroup G1A, a first B subgroup G1B, and a first C subgroup G1C in order from the object side to the image side. The focus group is the first B subgroup G1B. The first A subgroup G1A consists of three lenses L1a to L1c in order from the object side to the image side. The first B subgroup G1B consists of three lenses L1d to L1f in order from the object side to the image side. The first C subgroup G1C consists of three lenses L1g to L1i in order from the object side to the image side.

The second lens group G2 consists of seven lenses L2a to L2g in order from the object side to the image side. The third lens group G3 consists of two lenses L3a and L3b in order from the object side to the image side. The fourth lens group G4 consists of three lenses L4a to L4c in order from the object side to the image side. The fifth lens group G5 consists of an aperture stop St and eleven lenses L5a to L5k in order from the object side to the image side.

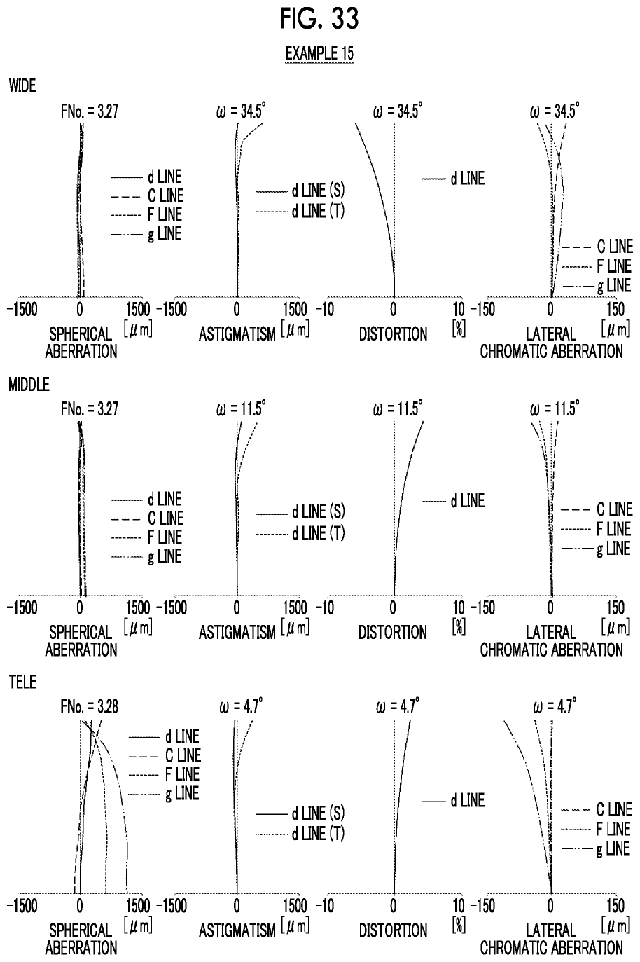

Regarding the variable magnification optical system of Example 15, Tables 43A and 43B show the basic lens data, Table 44 shows the specifications and the variable surface spacings, Table 45 shows the aspherical coefficients, and FIG. 33 shows a diagram of aberrations in a state in which the infinite distance object is in focus.

TABLE 43A
Example 15

| Sn | R | D | Nd | vd | θgF | ED | Sg |
|---|---|---|---|---|---|---|---|
| 1 | 1342.19576 | 3.700 | 1.77250 | 49.60 | 0.53531 | 121.00 | 4.23 |
| 2 | 162.25976 | 18.754 | | | | 113.58 | |
| 3 | −223.51842 | 3.500 | 1.85199 | 42.69 | 0.55212 | 113.19 | 4.81 |
| 4 | 314.18830 | 0.121 | | | | 114.38 | |
| 5 | 278.51041 | 6.972 | 1.84666 | 23.84 | 0.56463 | 114.78 | 3.50 |
| 6 | 1656.17553 | 5.808 | | | | 114.88 | |
| 7 | 3292.48069 | 10.063 | 1.59282 | 68.62 | 0.62012 | 115.70 | 4.13 |
| 8 | −222.73955 | 0.120 | | | | 116.15 | |
| 9 | 209.55339 | 12.490 | 1.49700 | 81.64 | 0.54414 | 117.55 | 3.65 |
| 10 | −755.75760 | 0.120 | | | | 117.32 | |
| 11 | 258.45005 | 3.000 | 1.84666 | 23.84 | 0.53714 | 114.88 | 3.50 |
| 12 | 153.12260 | 29.251 | | | | 113.58 | |
| 13 | 248.73941 | 13.918 | 1.49700 | 81.54 | 0.62012 | 118.89 | 3.62 |
| 14 | −368.66208 | 0.127 | | | | 118.98 | |
| 15 | 166.82812 | 12.956 | 1.49700 | 81.54 | 0.53748 | 117.49 | 3.62 |
| 16 | −4539.95216 | 0.120 | | | | 116.98 | |
| 17 | 129.14004 | 9.382 | 1.49700 | 81.54 | 0.53748 | 111.48 | 3.62 |
| 18 | 303.80387 | DD[18] | | | | 110.43 | |
| *19 | −415.17314 | 1.800 | 1.91082 | 35.25 | 0.53748 | 40.37 | |
| 20 | 38.45720 | 6.571 | | | | 36.75 | |
| 21 | −141.54498 | 1.600 | 1.84850 | 43.79 | 0.58224 | 36.70 | |
| 22 | 154.99727 | 2.923 | | | | 37.06 | |
| 23 | −169.96739 | 8.693 | 1.68648 | 36.26 | 0.56197 | 37.36 | |
| 24 | −26.77275 | 1.500 | 1.86730 | 34.66 | | 37.95 | |
| 25 | −140.23411 | 0.120 | | | 0.58616 | 41.57 | |
| 26 | −338.43238 | 10.027 | 1.70830 | 30.73 | 0.58585 | 42.19 | |
| 27 | −31.36026 | 1.500 | 1.87639 | 40.36 | | 43.28 | |
| 28 | −79.86113 | 0.120 | | | 0.60173 | 47.53 | |
| 29 | 268.13587 | 7.530 | 1.57871 | 40.24 | 0.56970 | 50.84 | |
| 30 | −70.04669 | DD[30] | | | | 51.33 | |
| 31 | −67.35994 | 1.810 | 1.49700 | 81.64 | 0.57891 | 53.00 | |
| 32 | 348.20748 | 2.917 | 1.80518 | 25.43 | | 55.76 | |
| 33 | −700.36344 | DD[33] | | | 0.53714 | 56.07 | |
| 34 | 262.52220 | 4.954 | 1.75485 | 52.51 | 0.61027 | 62.21 | |
| 35 | −275.94247 | 0.121 | | | | 62.25 | |
| 36 | 154.69560 | 11.990 | 1.58728 | 47.54 | 0.54748 | 61.65 | |
| 37 | −70.70324 | 1.800 | 1.81980 | 43.96 | | 61.22 | |
| 38 | −847.11379 | DD[38] | | | 0.56364 | 60.66 | |

TABLE 43B
Example 15

| Sn | R | D | Nd | νd | θgF | ED |
|---|---|---|---|---|---|---|
| 39(St) | ∞ | 1.523 | | | 0.56298 | 57.51 |
| 40 | 72.42845 | 9.405 | 1.53775 | 74.70 | | 58.52 |
| 41 | −255.53335 | 1.800 | 1.72559 | 28.72 | | 58.17 |
| 42 | −180.95542 | 3.472 | | | 0.53936 | 57.98 |
| 43 | 60.55588 | 10.847 | 1.49700 | 81.64 | 0.60724 | 51.49 |
| 44 | −117.63585 | 1.600 | 1.91776 | 34.81 | | 49.84 |
| 45 | 53.05283 | 48.123 | | | 0.53714 | 45.96 |
| 46 | −5703.98718 | 9.649 | 1.80518 | 25.43 | 0.58403 | 49.44 |
| 47 | −43.50207 | 1.400 | 1.88491 | 28.21 | | 49.57 |
| 48 | −86.67784 | 4.749 | | | 0.61027 | 50.22 |
| 49 | 44.37168 | 11.090 | 1.49700 | 81.64 | 0.60515 | 45.52 |
| 50 | −124.40622 | 0.431 | | | | 44.05 |
| 51 | −161.45851 | 1.200 | 1.84850 | 43.79 | 0.53714 | 43.01 |
| 52 | 28.63255 | 17.360 | 1.48749 | 70.24 | | 39.00 |
| 53 | −49.93815 | 1.200 | 1.78912 | 33.45 | 0.56197 | 38.64 |
| 54 | 104.17511 | 4.769 | | | 0.53007 | 39.25 |
| 55 | 52.97077 | 6.197 | 1.67300 | 38.26 | 0.59155 | 42.86 |
| 56 | 129.19174 | 56.329 | | | | 42.55 |
| 57 | ∞ | 2.650 | 1.51633 | 64.14 | | |
| 58 | ∞ | 1.012 | | | | |

TABLE 44
Example 15

| | WIDE | MIDDLE | TELE |
|---|---|---|---|
| Zr | 1.0 | 3.0 | 7.7 |
| f | 36.246 | 110.551 | 279.459 |
| Bf | 59.089 | 59.089 | 59.089 |
| FNo. | 3.27 | 3.27 | 3.28 |
| 2ω(°) | 69.0 | 23.0 | 9.4 |
| Ims | 23.4 | 23.4 | 23.4 |
| DD[18] | 2.734 | 78.918 | 110.797 |
| DD[30] | 83.685 | 1.866 | 21.219 |
| DD[33] | 39.510 | 43.276 | 1.177 |
| DD[38] | 9.220 | 11.090 | 1.957 |

TABLE 45
Example 15

| Sn | 19 |
|---|---|
| KA | 1.0000000E+00 |
| A4 | 2.0565523E−06 |
| A6 | −5.6853356E−09 |
| A8 | 1.5134896E−10 |
| A10 | −2.3325577E−12 |
| A12 | 2.0176465E−14 |
| A14 | −9.8333039E−17 |
| A16 | 2.1453611E−19 |
| A18 | 2.6418607E−22 |
| A20 | −2.7611169E−24 |
| A22 | 5.6162683E−27 |
| A24 | 1.1868486E−30 |
| A26 | −2.2634873E−32 |
| A28 | 3.5254923E−35 |
| A30 | −1.8405678E−38 |

Tables 46 to 48 show the corresponding values of Conditional Expressions (1) to (24) of the variable magnification optical system of Examples 1 to 15. In Tables 46 to 48, the columns where there is no corresponding item each show “-”. The corresponding values of Conditional Expression (24) of Example 7 are values relating to the lens L5i.

TABLE 46

| Expression | | | | | | |
|---|---|---|---|---|---|---|
| Number | | Example 1 | Example 2 | Example 3 | Example 4 | Example 5 |
| (1) | f1/(ft/FNt) | 1.568 | 1.410 | 1.551 | 1.358 | 1.410 |
| (2) | Ims/f1 | 0.128 | 0.142 | 0.129 | 0.148 | 0.142 |
| (3) | \|Ims/ffz\| | 0.329 | 0.136 | 0.324 | 0.340 | 0.326 |
| (4) | 1/βfzt | −0.051 | 0.004 | −0.057 | −0.018 | −0.006 |
| (5) | \|Dpfz/ffz\| | 1.638 | 0.651 | 1.614 | 1.520 | 1.539 |
| (6) | fMw/fN | 0.446 | 0.468 | 0.435 | 0.405 | 0.453 |
| (7) | νNdif | 57.81 | 69.23 | 57.81 | 69.23 | 69.23 |
| (8) | θM + 0.0018 × νM | 0.056 | 0.036 | 0.056 | 0.056 | 0.036 |
| | −0.64833 | | | | | |
| (9) | (RMnr + RMf)/(RMnr − RMf) | −0.453 | −0.766 | −0.403 | −0.765 | −0.737 |
| (10) | DpM/{(ft/fw) × Ims} | 0.646 | 0.620 | 0.646 | 0.580 | 0.613 |
| (11) | EDMf/EDMr | 1.529 | 2.239 | 2.462 | 2.244 | 1.133 |
| (12) | \|(HMfb/HMfa) | 2.173 | 2.226 | 2.174 | 2.203 | 2.256 |
| | /(HMrb/HMra)\| | | | | | |
| (13) | Ims/fE | 0.371 | 0.309 | 0.378 | 0.343 | 0.308 |
| (14) | θE + 0.0018 × vνE | 0.056 | 0.056 | 0.056 | 0.056 | 0.056 |
| | −0.64833 | | | | | |
| (15) | ave (Sgf/Nf) | 2.25 | 2.28 | 2.25 | 2.33 | 2.28 |
| (16) | Nfmax | 1.85478 | 1.84666 | 1.85478 | 1.84666 | 1.84666 |
| (17) | (Rpf − Rpr)/(Rpf + Rpr) | −0.173 | −0.275 | −0.102 | −0.315 | −0.300 |
| (18) | Ims/f1C | 0.145 | 0.157 | 0.145 | 0.158 | 0.158 |
| (19) | f1/f1B | 0.650 | 0.576 | 0.634 | 0.545 | 0.583 |
| (20) | θ1Bp + 0.0018 × ν1Bp | 0.134 | 0.056 | 0.056 | 0.056 | 0.056 |
| | −0.64833 | | | | | |
| (21) | ν1Bn | 24.80 | 23.84 | 24.80 | 23.78 | 23.84 |
| (22) | ν1Ap | 23.83 | 23.84 | 23.83 | 23.78 | 23.84 |
| (23) | (REf + REr)/(REf − REr) | 0.398 | 0.234 | 0.401 | 0.313 | 0.247 |
| (24) | dN/dT | — | — | — | — | — |

TABLE 47

| Expression | | | | | | |
|---|---|---|---|---|---|---|
| Number | | Example 6 | Example 7 | Example 8 | Example 9 | Example 10 |
| (1) | f1/(ft/FNt) | 1.314 | 1.315 | 1.503 | 1.524 | 1.444 |
| (2) | Ims/f1 | 0.152 | 0.152 | 0.183 | 0.132 | 0.134 |
| (3) | \|Ims/ffz\| | 0.364 | 0.359 | 0.355 | 0.353 | 0.370 |
| (4) | 1/βfzt | −0.011 | −0.013 | −0.035 | −0.041 | −0.143 |
| (5) | \|Dpfz/ffz\| | 1.582 | 1.573 | 1.648 | 1.723 | 1.862 |
| (6) | fMw/fN | 0.494 | 0.425 | 0.463 | 0.448 | 0.321 |
| (7) | νNdif | 54.00 | 70.83 | 66.23 | 56.12 | 56.12 |
| (8) | θM + 0.0018 × νM | 0.056 | 0.056 | 0.056 | 0.036 | 0.006 |
| | −0.64833 | | | | | |
| (9) | (RMnr + RMf)/(RMnr − RMf) | −0.281 | −0.198 | 0.010 | −0.129 | −0.289 |
| (10) | DpM/{(ft/fw) × Ims} | 0.563 | 0.567 | 0.601 | 0.626 | 0.645 |
| (11) | EDMf/EDMr | 2.535 | 2.368 | 2.375 | 2.723 | 1.108 |
| (12) | \|(HMfb/HMfa) | 2.052 | 2.068 | 1.904 | 1.805 | 1.605 |
| | /(HMrb/HMra)\| | | | | | |
| (13) | Ims/fE | 0.334 | 0.292 | 0.316 | 0.302 | 0.315 |
| (14) | θE + 0.0018 × vνE | 0.057 | 0.057 | 0.057 | 0.057 | 0.057 |
| | −0.64833 | | | | | |
| (15) | ave (Sgf/Nf) | 2.27 | 2.33 | 2.34 | 2.34 | 2.27 |
| (16) | Nfmax | 1.85478 | 1.84666 | 1.84666 | 1.81008 | 1.80518 |
| (17) | (Rpf − Rpr)/(Rpf + Rpr) | −0.575 | −1.256 | −5.926 | −4.788 | — |
| (18) | Ims/f1C | 0.185 | 0.162 | 0.184 | 0.146 | 0.144 |
| (19) | f1/f1B | 0.562 | 0.524 | 0.484 | 0.586 | 0.607 |
| (20) | θ1Bp + 0.0018 × ν1Bp | 0.056 | 0.056 | 0.056 | 0.057 | 0.057 |
| | −0.64833 | | | | | |
| (21) | ν1Bn | 24.80 | 23.84 | 23.84 | 26.49 | 25.42 |
| (22) | ν1Ap | 23.83 | 23.84 | 23.84 | 23.83 | 23.83 |
| (23) | (REf + REr)/(REf − REr) | 0.316 | 0.316 | 0.013 | −0.163 | −0.166 |
| (24) | dN/dT | — | 3.6 × 10⁻⁶ | — | — | — |

TABLE 48

| Expression | | | | | | |
|---|---|---|---|---|---|---|
| Number | | Example 11 | Example 12 | Example 13 | Example 14 | Example 15 |
| (1) | f1/(ft/FNt) | 1.635 | 1.470 | 1.412 | 2.205 | 1.511 |
| (2) | Ims/f1 | 0.128 | 0.142 | 0.141 | 0.125 | 0.182 |
| (3) | \|Ims/ffz\| | 0.365 | 0.378 | 0.395 | 0.383 | 0.379 |
| (4) | 1/βfzt | −0.118 | −0.062 | −0.087 | −0.068 | −0.129 |
| (5) | \|Dpfz/ffz\| | 2.071 | 1.695 | 1.811 | 1.750 | 1.752 |
| (6) | fMw/fN | 0.403 | 0.475 | 0.423 | 0.495 | 0.328 |
| (7) | νNdif | 56.12 | 56.12 | 56.21 | 56.21 | 56.12 |
| (8) | θM + 0.0018 × νM | 0.036 | 0.036 | 0.036 | 0.036 | −0.008 |
| | −0.64833 | | | | | |
| (9) | (RMnr + RMf)/(RMnr − RMf) | −0.101 | −0.119 | −0.238 | −0.195 | −0.573 |
| (10) | DpM/{(ft/fw) × Ims} | 0.697 | 0.613 | 0.594 | 0.592 | 0.599 |
| (11) | EDMf/EDMr | 1.397 | 1.429 | 2.500 | 2.430 | 0.720 |
| (12) | \|(HMfb/HMfa) | 1.648 | 1.987 | 2.120 | 2.233 | 2.099 |
| | /(HMrb/HMra)\| | | | | | |
| (13) | Ims/fE | 0.326 | 0.390 | 0.357 | 0.421 | 0.116 |
| (14) | θE + 0.0018 × vνE | 0.057 | 0.057 | 0.036 | 0.036 | 0.036 |
| | −0.64833 | | | | | |
| (15) | ave (Sgf/Nf) | 2.34 | 2.37 | 2.31 | 2.31 | 2.31 |
| (16) | Nfmax | 1.84666 | 1.81766 | 1.84666 | 1.84666 | 1.84666 |
| (17) | (Rpf − Rpr)/(Rpf + Rpr) | −0.981 | −1.282 | −0.894 | −0.723 | — |
| (18) | Ims/f1C | 0.138 | 0.152 | 0.160 | 0.153 | 0.199 |
| (19) | f1/f1B | 0.616 | 0.587 | 0.631 | 0.568 | 0.485 |
| (20) | θ1Bp + 0.0018 × ν1Bp | 0.057 | 0.057 | 0.056 | 0.056 | 0.036 |
| | −0.64833 | | | | | |
| (21) | ν1Bn | 23.78 | 28.38 | 23.84 | 23.84 | 23.84 |
| (22) | ν1Ap | 23.83 | 23.83 | 23.84 | 23.84 | 23.84 |
| (23) | (REf + REr)/(REf − REr) | 0.337 | 0.388 | 0.329 | 0.247 | −0.428 |
| (24) | dN/dT | — | — | — | — | — |

As can be seen from the data described above, the variable magnification optical systems of Examples 1 to 15 each have high optical performance with various aberrations satisfactorily corrected while being configured to have a small size. Further, the variable magnification optical systems of Examples 1 to 15 each have the F number at the telephoto end smaller than 3.4 and have almost no F drop while having a zoom magnification of seven times or more and achieving an increase in magnification.

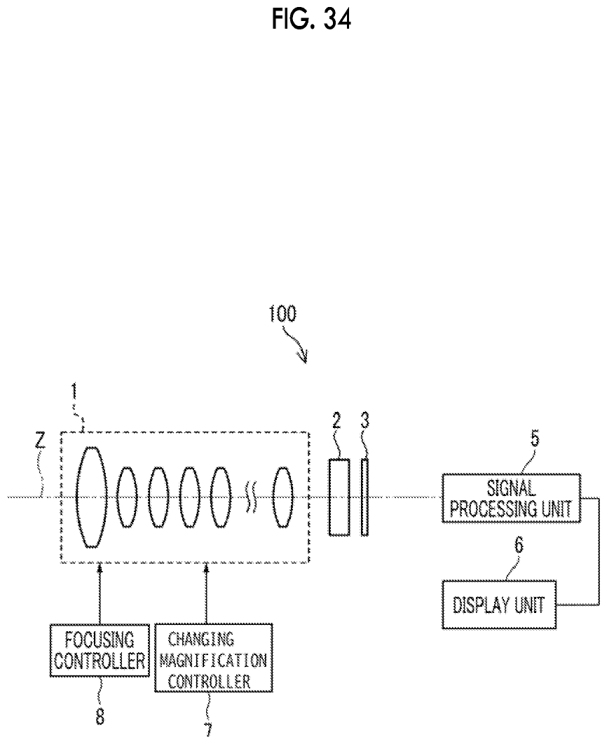

Next, an imaging apparatus according to an embodiment of the present disclosure will be described. FIG. 34 shows a schematic configuration diagram of an imaging apparatus 100 using the variable magnification optical system 1 according to the embodiment of the present disclosure as an example of the imaging apparatus according to the embodiment of the present disclosure. Examples of the imaging apparatus 100 include a movie shooting camera, a broadcasting camera, a video camera, a surveillance camera, and the like.

The imaging apparatus 100 includes a variable magnification optical system 1, a filter 2 disposed on the image side of the variable magnification optical system 1, and an imaging element 3 disposed on the image side of the filter 2. It should be noted that FIG. 34 schematically shows a plurality of lenses comprising the variable magnification optical system 1.

The imaging element 3 converts an optical image formed by the variable magnification optical system 1 into an electric signal, and for example, a charge coupled device (CCD) or a complementary metal oxide semiconductor (CMOS) or the like can be used. The imaging element 3 is disposed such that the imaging surface thereof coincides with the image plane of the variable magnification optical system 1.

The imaging apparatus 100 also comprises a signal processing unit 5 that calculates and processes an output signal from the imaging element 3, a display unit 6 that displays an image formed by the signal processing unit 5, a changing magnification controller 7 that controls zooming of the variable magnification optical system 1, and a focusing controller 8 that controls focusing of the variable magnification optical system 1. Although FIG. 34 shows only one imaging element 3, a so-called three-plate imaging apparatus having three imaging elements may be used.

The technology of the present disclosure has been hitherto described through embodiments and examples, but the technology of the present disclosure is not limited to the above-mentioned embodiments and examples, and may be modified into various forms. For example, values such as the radius of curvature, the surface spacing, the refractive index, the Abbe number, and the aspherical coefficient of each lens are not limited to the values shown in the numerical examples, and different values may be used therefor.

variable magnification optical system

What is claimed is:

1. A variable magnification optical system consisting of, in order from an object side to an image side: a first lens group that has a positive refractive power; a plurality of lens groups; and a final lens group that has a positive refractive power,
wherein during changing magnification, a spacing between the first lens group and the lens group closest to the object side among the plurality of lens groups changes, all spacings between adjacent lens groups in the plurality of lens groups change, and a spacing between the lens group closest to the image side among the plurality of lens groups and the final lens group changes.

2. The variable magnification optical system according to claim 1, wherein assuming that
a focal length of the first lens group in a state in which an infinite distance object is in focus is f1,
a focal length of the variable magnification optical system at a telephoto end in the state in which the infinite distance object is in focus is ft, and
an open F number of the variable magnification optical system at the telephoto end in the state in which the infinite distance object is in focus is FNt,
Conditional Expression (1) is satisfied, which is represented by
$$1 < f 1 / ( f t / F N t ) < 3 \qquad ( 1 )$$

3. The variable magnification optical system according to claim 1, wherein assuming that
a maximum image height is Ims, and
a focal length of the first lens group in a state in which an infinite distance object is in focus is f1,
Conditional Expression (2) is satisfied, which is represented by
$$0.1 < Ims / f 1 < 0.5 . \qquad ( 2 )$$

4. The variable magnification optical system according to claim 1,
wherein a lens group that moves by changing a spacing from an adjacent lens group during changing magnification is a movable lens group, and a movable lens group having a maximum absolute value of a ratio of a lateral magnification of a movable lens group at a telephoto end to a lateral magnification of the movable lens group at a wide angle end among the movable lens groups included in the variable magnification optical system in a state in which an infinite distance object is in focus is a fz group, and
assuming that
a focal length of the fz group is ffz, and
a maximum image height is Ims,
Conditional Expression (3) is satisfied, which is represented by
$$0.05 < \vert Ims / ffz \vert < 0.6 \qquad ( 3 )$$

5. The variable magnification optical system according to claim 1,
wherein a lens group that moves by changing a spacing from an adjacent lens group during changing magnification is a movable lens group, and a movable lens group having a maximum absolute value of a ratio of a lateral magnification of a movable lens group at a telephoto end to a lateral magnification of the movable lens group at a wide angle end among the movable lens groups included in the variable magnification optical system in a state in which an infinite distance object is in focus is a fz group, and
assuming that a lateral magnification of the fz group at the telephoto end in the state in which the infinite distance object is in focus is βfzt,
Conditional Expression (4) is satisfied, which is represented by
$$- 0.3 < 1 / β f z t < 0.3 . \qquad ( 4 )$$

6. The variable magnification optical system according to claim 1,
wherein a lens group that moves by changing a spacing from an adjacent lens group during changing magnification is a movable lens group, and a movable lens group having a maximum absolute value of a ratio of a lateral magnification of a movable lens group at a telephoto end to a lateral magnification of the movable lens group at a wide angle end among the movable lens groups included in the variable magnification optical system in a state in which an infinite distance object is in focus is a fz group, and
assuming that
a focal length of the fz group is ffz, and
a difference in an optical axis direction between a position of the fz group at the wide angle end and a position of the fz group at the telephoto end is Dpfz,
Conditional Expression (5) is satisfied, which is represented by
$$0.3 < \vert Dpfz / ffz \vert < 3. \qquad ( 5 )$$

7. The variable magnification optical system according to claim 1,
wherein the plurality of lens groups include, in order from a position closest to the object side to the image side, a middle group, which includes one or more lens groups and has a negative refractive power as a whole, and a negative movable lens group, which has a negative refractive power and moves during changing magnification, and
the negative movable lens group is positioned closest to the image side in the lens groups having negative refractive powers in the plurality of lens groups.

8. The variable magnification optical system according to claim 7, wherein assuming that
a focal length of the middle group at a wide angle end in a state in which an infinite distance object is in focus is fMw, and
a focal length of the negative movable lens group is fN,
Conditional Expression (6) is satisfied, which is represented by
$$0.2 < fMw / fN < 0.7 . \qquad ( 6 )$$

9. The variable magnification optical system according to claim 7,
wherein the negative movable lens group includes one or more negative lenses and one or more positive lenses, and
assuming that a maximum absolute value of a difference between an Abbe number of the negative lens included in the negative movable lens group based on a d line and an Abbe number of the positive lens included in the negative movable lens group based on the d line is μNdif, Conditional Expression (7) is satisfied, which is represented by
$$40 < vNdif < 95. \qquad ( 7 )$$

10. The variable magnification optical system according to claim 7,
wherein the middle group includes one or more positive lenses, and
assuming that an Abbe number of the positive lens, of which an Abbe number based on a d line is maximum, among the positive lenses included in the middle group based on the d line is νM and a partial dispersion ratio thereof between a g line and an F line is θM, Conditional Expression (8) is satisfied, which is represented by
$$- 0.02 < θ M + 0.00 \; 18 \times v M - 0.64833 < 0 .07 . \qquad ( 8 )$$

11. The variable magnification optical system according to claim 7, wherein assuming that
a curvature radius of an image side surface of a negative lens closest to the object side in the middle group is RMnr, and
a curvature radius of an object side surface of a lens disposed adjacent to the image side of a negative lens closest to the object side in the middle group is RMf,
Conditional Expression (9) is satisfied, which is represented by
$$- 1.5 < ( RMnr + RMf ) / ( RMnr - RMf ) < 0.2 . \qquad ( 9 )$$

12. The variable magnification optical system according to claim 7, wherein assuming that
a difference in an optical axis direction between a position of a lens surface closest to the image side in the middle group at a wide angle end and a position of a lens surface closest to the image side in the middle group at a telephoto end in a state in which an infinite distance object is in focus is DpM,
a focal length of the variable magnification optical system at a wide angle end in the state in which the infinite distance object is in focus is fw,
a focal length of the variable magnification optical system at a telephoto end in the state in which the infinite distance object is in focus is ft, and
a maximum image height is Ims,
Conditional Expression (10) is satisfied, which is represented by
$$0 .2 < Dp M / \{ ( ft / fw ) \times Ims \} < 0.9 . \qquad ( 10 )$$

13. The variable magnification optical system according to claim 7, wherein assuming that
an effective diameter of a lens surface closest to the object side in the middle group in a state in which an infinite distance object is in focus is EDMf, and
an effective diameter of a lens surface closest to the image side in the middle group in the state in which the infinite distance object is in focus is EDMr,
Conditional Expression (11) is satisfied, which is represented by
$$0 .5 < EDMf / EDMr < 3.25 . \qquad ( 11 )$$

14. The variable magnification optical system according to claim 7, wherein assuming that
a height of a principal ray from an optical axis at a maximum image height on a lens surface closest to the object side in the middle group at the wide angle end in a state in which an infinite distance object is in focus is HMfb,
a height of an on-axis marginal ray from the optical axis on the lens surface closest to the object side in the middle group at the wide angle end in the state in which the infinite distance object is in focus is HMfa,
a height of the principal ray from the optical axis at a maximum image height on a lens surface closest to the image side in the middle group at the wide angle end in the state in which the infinite distance object is in focus is HMrb, and
a height of the on-axis marginal ray from the optical axis on the lens surface closest to the image side in the middle group at the wide angle end in the state in which the infinite distance object is in focus is HMra,
Conditional Expression (12) is satisfied, which is represented by
$$1 < \vert ( HMfb / ( HMfa ) / ( HMrb / HMra ) \vert < 3. \qquad ( 12 )$$

15. The variable magnification optical system according to claim 7, wherein the plurality of lens groups consist of the middle group and the negative movable lens group.

16. The variable magnification optical system according to claim 7,
wherein the middle group consists of a front lens group having a positive refractive power and a rear lens group having a negative refractive power in order from the object side to the image side, and
a spacing between the front lens group and the rear lens group changes during changing magnification.

17. The variable magnification optical system according to claim 7, wherein groups, which are included in the plurality of lens groups and move by changing a spacing from an adjacent lens group during changing magnification, consist of, in order from the object side to the image side, the middle group, the negative movable lens group, and a positive movable lens group having a positive refractive power.

18. The variable magnification optical system according to claim 1, wherein assuming that
a maximum image height is Ims, and
a focal length of the final lens group is fE,
Conditional Expression (13) is satisfied, which is represented by
$$0.1 < Ims / fE < 0.6 . \qquad ( 13 )$$

19. The variable magnification optical system according to claim 1, wherein assuming that an Abbe number of the positive lens, of which an Abbe number based on a d line is maximum, among the positive lenses included in the final lens group based on the d line is νE and a partial dispersion ratio thereof between a g line and an F line is θE, Conditional Expression (14) is satisfied, which is represented by
$$0.02 < θ E + 0.0018 \times v E - 0.64833 < 0 .08 . \qquad ( 14 )$$

20. The variable magnification optical system according to claim 1,
wherein the variable magnification optical system includes a focus group that performs focusing by moving along an optical axis, and
assuming that
a specific gravity of each lens in the focus group is Sgf and a refractive index thereof at a d line is Nf,
an average value of Sgf/Nf of all lenses in the focus group is ave(Sgf/Nf), and a maximum value of refractive indexes of all the lenses in the focus group at the d line is Nfmax,
Conditional Expressions (15) and (16) are satisfied, which are represented by
$$\begin{matrix}2.05 < ave ( Sgf / Nf ) < 2.55 , and & ( 15 ) \\ 1.7 < Nfmax < 2.2 . & ( 16 )\end{matrix}$$

21. The variable magnification optical system according to claim 1, wherein in a case where a lens group that moves by changing a spacing from an adjacent lens group during changing magnification is a movable lens group,
the number of the movable lens groups included in the variable magnification optical system is three or more, and
the movable lens group closest to the object side among the movable lens groups included in the variable magnification optical system has a positive refractive power.

22. The variable magnification optical system according to claim 21, wherein the movable lens group closest to the object side among the movable lens groups included in the variable magnification optical system consists of one positive lens having a convex surface facing toward the object side.

23. The variable magnification optical system according to claim 22, wherein assuming that
a curvature radius of an object side surface of the positive lens having the convex surface facing toward the object side is Rpf, and
a curvature radius of an image side surface of the positive lens having the convex surface facing toward the object side is Rpr,
Conditional Expression (17) is satisfied, which is represented by
$$- 6 < ( Rpf - Rpr ) / ( Rpf + Rpr ) < 1. \qquad ( 17 )$$

24. The variable magnification optical system according to claim 1,
wherein the first lens group consists of, in order from the object side to the image side, a first A subgroup having a negative refractive power, a first B subgroup having a positive refractive power, and a first C subgroup having a positive refractive power, and
focusing is performed by moving the first B subgroup along an optical axis.

25. The variable magnification optical system according to claim 24, wherein assuming that
a maximum image height is Ims, and
a focal length of the first C subgroup is f1C,
Conditional Expression (18) is satisfied, which is represented by
$$0.05 < Ims / f 1 C < 0.3 . \qquad ( 18 )$$

26. The variable magnification optical system according to claim 24, wherein assuming that
a focal length of the first lens group is f1, and
a focal length of the first B subgroup is f1B,
Conditional Expression (19) is satisfied, which is represented by
$$0.3 < f 1 / f 1 B < 0.9 . \qquad ( 19 )$$

27. The variable magnification optical system according to claim 24,
wherein the first B subgroup includes one or more positive lenses and one or more negative lenses, and
assuming that
an Abbe number of the positive lens, of which an Abbe number based on a d line is maximum, among the positive lenses included in the first B subgroup based on the d line is ν1Bp, and a partial dispersion ratio thereof between a g line and an F line is θ1Bp, and
a minimum value of Abbe numbers of all the negative lenses included in the first B subgroup based on the d line is ν1Bn,
Conditional Expressions (20) and (21) are satisfied, which are represented by
$$\begin{matrix}0.01 < θ 1 Bp + 0. 0018 \times v 1 Bp - 0. 64833 < 0.07 , and & ( 20 ) \\ 15 < v 1 Bn < 40. & ( 21 )\end{matrix}$$

28. The variable magnification optical system according to claim 24,
wherein the first A subgroup includes two or more negative lenses of which Abbe numbers based on a d line are 50 or more, and
assuming that a minimum value of Abbe numbers of all the positive lenses included in the first A subgroup based on the d line is ν1Ap, Conditional Expression (22) is satisfied, which is represented by
$$15 < v 1 Ap < 40. \qquad ( 22 )$$

29. The variable magnification optical system according to claim 1, wherein the first lens group remains stationary with respect to an image plane during changing magnification.

30. The variable magnification optical system according to claim 1,
wherein the final lens group remains stationary with respect to an image plane during changing magnification, and
a stop is disposed closest to the object side in the final lens group.

31. The variable magnification optical system according to claim 30,
wherein in a case where one lens component is one single lens or one group of cemented lenses,
a lens component disposed adjacent to the image side of the stop has a biconvex shape.

32. The variable magnification optical system according to claim 31, wherein assuming that
a curvature radius of a surface closest to the object side of the lens component disposed adjacent to the image side of the stop is REf, and
a curvature radius of a surface closest to the image side of the lens component disposed adjacent to the image side of the stop is REr,
Conditional Expression (23) is satisfied, which is represented by
$$- 0.7 < ( REf + REr ) / ( REf - REr ) < 0.7 . \qquad ( 23 )$$

33. The variable magnification optical system according to claim 1, wherein assuming that
a temperature coefficient of a relative refractive index of a lens in the final lens group at a d line in a range of 20° C. to 40° C. is dN/dT and a unit of dN/dT is ° C.⁻¹,
the final lens group includes one or more lenses respectively having an Abbe number based on the d line of 65 or more and satisfying Conditional Expression (24), which is represented by
$$0 < d N / d T < 8 \times 1 {0}^{- 6} . \qquad ( 24 )$$

34. An imaging apparatus comprising the variable magnification optical system according to claim 1.
